(19) United States
(12) Patent Application Publication
(10) Pub. No.: US 2010/0172221 A1
(43) Pub. Date: Jul. 8, 2010

(54) DISC CARTRIDGE, AND DISC CHANGER

(75) Inventor: Yasuo OSADA, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/638,560

(22) Filed: Dec. 15, 2009

(30) Foreign Application Priority Data
Jan. 7, 2009 (JP) 2009-001987
Jan. 7, 2009 (JP) 2009-001988
Jan. 7, 2009 (JP) 2009-001989
Jan. 7, 2009 (JP) 2009-001990

(51) Int. Cl. G11B 21/08

(52) U.S. Cl. 369/30.85; G9B/21.012

(57) ABSTRACT

A disc cartridge includes a storage case storing disc-shaped recording media, disc trays holding the disc-shaped recording media and moved toward one and another sides to be inserted into and extracted from the storage case, and tray levers causing the disc trays to move toward the another side. First, second, and third direction are respectively defined as thickness direction of the disc-shaped recording media, moving direction of the disc trays, and direction perpendicular to the first and second directions. Each disc tray includes a tab which projects in the second direction. Each tray lever includes a pushing portion which pushes the tab toward the another side when the disc tray is to be extracted. The tabs of the disc trays disposed next to each other in the first direction are at different positions in the third direction. The tray levers are positioned near the respective tabs.

### BACKGROUND OF THE INVENTION

1. Field of the Invention

The present invention relates to a technical field of disc cartridges and disc changers. More specifically, the present invention relates to a technique for facilitating an operation of extracting disc trays and disc-shaped recording media from a storage case by providing each disc tray with a tab which is pushed when the disc tray is extracted and which is disposed at a different position for each disc tray, and to a technique for conveying the disc trays and the disc-shaped recording media.

2. Description of the Related Art

An example of a disc changer includes a cartridge-holding block configured to hold a disc cartridge in which a plurality of disc-shaped recording media, such as optical discs, are stored; a disc-conveying mechanism configured to extract a desired disc-shaped recording medium from the disc cartridge and convey the disc-shaped recording medium to a recording-reproducing position; and a disc drive block to which the disc-shaped recording medium conveyed to the recording-reproducing position is attached and which performs an operation of recording information signals on the disc-shaped recording medium or reproducing information signals from the disc-shaped recording medium.

In a disc changer according to a related art, a plurality of disc-shaped recording media are stored in a disc cartridge such that the disc-shaped recording media are held by respective disc trays and arranged in a thickness direction (see, for example, Japanese Unexamined Patent Application Publication No. 2008-159118). A desired one of the disc-shaped recording media stored in the disc cartridge is selected and extracted by a disc-extracting mechanism, and is conveyed to a recording-reproducing position by a disc-conveying mechanism.

In the disc changer described in Japanese Unexamined Patent Application Publication No. 2008-159118, when the desired disc-shaped recording medium is selected and extracted from the disc cartridge, a part of the disc-extracting mechanism engages with the desired disc-shaped recording medium and the disc tray which holds the desired disc-shaped recording medium to extract the desired disc-shaped recording medium from the disc cartridge.

### SUMMARY OF THE INVENTION

In the disc changer, it is desirable to optimize the operation of the disc changer by facilitating the operation of extracting each disc-shaped recording medium from the disc cartridge and inserting the disc-shaped recording medium into the disc cartridge.

In the disc changer described in Japanese Unexamined Patent Application Publication No. 2008-159118, a part of a disc-selecting block is inserted into the disc cartridge and is caused to engage with the desired disc-shaped recording medium and the disc tray which holds the desired disc-shaped recording medium. Therefore, a space with a predetermined size is provided above and below the desired disc-shaped recording medium and the disc tray to receive the part of the disc-selecting block.

If the size of the space above and below the desired disc-shaped recording medium and the disc tray is increased, it becomes difficult to reduce the size of the disc changer. If the size of the space above and below the desired disc-shaped recording medium and the disc tray is reduced, it becomes difficult to extract the desired disc-shaped recording medium and the disc tray.

In the disc changer, it is desirable to store a large number of disc-shaped recording media in the disc cartridge without increasing the size thereof. Therefore, it is desirable to reduce the thickness of the disc trays which hold the disc-shaped recording media.

In the disc changer described in Japanese Unexamined Patent Application Publication No. 2008-159118, extraction positions at which the disc-shaped recording media are extracted from the disc cartridge are arranged in the thickness direction of the disc-shaped recording media. In this case, since the thicknesses of the disc-shaped recording media and the disc trays are small, the extraction positions which are next to each other are close to each other.

Therefore, in the case where the positioning accuracy of the disc-extracting mechanism with respect to the extraction positions is low, there is a risk that a wrong disc tray will be extracted by mistake. To prevent such a mistake, intervals between the disc-shaped recording media which are next to each other are increased. As a result, the size of the disc cartridge is increased.

Alternatively, to prevent the above-described mistake, the positioning accuracy of the disc-extracting mechanism with respect to the extraction positions may be increased. However, in such a case, high costs are incurred to ensure the positioning accuracy, and the disc-extracting mechanism and the operation thereof will become complex.

Also in the case where thin disc trays are used, to optimize the operation, it is desirable to reliably convey each disc tray to a certain position together with the disc-shaped recording medium held by the disc tray.

Accordingly, to solve the above-described problems, it is desirable to provide a disc cartridge and a disc changer capable of facilitating the operation of extracting each disc tray and the disc-shaped recording medium held by the disc tray from the storage case, improving the operation of inserting the disc tray and the disc-shaped recording medium into the storage case, and ensuring the reliability in the operation of conveying the disc tray and the disc-shaped recording medium.

A disc cartridge according to an embodiment of the present invention includes a storage case in which a plurality of disc-shaped recording media having a sheet shape are arranged in a thickness direction; a plurality of disc trays having a sheet shape, the disc trays holding the respective disc-shaped recording media and being moved toward one side with respect to the storage case to be inserted into the storage case together with the disc-shaped recording media and toward another side to be extracted from the storage case together with the disc-shaped recording media; and a plurality of tray levers disposed in the storage case, the tray levers being movable in a predetermined direction and causing the respective disc trays to move toward the another side. A first direction, a second direction, and a third direction are respectively defined as the thickness direction of the disc-shaped recording media, a direction in which the disc trays are moved with respect to the storage case, and a direction perpendicular to the first direction and the second direction. Each disc tray includes a tab which projects in the second direction, and each tray lever includes a pushing portion which pushes the tab of the corresponding disc tray toward the another side when the disc tray is to be extracted from the storage case. The tabs of the disc trays disposed next to each other in the first direction are at different positions in the third direction, and the tray levers are positioned near the respective tabs.

Thus, the disc trays include the tabs which are disposed at different positions in the third direction, and the tab of each disc tray can be pushed by the pushing portion of the corresponding tray lever so that the disc tray and the disc-shaped recording medium held by the disc tray are extracted from the storage case.

Therefore, the tabs of the disc trays disposed next to each other in the first direction are not arranged in the first direction, so that the disc trays can be easily extracted from the storage case using the tray levers. In addition, a large number of disc trays and the disc-shaped recording media can be stored in the storage case.

In the disc cartridge, preferably, the tabs of the disc trays and the tray levers are successively arranged in the first direction and the third direction.

When the tabs of the disc trays and the tray levers are successively arranged in the first direction and the third direction, the length of the disc cartridge in the third direction can be reduced.

Therefore, a large number of disc-shaped recording media can be stored in the storage case without degrading the ease of extracting the disc trays from the storage case using the tray levers or increasing the length of the disc cartridge in the third direction.

In the disc cartridge, preferably, two tabs that are disposed at one and the other ends of the disc trays in the third direction and the tabs of the disc trays that are positioned between two disc trays including the two tabs in the first direction are arranged with constant intervals therebetween in the third direction.

When the tabs are arranged with constant intervals therebetween in the third direction, the tray levers can be arranged with constant intervals therebetween in the third direction.

Since the tray levers can be arranged with constant intervals therebetween in the third direction, the space efficiency can be improved.

In the disc cartridge, preferably, the tab of each disc tray includes a lock-receiving projection, and each tray lever includes a lock projection which engages with the lock-receiving projection to lock the corresponding disc tray to the storage case when the disc-shaped recording medium held by the disc tray is stored in the storage case.

Thus, each disc tray can be locked by the corresponding tray lever, which has a function of pushing the tab in the second direction and causing the disc tray to project from the storage case, and it is not necessary to provide a dedicated component for locking the disc tray. Therefore, the number of components can be reduced.

In the disc cartridge, preferably, each tray lever is rotatable about an axis which extends in the first direction. When the tray lever rotates in a first rotational direction, the pushing portion pushes the tab of the corresponding disc tray toward the another side, and when the tray lever rotates in a second rotational direction, the lock projection engages with the lock-receiving projection on the tab of the corresponding disc tray.

In the case where each tab is pushed toward the another side when the corresponding tray lever rotates in the first rotational direction and the lock projection on the tray lever engages with the lock-receiving projection on the tab when the tray lever rotates in the second rotational direction, each disc tray can be pushed or locked in accordance with the rotational direction of the corresponding tray lever.

Since each disc tray is either pushed or locked in accordance with the rotational direction of the corresponding tray lever, the movements of the components are simple, and the mechanism can be simplified.

In the disc cartridge, preferably, each tray lever is rotatable between a lock position at which the corresponding disc tray is locked and a pushing completion position at which pushing of the tab of the corresponding disc tray is completed, and, when the tray lever is rotated toward the lock position, the tray lever receives an urging force in the second rotational direction from a corresponding urging spring.

In the case where each tray lever receives the urging force in the second rotational direction from the urging spring when the tray lever is rotated toward the lock position, a rotational force toward the lock position can be applied to the tray lever.

Therefore, the corresponding disc tray can be reliably locked at the lock position by the urging force applied by the urging spring.

In the disc cartridge, preferably, a standby position is provided between the lock position and the pushing completion position, each tray lever being placed at the standby position such that the tab of the corresponding disc tray is capable of coming into contact with the pushing portion when the disc tray is moved toward the one side to be inserted into the storage case, and the tray lever is capable of being retained at the standby position by the corresponding urging spring.

In the case where each tray lever is capable of being retained at the standby position by the corresponding urging spring, the urging spring serves both a function of causing the tray lever to reliably lock the corresponding disc tray at the lock position and a function of retaining the tray lever at the standby position.

Since the urging spring has a function of causing the tray lever to reliably lock the disc tray at the lock position and a function of retaining the tray lever at the standby position, the urging spring serves multiple functions. Therefore, the mechanism can be simplified and the number of components can be reduced.

In the disc cartridge, preferably, a plurality of pin insertion holes which correspond to the tray levers are provided in the storage case, and each tray lever is rotated by inserting an operation pin into the storage case through the corresponding pin insertion hole and pushing the tray lever.

When a plurality of pin insertion holes which correspond to the tray levers are provided in the storage case, the operation pin can be guided into the storage case by the pin insertion holes.

Thus, each pin-insertion hole functions as a guide member in the process of pushing the corresponding disc tray, and each tray lever can be pushed by the operation pin at an optimum position thereof.

In the disc cartridge, preferably, a thickness of the pushing portion of each tray lever is larger than a thickness of the tab of each disc tray.

When the thickness of the pushing portion of each tray lever is larger than the thickness of the tab of each disc tray, the allowable positioning accuracy between the pushing portion of each tray lever and the tab of the corresponding disc tray can be reduced.

Therefore, the tab of each disc tray can be reliably pushed using the operation pin.

In the disc cartridge, preferably, the urging springs are formed integrally with a base surface portion by processing a metal plate such that the urging springs project from the base surface portion in a predetermined direction.

In the case where the urging springs are formed integrally with the base surface portion, the base surface portion and the urging springs are composed of a single member.

Therefore, it is not necessary to provide the urging springs as separate components and the number of components can be reduced.

A disc cartridge according to another embodiment of the present invention includes a storage case in which a plurality of disc-shaped recording media having a sheet shape are arranged in a thickness direction; a plurality of disc trays composed of sheet-shaped elastic members, the disc trays holding the respective disc-shaped recording media and being moved toward one side with respect to the storage case to be inserted into the storage case together with the disc-shaped recording media and toward another side to be extracted from the storage case together with the disc-shaped recording media; and a plurality of tray levers disposed in the storage case, the tray levers being movable in a predetermined direction and causing the respective disc trays to move toward the another side. A first direction, a second direction, and a third direction are respectively defined as the thickness direction of the disc-shaped recording media, a direction in which the disc trays are moved with respect to the storage case, and a direction perpendicular to the first direction and the second direction. Each disc tray includes a tab which projects in the second direction, and each tray lever includes a pushing portion which pushes the tab of the corresponding disc tray toward the another side when the disc tray is to be extracted from the storage case. The tabs of the disc trays disposed next to each other in the first direction are at different positions in the third direction, and the tray levers are positioned near the respective tabs. The storage case includes a pair of side surface sections which are spaced from each other in the third direction. Each of the side surface sections is provided with a plurality of retaining grooves which extend in the second direction, and outer peripheral portions of the disc trays are inserted in the retaining grooves so that the disc trays are retained by the retaining grooves.

In this disc cartridge, the disc-shaped recording media having a sheet shape and the disc trays composed of elastic members are retained by the retaining grooves formed in the pair of side surface sections.

Therefore, when the disc trays are inserted in the retaining grooves, edge portions in the third direction of the disc trays disposed next to each other in the first direction can be prevented from coming into contact with each other and are separated from each other by a constant interval. Thus, the disc trays can be stored in the storage case in a state such that the disc trays can be elastically deformed, and the number of disc-shaped recording media which can be stored in the storage case can be increased.

In the disc cartridge, preferably, each disc-shaped recording medium is provided with a cover sheet which covers at least a central portion of the disc-shaped recording medium at a side opposite the disc tray.

When each disc-shaped recording medium is provided with a cover sheet which covers at least a central portion of the disc-shaped recording medium, the cover sheet is positioned on the disc-shaped recording medium at a side opposite the disc tray.

Therefore, the risk that each disc-shaped recording medium will be damaged or scratched can be reduced.

In the disc cartridge, preferably, an edge portion of each disc tray at the one side thereof and an edge portion of the corresponding cover sheet at the one side thereof and are bonded together.

When the edge portion of each disc tray and the edge portion of the corresponding cover sheet are bonded together, the disc tray and the cover sheet can be prevented from being displaced from each other even after the cover sheet is partially removed from the disc tray.

Since the disc tray and the cover sheet can be prevented from being displaced from each other even after the cover sheet is partially removed from the disc tray, a suitable positional relationship can be maintained between the disc tray and the cover sheet. In addition, each disc-shaped recording medium can be covered by the cover sheet at an adequate position.

In the disc cartridge, preferably, each disc tray is made of a conductive material.

When each disc tray is made of a conductive material, the disc tray is electrically connected to the disc-shaped recording medium held by the disc tray.

Therefore, each disc-shaped recording medium can be prevented from being charged.

In the disc cartridge, preferably, a width of each disc tray in the third direction is larger than a diameter of each disc-shaped recording medium, a distance between the side surface sections of the storage case is larger than the diameter of each disc-shaped recording medium and smaller than the width of each disc tray in the third direction, and a width of each of the retaining grooves provided in the side surface sections in the first direction is larger than the thickness of each disc tray and smaller than the sum of the thickness of each disc tray and the thickness of each disc-shaped recording medium.

Since the distance between the side surface sections of the storage case is larger than the diameter of each disc-shaped recording medium and smaller than the width of each disc tray in the third direction, each disc-shaped recording medium can be positioned by the inner surfaces of the side surface sections.

Since each disc-shaped recording medium is positioned by the inner surfaces of the side surface sections in the third direction, it is not necessary to provide a positioning portion for positioning the disc-shaped recording medium on each disc tray. Therefore, the thickness of each disc tray can be reduced and the number of disc-shaped recording media which can be stored in the disc cartridge can be increased.

In the disc cartridge, preferably, each disc tray is provided with a rib arrangement notch or a rib arrangement hole, and the storage case includes a positioning rib which, when the disc trays are stored in the storage case, extends through all of the rib arrangement notches or the rib arrangement holes in the disc trays and positions the disc-shaped recording media held by the disc trays.

Since the positing rib extends through all of the rib arrangement notches or the rib arrangement holes in the disc trays, all of the disc trays can be positioned by the positioning rib.

Therefore, it is not necessary to provide the same number of positioning ribs as the number of disc-shaped recording media. As a result, the number of components can be reduced and the structure can be simplified.

In the disc cartridge, preferably, the storage case is provided with an opening through which each disc-shaped recording medium is inserted into and extracted from the storage case, and the storage case includes a rotatable opening-closing lid which closes or opens the opening when the disc-shaped recording media and the disc trays are stored in the storage case. The opening-closing lid includes a positioning portion which is capable of coming into contact with outer peripheral surfaces of the disc-shaped recording media when the opening is closed by the opening-closing lid, and a length of the positioning portion is substantially equal to a width of the opening in the thickness direction.

In the case where the opening-closing lid includes the positioning portion which is capable of coming into contact with outer peripheral surfaces of the disc-shaped recording media when the opening is closed by the opening-closing lid, the disc-shaped recording media can be positioned by the positing portion when the opening is closed by the opening-closing lid.

Therefore, the disc-shaped recording media can be prevented from falling from the storage case, and can be positioned at the same time.

In the disc cartridge, preferably, the side surface sections of the storage case are made of a conductive material.

In the case where the surface sections of the storage case are made of a conductive material, the side surface sections of the storage case, the disc trays, and the disc-shaped recording media can be electrically connected to each other.

Therefore, the disc trays and the disc-shaped recording media can be prevented from being charged.

In the disc cartridge, preferably, the storage case includes a top surface section which continues to the side surface sections at opposite edges thereof and a bottom surface section which continues to the side surface sections at opposite edges thereof, the top surface section and the bottom surface section being spaced from each other in the first direction, and the following condition is preferably satisfied:

Lt>Δa

Δa=Δb·cos θ

where θ is a maximum bending angle obtained when the disc trays are elastically deformed together with the disc-shaped recording media and one of the disc trays is in contact with the top surface section or the bottom surface section, Lt is an amount of insertion by which the disc trays are inserted into the respective retaining grooves in a radial direction of the disc-shaped recording media, and Δb is a displacement of end faces of the disc trays in the third direction when the disc trays are bent at the maximum bending angle θ.

In the case where Lt>Δa is satisfied, the disc trays can be prevented from falling from the respective retaining grooves when the disc trays are bent.

Therefore, even when the disc trays are bent, the disc trays can be prevented from falling from the retaining grooves.

A disc changer according to an embodiment of the present invention includes a cartridge-holding block configured to hold a disc cartridge and a disc-selecting block capable of moving in a predetermined direction with respect to the disc cartridge held by the cartridge-holding block. The disc cartridge includes a storage case in which a plurality of disc-shaped recording media having a sheet shape are arranged in a thickness direction, a plurality of disc trays composed of sheet-shaped elastic members, the disc trays holding the respective disc-shaped recording media and being moved toward one side with respect to the storage case to be inserted into the storage case together with the disc-shaped recording media and toward another side to be extracted from the storage case together with the disc-shaped recording media, and a plurality of tray levers disposed in the storage case, the tray levers being movable in a predetermined direction and causing the respective disc trays to move toward the another side. A first direction, a second direction, and a third direction are respectively defined as the thickness direction of the disc-shaped recording media, a direction in which the disc trays are moved with respect to the storage case, and a direction perpendicular to the first direction and the second direction. Each disc tray includes a tab which projects in the second direction, and each tray lever includes a pushing portion which pushes the tab of the corresponding disc tray toward the another side when the disc tray is to be extracted from the storage case. The tabs of the disc trays disposed next to each other in the first direction are at different positions in the third direction, and the tray levers are positioned near the respective tabs. The storage case includes a pair of side surface sections which are spaced from each other in the third direction. Each of the side surface sections is provided with a plurality of retaining grooves which extend in the second direction, and outer peripheral portions of the disc trays are inserted in the retaining grooves so that the disc trays are retained by the retaining grooves. The disc-selecting block includes a selection slider configured to select a disc-shaped recording medium and a disc tray to be extracted from the storage case and move the tray lever corresponding to the disc tray such that the disc tray is moved toward the another side. The selection slider is movable in the third direction.

In this disc changer, the disc-shaped recording media having a sheet shape and the disc trays composed of elastic members are retained by the retaining grooves formed in the pair of side surface sections.

Therefore, when the disc trays are inserted in the retaining grooves, edge portions in the third direction of the disc trays disposed next to each other in the first direction can be prevented from coming into contact with each other and are separated from each other by a constant interval. In addition, the disc trays can be stored in the storage case in a state such that the disc trays can be elastically deformed, and the number of disc-shaped recording media which can be stored in the storage case can be increased.

A disc changer according to another embodiment of the present invention includes a cartridge-holding block configured to hold a disc cartridge and a disc-selecting block capable of moving in a predetermined direction with respect to the disc cartridge held by the cartridge-holding block. The disc cartridge includes a storage case in which a plurality of disc-shaped recording media having a sheet shape are arranged in a thickness direction, a plurality of disc trays having a sheet shape, the disc trays holding the respective disc-shaped recording media and being moved toward one side with respect to the storage case to be inserted into the storage case together with the disc-shaped recording media and toward another side to be extracted from the storage case together with the disc-shaped recording media, and a plurality of tray levers disposed in the storage case, the tray levers being movable in a predetermined direction and causing the respective disc trays to move toward the another side. A first direction, a second direction, and a third direction are respectively defined as the thickness direction of the disc-shaped recording media, a direction in which the disc trays are moved with respect to the storage case, and a direction perpendicular to the first direction and the second direction. Each disc tray includes a tab which projects in the second direction, and each tray lever includes a pushing portion which pushes the tab of the corresponding disc tray toward the another side when the disc tray is to be extracted from the storage case. The tabs of the disc trays disposed next to each other in the first direction are at different positions in the third direction, and the tray levers are positioned near the respective tabs. The disc-selecting block includes a selection slider configured to select a disc-shaped recording medium and a disc tray to be extracted from the storage case and move the tray lever corresponding to the disc tray such that the disc tray is moved toward the another side. The selection slider is movable in the third direction.

Thus, the disc trays include the tabs which are disposed at different positions in the third direction, and the tab of each disc tray can be pushed by the pushing portion of the corresponding tray lever so that the disc tray and the disc-shaped recording medium held by the disc tray are extracted from the storage case.

Therefore, the tabs of the disc trays disposed next to each other in the first direction are not arranged in the first direction, and each disc tray can be easily extracted from the storage case using the corresponding tray lever. In addition, a large number of disc trays and the disc-shaped recording media can be stored in the storage case.

In the disc changer, preferably, a plurality of pin insertion holes which correspond to the tray levers are provided in the storage case, and the selection slider in the disc-selecting block includes an operation pin that is capable of being inserted into the storage case through each pin insertion hole to push and move the corresponding tray lever.

When a plurality of pin insertion holes which correspond to the tray levers are provided in the storage case, the operation pin can be guided into the storage case by the pin insertion holes.

Thus, each pin-insertion hole functions as a guide member in the process of pushing the corresponding disc tray, and each tray lever can be pushed by the operation pin at an optimum position thereof.

A disc changer according to another embodiment of the present invention includes a cartridge-holding block configured to hold a disc cartridge and a disc-conveying block. The disc cartridge includes a storage case in which a plurality of disc-shaped recording media are arranged in a thickness direction while being held by respective disc trays which each include a tab, the tabs of the disc trays being disposed at different positions in a direction perpendicular to the thickness direction; and a plurality of tray levers capable of pushing the tabs of the respective disc trays so that the disc trays partially project from the storage case together with the disc-shaped recording media. The disc-conveying block includes at least one pair of feed rollers capable of conveying each disc tray and the disc-shaped recording medium held by the disc tray in an extraction direction for extracting the disc tray and the disc-shaped recording medium from the storage case by rotating while clamping a part of the disc tray between the feed rollers in the thickness direction when the disc tray partially projects from the storage case, and conveying each disc tray and the disc-shaped recording medium held by the disc tray in an insertion direction for inserting the disc tray and the disc-shaped recording medium into the storage case by rotating in a direction opposite to a rotational direction for the conveyance in the extraction direction while clamping the part of the disc tray between the feed rollers in the thickness direction.

In the disc changer, the disc tray which is caused to project from the storage case by being pushed by the corresponding tray lever and the disc-shaped recording medium held by the disc tray are conveyed by the at least one pair of feed rollers.

Thus, each disc tray and the disc-shaped recording medium held by the disc tray can be extracted from the storage case by a simple operation of causing the disc tray and the disc-shaped recording medium to project from the storage case and conveying the disc tray and the disc-shaped recording medium with a simple mechanism including the feed rollers. Thus, the disc tray and the disc-shaped recording medium can be reliably conveyed by a simple mechanism and a simple operation.

Preferably, the disc changer further includes an operation pin configured to push each tray lever, a selection slider configured to hold the operation pin, an operation lever configured to push the selection slider so that the operation pin pushes each tray lever, and a loading motor configured to rotate the feed rollers in a forward direction or a reverse direction in accordance with a rotational direction of the loading motor, thereby conveying the disc tray and the disc-shaped recording medium in the extraction direction or the insertion direction, respectively. The operation lever is driven by a driving force of the loading motor when the feed rollers are rotated in the forward direction by the loading motor.

In the case where the operation lever is driven by a driving force of the loading motor when the feed rollers are rotated in the forward direction, the operating lever and the feed rollers are driven by the loading motor.

Since the operation lever and the feed rollers, which are separate components, are driven by a single loading motor, the number of components can be reduced and the structure can be simplified.

Preferably, the disc changer further includes a return lever which, when the conveyance of the disc tray and the disc-shaped recording medium in the insertion direction performed by the feed rollers is completed, pushes the disc tray in the insertion direction to insert the disc tray and the disc-shaped recording medium into the storage case, and a loading motor configured to rotate the feed rollers in a forward direction or a reverse direction in accordance with a rotational direction of the loading motor, thereby conveying the disc tray and the disc-shaped recording medium in the extraction direction or the insertion direction, respectively. The return lever is driven by a driving force of the loading motor when the feed rollers are rotated in the reverse direction by the loading motor.

In the case where the return lever is driven by a driving force of the loading motor when the feed rollers are rotated in the reverse direction, the return lever and the feed rollers are driven by the loading motor.

Since the return lever and the feed rollers, which are separate components, are driven by a single loading motor, the number of components can be reduced and the structure can be simplified.

Preferably, the disc changer further includes a return lever which, when the conveyance of the disc tray and the disc-shaped recording medium in the insertion direction performed by the feed rollers is completed, pushes the disc tray in the insertion direction to insert the disc tray and the disc-shaped recording medium into the storage case. The operation of the return lever is stopped when the feed rollers are rotated in the forward direction by the loading motor, and the return lever is driven by the driving force of the loading motor and the operation of the operation lever is stopped when the feed rollers are rotated in the reverse direction by the loading motor.

Thus, the operation of the return lever is stopped when the feed rollers are rotated in the forward direction, and the return lever is driven by the driving force of the loading motor and the operation of the operation lever is stopped when the feed rollers are rotated in the reverse direction. In this case, the operation lever and the return lever can be selectively operated in accordance with the rotational direction of the loading motor.

Since the operation lever and the return lever can be selectively operated in accordance with the rotational direction of the loading motor, the operation speed can be increased and power consumption can be reduced.

In the disc changer, preferably, the return lever includes a swing lever supported such that the swing lever is rotatable about a first rotational axis which extends in the thickness direction, the swing lever swinging about the first rotational axis when the disc tray and the disc-shaped recording medium are conveyed in the insertion direction by the feed rollers; and a transmission lever supported such that the transmission lever is rotatable about a second rotational axis which extends in the thickness direction, the transmission lever being capable of sliding along an outer peripheral surface of the disc tray and being rotated about the second rotational axis when the disc tray is moved in the extraction direction or the insertion direction. When the conveyance of the disc tray and the disc-shaped recording medium in the insertion direction performed by the feed rollers is completed, the swing lever pushes the transmission lever and a pushing force of the swing lever is applied to the disc tray through the transmission lever so that the disc tray and the disc-shaped recording medium are inserted into the storage case.

Since the swing lever pushes the transmission lever to insert each disc tray and the disc-shaped recording medium held by the disc tray when the conveyance performed by the feed rollers is completed, the return lever serves to assist the operation of conveying the disc tray and the disc-shaped recording medium with the feed rollers.

Thus, the return lever unit assists the operation of conveying the disc tray and the disc-shaped recording medium with the feed rollers, so that the disc tray and the disc-shaped recording medium can be reliably inserted into the storage case.

Preferably, the disc changer further includes a return spring which applies an urging force to the transmission lever in a direction away from the disc trays when the disc trays and the disc-shaped recording media are stored in the storage case.

When the return spring which applies the urging force to the transmission lever in the direction away from the disc trays is provided, the return lever can be separated from a cartridge holder when the cartridge holder is being moved.

Therefore, in the operation of moving the cartridge holder after the disc trays and the other components are inserted into the storage case, the return lever is prevented from interfering with the cartridge holder. As a result, the cartridge holder can be smoothly moved. In addition, the cartridge holder and the return lever can be prevented from being damaged.

Preferably, the disc changer further includes a tray-storage detection switch configured to detect a position of each disc tray in the extraction direction and the insertion direction on the basis of a position of the transmission lever in a rotational direction thereof.

In the case where the tray-storage detection switch configured to detect the position of each disc tray on the basis of the position of the transmission lever in a rotational direction thereof is provided, the position of each disc tray can be determined on the basis of the rotation of the transmission lever.

Therefore, it is not necessary to provide a dedicated mechanism for detecting the position of each disc tray. As a result, the structure can be simplified and the manufacturing cost can be reduced.

In the disc changer, preferably, each disc-shaped recording medium is stored in the storage case such that the disc-shaped recording medium is covered by a cover sheet at a side opposite the disc tray, and the cover sheet is removed from the disc-shaped recording medium by a removing lever when the disc tray partially projects from the storage case, the removing lever being moved away from the disc-shaped recording medium when the disc tray, the disc-shaped recording medium, and the cover sheet are conveyed in the extraction direction by the feed rollers.

Since the removing lever which is moved away from the disc-shaped recording medium when the disc tray, the disc-shaped recording medium, and the cover sheet are conveyed is provided, the removing lever can be moved away from the disc-shaped recording medium.

Therefore, the cover sheet can be removed from the disc tray without damaging the disc-shaped recording medium with the removing lever.

In the disc changer, preferably, the cover sheet, the disc tray, and the removing lever are composed of elastic bodies, and an elasticity of the removing lever is higher than an elasticity of the cover sheet and lower than an elasticity of the disc tray. The cover sheet is caused to slide along the removing lever so that the cover sheet is elastically deformed and is removed from the disc-shaped recording medium, and the disc tray is caused to slide along the removing lever so that the removing lever is elastically deformed and is moved away from the disc-shaped recording medium.

Since the disc tray of each disc-shaped recording medium is caused to slide along the removing lever so that the removing lever is elastically deformed and is moved away from the disc-shaped recording medium, the removing lever can be moved away from the disc-shaped recording medium by the movement of the disc tray.

Therefore, it is not necessary to provide a dedicated driving force for removing the cover sheet from each disc-shaped recording medium or a dedicated driving force for moving the removing lever away from each disc-shaped recording medium. As a result, the structure can be simplified and the manufacturing cost can be reduced.

In the disc changer, preferably, the removing lever is made of a conductive material.

When the removing lever is made of a conductive material, the removing member is electrically connected to the cover sheets and the disc trays.

Therefore, when the removing lever is caused to slide along each cover sheet or each disc tray, the static electricity with which the cover sheet or the disc tray is charged can be discharged through the removing lever. Thus, the cover sheets and the disc trays can be prevented from being charged.

Preferably, the disc changer further includes a sheet guide which guides the cover sheet removed from the disc-shaped recording medium to a position separated from the disc-shaped recording medium.

In the case where the sheet guide which guides the cover sheet of each disc-shaped recording medium to a position separated from the disc-shaped recording medium is provided, the cover sheet of each disc-shaped recording medium can be separated from the disc-shaped recording medium when the disc-shaped recording medium is rotated.

Therefore, each disc-shaped recording medium can be smoothly rotated.

In the disc changer, preferably, the sheet guide is made of a conductive material.

When the sheet guide is made of a conductive material, the sheet guide is electrically connected to each cover sheet.

Therefore, the static electricity with which the cover sheets are charged can be discharged through the sheet guide, and the cover sheets can be prevented from being charged.

Preferably, the disc changer further includes a disc drive mechanism which includes a disc table rotated by a spindle motor and which is moved in the thickness direction after the disc tray and the disc-shaped recording medium conveyed by the feed rollers reach a recording-reproducing position at which information signals are recorded on or reproduced from the disc-shaped recording medium, the disc table including a centering projection which is inserted into a center hole formed in the disc-shaped recording medium. The disc tray is provided with a plurality of shaft insertion holes which extend through the disc tray in the thickness direction. The disc drive mechanism includes positioning shafts and, when the disc drive mechanism is moved in the thickness direction such that the centering projection is inserted into the center hole in the disc-shaped recording medium, the positioning shafts are inserted through the shaft insertion holes in the disc tray and are positioned around the outer periphery of the disc-shaped recording medium to position the disc-shaped recording medium with respect to the centering projection.

In the case where the positioning shafts are provided which are inserted through the shaft insertion holes in the disc tray to position the disc-shaped recording media with respect to the centering projection, the disc-shaped recording medium can be positioned by the positioning shafts when the disc drive mechanism is moved.

Thus, the disc-shaped recording medium can be positioned when the disc drive mechanism is moved, and the centering projection of the disc table can be reliably inserted into the center hole formed in the disc-shaped recording medium.

In the disc changer, preferably, each positioning shaft includes a large-diameter portion and a small-diameter portion which have different diameters. The disc-shaped recording medium is positioned by the large-diameter portions of the positioning shafts, and the small-diameter portions of the positioning shafts are positioned outside the outer peripheral surface of the disc-shaped recording medium when the centering projection of the disc table is inserted in the center hole in the disc-shaped recording medium.

Since the small-diameter portions are positioned outside the outer peripheral surface of the disc-shaped recording medium when the centering projection is inserted in the center hole in the disc-shaped recording medium, the positioning shafts are separated from the outer peripheral surface of the disc-shaped recording medium.

Therefore, the disc-shaped recording medium can be smoothly rotated.

In the disc changer, preferably, the disc-shaped recording medium has a sheet shape, and the disc changer further includes a disc-shaped stabilizer provided to retain the disc-shaped recording medium between the stabilizer and the disc table, the stabilizer being rotated by the rotation of the disc table and being made of a conductive metal material; and a holder body made of a conductive material, the holder body holding the stabilizer when the stabilizer is not rotated and being spaced from the stabilizer when the stabilizer is being rotated. The stabilizer and the holder body are electrically connected to each other when the stabilizer is not rotated.

Since the stabilizer and the holder body are electrically connected to each other when the stabilizer is not rotated, the stabilizer and the holder body can be electrically connected to the disc-shaped recording medium.

Therefore, the static electricity with which the disc-shaped recording medium is charged can be discharged through the stabilizer and the holder body, and the disc-shaped recording medium can be prevented from being charged.

A disc changer according to another embodiment of the present invention includes a cartridge-holding block configured to hold a disc cartridge in which a plurality of disc-shaped recording media are arranged at a first pitch in a thickness direction of the disc-shaped recording media; a disc-conveying block which conveys a disc-shaped recording medium to be inserted into or extracted from the disc cartridge in a process of inserting the disc-shaped recording medium into the disc cartridge or extracting the disc-shaped recording medium from the disc cartridge; and a disc-selecting block which selects the disc-shaped recording medium to be extracted from the disc-shaped recording medium in the process of extracting the disc-shaped recording medium from the disc cartridge. A first direction, a second direction, and a third direction are respectively defined as the thickness direction of the disc-shaped recording media, a direction which is perpendicular to the first direction and in which each disc-shaped recording medium is inserted into and extracted from the disc cartridge, and a direction which is perpendicular to the first direction and the second direction. Selection positions at which the disc-selecting block selects the respective disc-shaped recording media are separated from each other by a second pitch in the third direction and by a first pitch in the first direction in the order of storage positions at which the disc-shaped recording media are arranged in the first direction in the disc cartridge. The cartridge-holding block includes a cartridge holder to which the disc cartridge is attached, the cartridge holder being movable in the first direction. The disc-selecting block includes a selection slider which selects the disc-shaped recording medium to be extracted at the corresponding selection position, the selection slider being movable in the third direction. The ratio between an amount of movement per unit time of the cartridge holder in the first direction and an amount of movement per unit time of the selection slider in the third direction is equal to the ratio between the first pitch and the second pitch.

Therefore, in the disc changer, the ratio between the distances by which the cartridge holder and the selection slider are moved in the first direction and the third direction, respectively, per unit time correspond to the ratio between the first pitch and the second pitch.

Therefore, when the cartridge holder which holds the disc cartridge is moved, the position to which the selection slider is moved coincides with one of the selection positions in the second direction. Therefore, the operation of placing the selection slider at one of the selection positions can be easily performed.

In the disc changer, preferably, the cartridge holder is moved in the first direction and the selection slider is moved in the third direction by a single motor.

When the cartridge holder is moved in the first direction and the selection slider is moved in the third direction by a single motor, the cartridge holder and the selection slider can be moved by a driving force supplied by a single motor.

Therefore, the number of components can be reduced.

In the disc changer, preferably, the disc-shaped recording media are divided into a plurality of groups, each group including a predetermined number of disc-shaped recording media. The selection positions of the disc-shaped recording media in the respective groups are provided with a predetermined interval therebetween in the first direction. The same number of selection sliders as the number of groups are provided, and the selection of one of the disc-shaped recording media in each group is performed by the selection slider corresponding to the group. When one of the selection sliders is being moved, all of the remaining selection sliders are stopped.

When all of the selection sliders other than the selection slider which is being moved are stopped, the selection sliders can be selectively moved.

Thus, the efficiency of the operation of selecting the disc trays with the selection sliders can be increased.

Preferably, the disc changer further includes a common guide shaft which guides the selection sliders in the third direction.

When the common guide shaft which guides the selection sliders in the third direction is provided, the selection sliders can be moved in the third direction while being guided by the guide shaft.

Therefore, the number of components can be reduced.

In the disc changer, preferably, the selection slider includes a rack portion which extends in the third direction. The disc cartridge further includes a gear train including a plurality of gears which mesh with each other, the gears being arranged in the third direction, and the selection slider is moved in the third direction by causing the rack portion to successively mesh with the gears arranged next to each other.

In the case where the selection slider is moved in the third direction by causing the rack portion to successively mesh with the gears arranged next to each other, the length of the rack portion of the selection slider in the third direction can be set to a distance between the gears arranged next to each other.

Therefore, the length of the rack portion of the selection slider in the third direction can be reduced, and the size of the disc changer can be reduced accordingly.

### BRIEF DESCRIPTION OF THE DRAWINGS

FIG. 1, together with FIGS. 2 to 84, shows an embodiment of the present invention, and FIG. 1 is a schematic perspective view of a disc changer and a disc cartridge;

FIG. 2 is an exploded perspective view of the disc cartridge;

FIG. 3 is a partially exploded perspective view of the disc cartridge;

FIG. 4 is an enlarged perspective view of a tray lever, urging springs, and other components;

FIG. 5 is an enlarged perspective view of a part of a metal plate;

FIG. 6 is an enlarged front view of the disc cartridge;

FIG. 7 is an enlarged sectional view of a part of the disc cartridge;

FIG. 8 is an exploded perspective view of the disc cartridge in which disc trays and other components are divided into two groups;

FIG. 9 is an exploded perspective view of a disc tray, a disc-shaped recording medium, and a cover sheet;

FIG. 10 is an enlarged perspective view illustrating the positional relationship between tabs on the disc trays;

FIG. 11 is a perspective view of the disc tray, the disc-shaped recording medium, and the cover sheet;

FIG. 12 is a conceptual diagram illustrating the state in which the disc trays and other components are stored in a storage case;

FIG. 13 is a perspective view illustrating the state in which the disc trays and other components are stored in the storage case;

FIG. 14 is an enlarged sectional view illustrating the state in which the disc trays and other components are positioned by an opening-closing lid;

FIG. 15 is a conceptual diagram illustrating the state in which the disc trays and other components are stored in the storage case such that the disc trays and the other components are bent;

FIG. 16 is a conceptual diagram illustrating the relationship between the width of retaining grooves and the thickness of each component;

FIG. 17 is a conceptual diagram illustrating a simply supported beam as a model of the state in which the disc tray and other components are bent;

FIG. 18 is a schematic diagram illustrating the dimensional relationship between the disc tray and other components in a bent state;

FIG. 19 is a schematic diagram illustrating the dimensional relationship between the disc tray and other components in a bent state by a method other than that in FIG. 18;

FIG. 20 is a schematic diagram illustrating the dimensional relationship between the disc tray and other components in a bent state by a method other than that in FIG. 19;

FIG. 21 is a conceptual diagram illustrating the positional relationship between the disc trays, tray levers, and other components in a stored state;

FIG. 22, together with FIGS. 23 to 29, shows the operation of a tray lever, and FIG. 22 is an enlarged plan view illustrating the state in which a tab of a disc tray is locked by the tray lever;

FIG. 23 is an enlarged plan view illustrating the state in which the tab of the disc tray is released from the tray lever after the state shown in FIG. 22;

FIG. 24 is an enlarged plan view illustrating the state in which the tray lever is being continuously rotated after the state shown in FIG. 23;

FIG. 25 is an enlarged plan view illustrating the state in which the tray lever is being continuously rotated after the state shown in FIG. 24;

FIG. 26 is an enlarged plan view illustrating the state in which the tray lever has been rotated to a pushing completion position after the state shown in FIG. 25;

FIG. 27 is an enlarged plan view illustrating the state in which the pushing force applied to the tray lever by an operation pin is eliminated and the tray lever is held at a standby position after the state shown in FIG. 26;

FIG. 28 is an enlarged plan view illustrating the state in which the tray lever is pushed and rotated by the tab;

FIG. 29 is an enlarged plan view illustrating the state in which the tray lever is continuously pushed and rotated by the tab after the state shown in FIG. 28;

FIG. 30 is a schematic diagram illustrating the structure of the disc changer;

FIG. 31 is a perspective view of a base chassis;

FIG. 32 is a perspective view illustrating the inner structure of the disc changer;

FIG. 33 is a perspective view illustrating the inner structure of the disc changer in the state in which some components are removed;

FIG. 34 is an enlarged perspective view illustrating a front end section of the inner structure of the disc changer;

FIG. 35 is an enlarged perspective view corresponding to FIG. 34, illustrating the state in which an operation lever is removed;

FIG. 36 is an enlarged exploded perspective view of selection sliders;

FIG. 37 is an enlarged side view illustrating the state in which a pin attachment member is pivoted and an operation pin is caused to project from a pin-supporting member;

FIG. 38 is an enlarged side view illustrating the state in which the operation pin is not pushed by the pin attachment member;

FIG. 39 is a partially exploded perspective view illustrating the base chassis and some of the components mounted on the base chassis;

FIG. 40 is a partially exploded perspective view illustrating the base chassis and some of the components mounted on the base chassis;

FIG. 41 is an enlarged perspective view of gears;

FIG. 42 is an enlarged exploded perspective view of a cartridge holder;

FIG. 43 is an enlarged exploded perspective view of components of a disc-loading block;

FIG. 44 is an enlarged exploded perspective view of components of the disc-loading block and a disc-ejecting block;

FIG. 45 is an enlarged exploded perspective view of a conveying unit;

FIG. 46 is a partially exploded perspective view of the conveying unit;

FIG. 47 is an enlarged side view illustrating the state of components in the state in which an activation lever included in the disc-loading block has been moved to a back end of a movable range thereof;

FIG. 48 is an enlarged side view illustrating the state of components in the state in which the activation lever included in the disc-loading block has been moved to a front end of the movable range thereof;

FIG. 49 is an enlarged plan view illustrating the state in which the activation lever included in the disc-loading block is pivoted;

FIG. 50 is an enlarged exploded perspective view of components of the disc-ejecting block;

FIG. 51 is an enlarged exploded perspective view of a return lever and other components;

FIG. 52 is an enlarged perspective view of the return lever and other components;

FIG. 53 is an enlarged side view illustrating the state of components in the state in which an activation lever included in the disc-ejecting block has been moved to a back end of a movable range thereof;

FIG. 54 is an enlarged side view illustrating the state of components in the state in which the activation lever included in the disc-ejecting block has been moved to a front end of the movable range thereof;

FIG. 55 is an enlarged plan view illustrating the state in which the activation lever included in the disc-ejecting block is pivoted;

FIG. 56 is an enlarged side view illustrating the state in which a transmission lever is urged by a return spring;

FIG. 57, together with FIGS. 58 to 65, shows the operation of the return lever, and FIG. 57 is a partially sectioned enlarged plan view illustrating the state in which the disc tray does not yet project from the storage case;

FIG. 58 is a partially sectioned enlarged plan view illustrating the state in which the disc tray projects from the storage case;

FIG. 59 is a partially sectioned enlarged plan view illustrating the state in which the disc tray further projects from the storage case;

FIG. 60 is a partially sectioned enlarged plan view illustrating the state in which the disc tray is being inserted into the storage case;

FIG. 61 is a partially sectioned enlarged plan view illustrating the state in which the disc tray is being further inserted into the storage case after the state shown in FIG. 60;

FIG. 62 is a partially sectioned enlarged plan view illustrating the state in which the disc tray is being further inserted into the storage case after the state shown in FIG. 61;

FIG. 63 is a partially sectioned enlarged plan view illustrating the state in which the disc tray is being further inserted into the storage case after the state shown in FIG. 62;

FIG. 64 is a partially sectioned enlarged plan view illustrating the state in which the disc tray is being further inserted into the storage case after the state shown in FIG. 63;

FIG. 65 is a partially sectioned enlarged plan view illustrating the state in which the disc tray has been inserted into the storage case after the state shown in FIG. 64;

FIG. 66 is a partially exploded perspective view illustrating a support plate, a disc drive mechanism, and other components;

FIG. 67 is an enlarged exploded perspective view of the disc drive mechanism and other components;

FIG. 68 is an exploded perspective view of a disc-holding unit;

FIG. 69 is a perspective view of the disc-holding unit;

FIG. 70 is a partially sectioned enlarged side view illustrating the state in which the disc-shaped recording medium is not yet chucked;

FIG. 71 is an enlarged perspective view illustrating the state in which a part of the cover sheet is removed by removing levers;

FIG. 72 is an enlarged side view illustrating the state in which a part of the cover sheet is removed by the removing levers;

FIG. 73 is an enlarged side view illustrating the state in which the cover sheet is removed by the removing levers;

FIG. 74 is a plan view illustrating the state in which a positioning edge of the disc tray is in contact with positioning ribs and the disc tray is positioned;

FIG. 75 is a plan view illustrating the state in which the disc-shaped recording medium is positioned by positioning shafts;

FIG. 76 is a perspective view illustrating the state in which the disc-shaped recording medium is positioned by the positioning shafts;

FIG. 77 is a partially sectioned enlarged side view illustrating the state in which the disc-shaped recording medium is chucked;

FIG. 78 is a partially sectioned enlarged side view illustrating the state in which the disc-shaped recording medium is being chucked and rotated;

FIG. 79 is a block diagram of the disc changer;

FIG. 80 is a flowchart of an operation from when the disc cartridge is inserted into the cartridge holder to when a disc-shaped recording medium is selected;

FIG. 81 is a flowchart of a reproducing operation for a disc-shaped recording medium stored in the disc cartridge at a position corresponding to an address number designated by the user;

FIG. 82 is a flowchart of an operation of returning the disc-shaped recording medium from a position at which the reproducing operation for the disc-shaped recording medium has been performed to the position corresponding to the original address number;

FIG. 83 is a flowchart of an operation performed when the address number of a selection position designated by the user is changed; and

FIG. 84 is a flowchart of an operation of ejecting the disc cartridge from the cartridge holder.

### DESCRIPTION OF THE PREFERRED EMBODIMENT

An embodiment of the present invention will now be described with reference to the accompanying drawings.

In the following description, for convenience of explanation, a direction in which a disc cartridge is inserted into a disc changer is referred to as a backward direction and a direction in which the disc cartridge is extracted from the disc changer is referred to as a forward direction.

Vertical, front-back, and left-right directions described below are simply used for convenience of explanation, and the present invention is not limited to these directions.

### Schematic Structure of Disc Changer

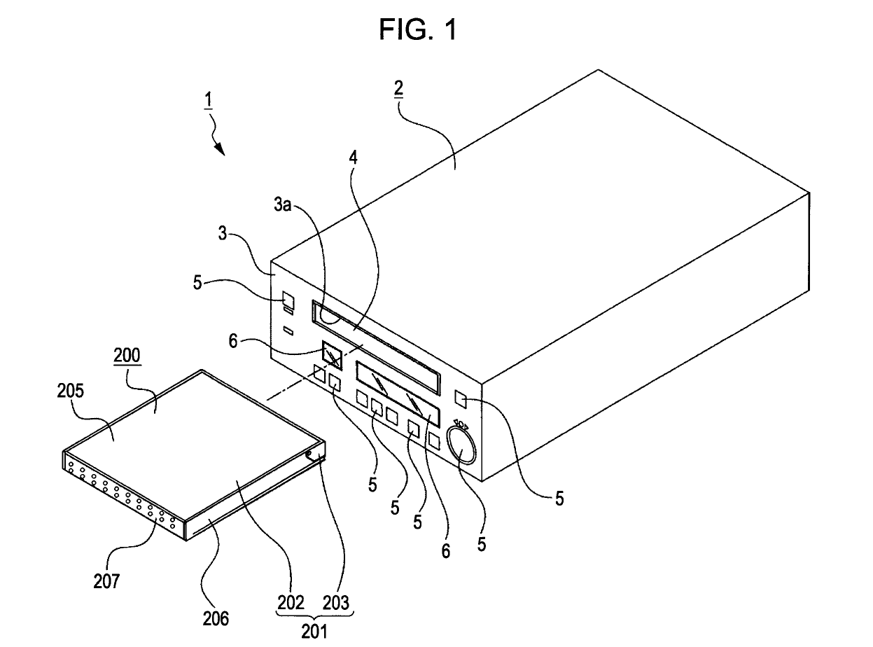

As shown in FIG. 1, a disc changer 1 includes a housing 2 and components disposed in the housing 2. The housing 2 has a rectangular parallelepiped shape which is long in, for example, the front-back direction.

The housing 2 includes a front panel 3, and an opening 3a through which a disc cartridge 200 can be inserted into or extracted from the housing 2 is formed in the front panel 3. A cover 4 which is capable of opening and closing the opening 3a is provided on the front panel 3 in a pivotable manner.

A plurality of operation members 5, 5, . . . and display members 6 and 6 are arranged on a front surface of the front panel 3. The operation members 5, 5, . . . include, for example, a play button, a record button, a stop button, a disc change button, an eject button, and a power button. The display members 6 and 6 display, for example, a disc number of a disc for which playback or recording is performed and a playback position.

### Schematic Structure of Disc Cartridge

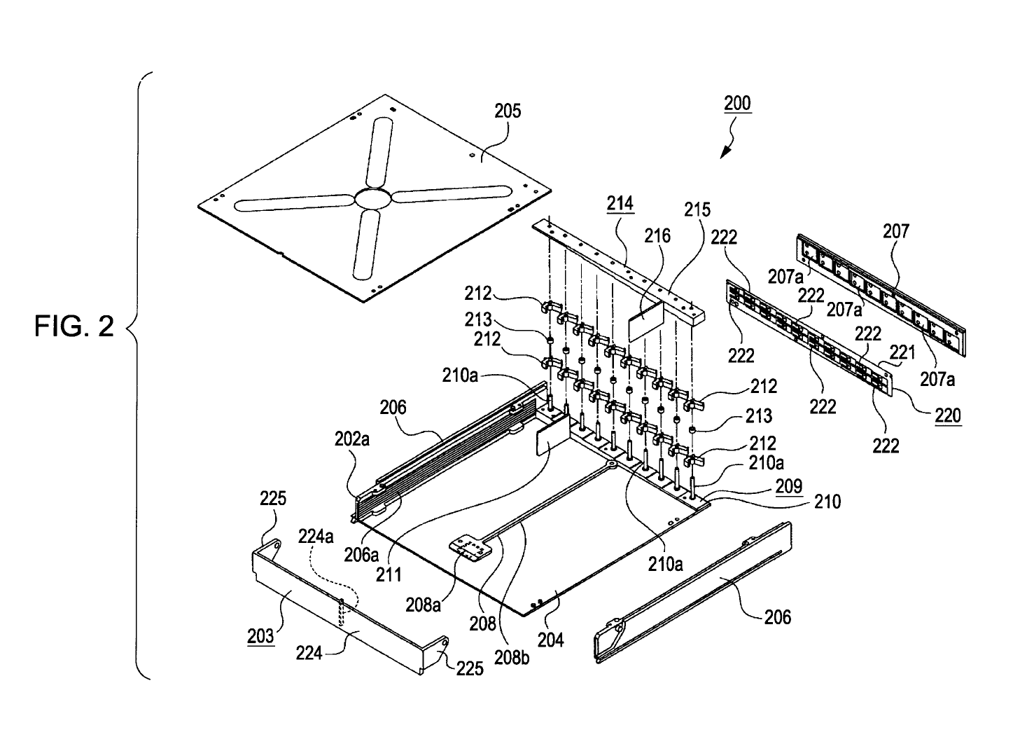

The disc cartridge 200 includes a storage case 201 and components disposed in the storage case 201. The storage case 201 includes a main body 202 and an opening-closing lid 203 provided at the back end of the main body 202 in a pivotable manner (see FIGS. 1 and 2).

As shown in FIG. 2, the main body 202 includes a bottom surface section 204 and a top surface section 205, each of which extends substantially perpendicular to the vertical direction, a pair of side surface sections 206 and 206, and a front surface section 207 which extends between the side surface sections 206 and 206 at the front end thereof. Thus, the main body 202 is formed in a box shape with an open side at the back, and the open side at the back functions as an opening 202a.

The side surface sections 206 and 206 are made of, for example, a conductive material.

A tray receiver 208 is attached to the bottom surface section 204 at a central position thereof in the left-right direction. The tray receiver 208 includes a wide portion 208a disposed at a position near the back end of the bottom surface section 204 and a narrow portion 208b which projects forward from the wide portion 208a at a central position thereof in the left-right direction. The wide portion 208a and the narrow portion 208b are formed integrally with each other. A front-end portion of the tray receiver 208 is disposed at a position near the front end of the bottom surface section 204.

### Inner Structure of Disc Cartridge

A lower support member 209 is attached to the bottom surface section 204 at the front end thereof. The lower support member 209 includes a support portion 210 which extends in the left-right direction and a positioning rib 211 which projects backward from the support portion 210 at a position near the right end thereof.

The support portion 210 is formed in a stepped shape such that the height of the top surface of the support portion 210 increases stepwise toward the right. Sections divided by the steps are provided with support shafts 210a, 210a, . . . which project upward. The number of support shafts 210a, 210a, . . . is, for example, ten. The difference in height between the adjacent sections divided by each step is, for example, 0.5 mm.

The height of the positioning rib 211 is larger than the height of the support portion 210, and the top end of the positioning rib 211 is positioned above the top surface of the support portion 210. The height of the positioning rib 211 is substantially equal to the distance between the bottom surface section 204 and the top surface section 205, and the positioning rib 211 is formed in a plate shape which extends substantially perpendicular to the left-right direction.

Tray levers 212, 212, . . . are rotatably supported by the respective support shafts 210a, 210a, . . . . The thickness of each tray lever 212 is set to, for example, 3 mm. Each support shaft 210a supports, for example, two tray levers 212 and 212, which are separated from each other in the vertical direction, and a spacer 213, through which the support shaft 210a is inserted, is disposed between the two tray levers 212 and 212.

Thus, the tray levers 212, 212, . . . are arranged in two rows, that is, upper and lower rows, such that two tray levers 212 and 212 are rotatably supported by each of the support shafts 210a, 210a, . . . .

As described above, the support portion 210 of the lower support member 209 is formed in a stepped shape such that the height of the support portion 210 increases stepwise toward the right. Therefore, the vertical position of the tray levers 212, 212, . . . disposed next to each other in the left-right direction also increases stepwise toward the right.

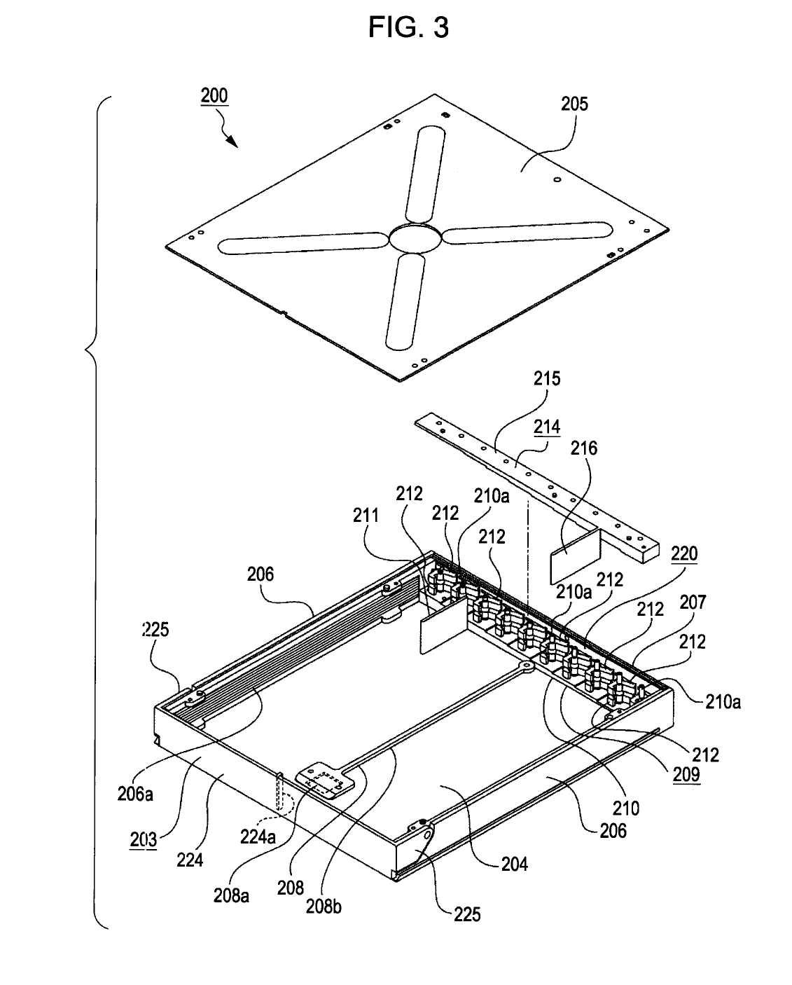

In the state in which the tray levers 212, 212, . . . are supported by the respective support shafts 210a, 210a, . . . , an upper support member 214 is attached to the support shafts 210a, 210a, . . . at the top ends thereof (see FIGS. 2 and 3). The upper support member 214 includes a support portion 215 which extends in the left-right direction and a positioning rib 216 which projects backward from the support portion 215 at a position near the left end thereof.

The support portion 215 is formed in a stepped shape such that the height of the bottom surface of the support portion 215 increases stepwise toward the right.

The height of the positioning rib 216 is larger than the height of the support portion 215, and the bottom end of the positioning rib 216 is positioned below the bottom surface of the support portion 215. The height of the positioning rib 216 is substantially equal to the distance between the bottom surface section 204 and the top surface section 205, and the positioning rib 216 is formed in a plate shape which extends substantially perpendicular to the left-right direction.

In the state in which the upper support member 214 is attached to the support shafts 210a, 210a, . . . at the top ends thereof, the positioning rib 216 is disposed parallel to the positioning rib 211 of the lower support member 209 with a space therebetween in the left-right direction.

The top surface of the upper support member 214 is attached to the bottom surface of the top surface section 205.

### Tray Lever

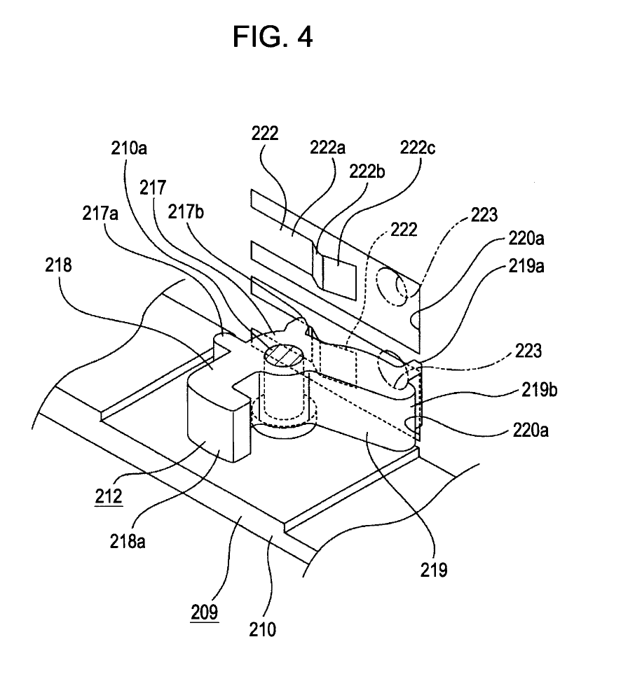

As shown in FIG. 4, each tray lever 212 is substantially L-shaped in a plan view and includes an annular support portion 217 supported by the corresponding support shaft 210a and first and second projections 218 and 219 which project from the support portion 217 in directions substantially perpendicular to each other. The support portion 217 and the first and second projections 218 and 219 are formed integrally with each other.

The support portion 217 is provided with a first engagement projection 217a and a second engagement projection 217b which are spaced from each other in a circumferential direction of the support portion 217.

A lock projection 218a which projects in substantially the same direction as the direction in which the second projection 219 projects is provided on the first projection 218 at an end thereof.

A stopper projection 219a is provided on the second projection 219 at a position near an end thereof, and an end portion of the second projection 219 functions as a pushing portion 219b.

### Metal Plate

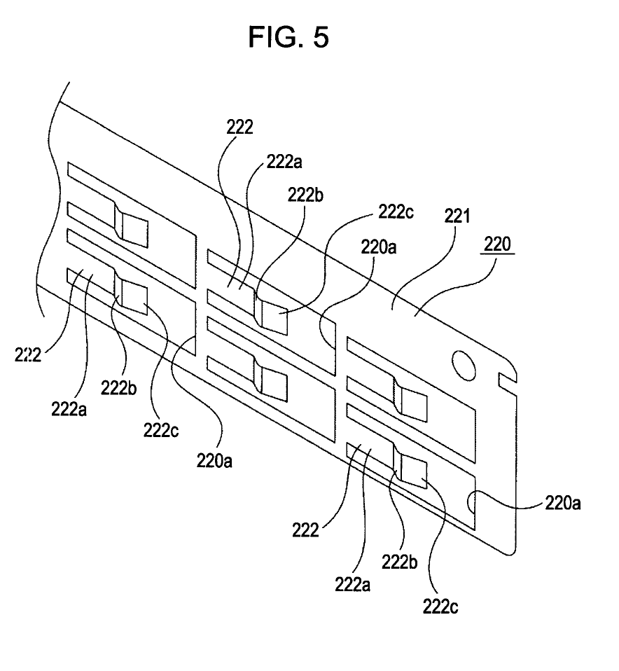

A metal plate 220 is disposed at the front side of the tray levers 212, 212, . . . , and is attached to a back surface of the front surface section 207. As shown in FIG. 5, the metal plate 220 has an oblong rectangular shape which extends in the left-right direction, and includes a base surface portion 221 and a plurality of urging springs 222, 222, . . . formed by punching out predetermined sections. The base surface portion 221 and the urging springs 222, 222, . . . are formed integrally with each other. The number of urging springs 222, 222, . . . is, for example, twenty, and is the same as the number of tray levers 212, 212, . . . .

As described above, the base surface portion 221 and the urging springs 222, 222, . . . are formed integrally with each other by processing the metal plate 220. Therefore, it is not necessary to provide the urging springs 222, 222, . . . as separate components and the number of components can be reduced.

The urging springs 222, 222, . . . are disposed near the respective tray levers 212, 212, . . . , more specifically, directly in front of the respective tray levers 212, 212, . . . . The urging springs 222, 222, . . . are arranged in two rows, that is, upper and lower rows, which each include ten urging springs 222, 222, . . . arranged with constant intervals therebetween, and are positioned such that the height thereof increases toward the right.

Each urging spring 222 includes a base portion 222a which projects continuously from the base surface portion 221 in the left-right direction; a first inclined portion 222b which continues from the base portion 222a and which is inclined such that the position thereof is shifted backward toward the left; and a second inclined portion 222c which continues from the first inclined portion 222b and which is inclined such that the position thereof is shifted forward toward the left.

Spaces are provided around each of the urging springs 222, 222, . . . in the metal plate 220, that is, at the upper, lower, and left sides of each urging spring 222. The spaces at the left sides of the urging springs 222, 222, . . . serve as pushing through holes 220a, 220a, . . . .

The pushing through holes 220a, 220a, . . . are disposed directly in front of the second projections 219, 219, . . . of the respective tray levers 212, 212, . . . .

### Structure of Side Surface Sections of Storage Case

A plurality of retaining grooves 206a, 206a, . . . are formed in each of the side surface sections 206 and 206 of the storage case 201. The retaining grooves 206a, 206a, . . . retain disc trays, which will be described below. Twenty retaining grooves 206a, 206a, . . . , for example, are formed in each of the side surface sections 206 and 206 such that the retaining grooves 206a, 206a, . . . extend in the front-back direction. Intervals (pitch) between the retaining grooves 206a, 206a, . . . in the vertical direction is set to, for example, 0.5 mm.

A plurality of recesses 207a, 207a, . . . which open backward are formed in a back surface of the front surface section 207 of the storage case 201. The recesses 207a, 207a, . . . are formed with constant intervals therebetween in the left-right direction, and the height of the recesses 207a, 207a, . . . increases toward the right.

### Structure of Front Surface Section of Storage Case

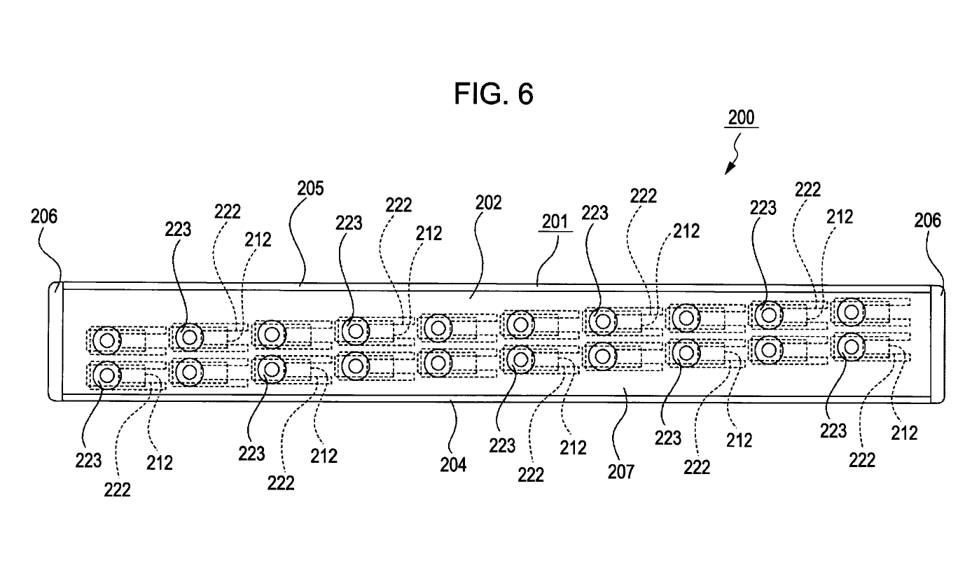

A plurality of pin-insertion holes 223, 223, . . . are formed in the front surface of the front panel 207 (see FIG. 6). The pin-insertion holes 223, 223, . . . are arranged in two rows, that is, upper and lower rows, which each include ten pin-insertion holes 223, 223, . . . arranged with constant intervals therebetween, and are positioned such that the height thereof increases toward the right. The distance between the centers of the pin-insertion holes 223, 223, . . . arranged in the vertical direction is set to, for example, 5 mm, an the distance between the centers of the pin-insertion holes 223, 223, . . . arranged next to each other in the left-right direction is set to, for example, 12 mm.

The pin-insertion holes 223, 223, . . . are positioned directly in front of the respective pushing through holes 220a, 220a, . . . formed in the metal plate 220.

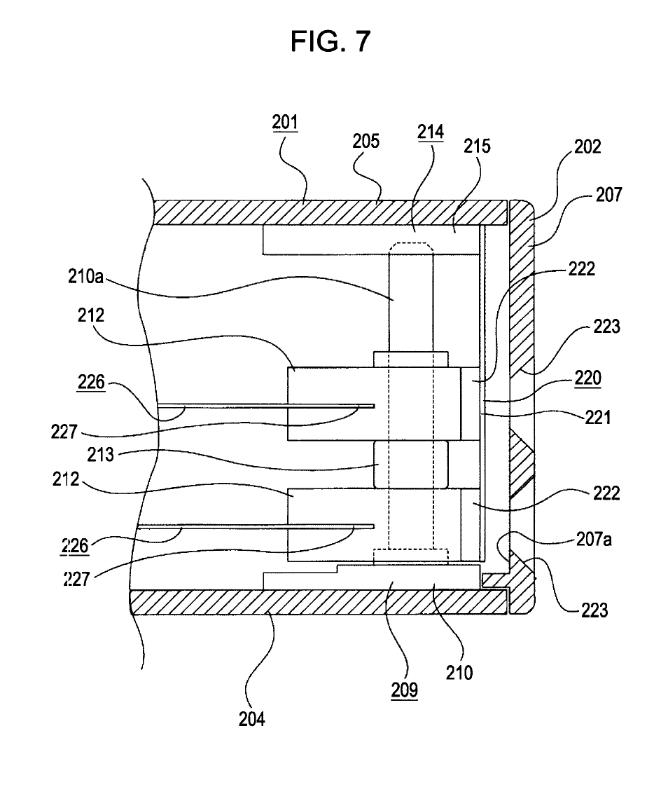

Each pin-insertion hole 223 is formed such that the diameter thereof increases toward the front (see FIG. 7). The pin-insertion holes 223, 223, . . . open into the respective recesses 207a, 207a, . . . at back ends thereof.

### Opening-Closing Lid

As shown in FIGS. 2 and 3, the opening-closing lid 203 includes an oblong opening-closing portion 224 which extends in the left-right direction and support projections 225 and 225 which project forward from the left and right ends of the opening-closing portion 224. The support projections 225 and 225 are supported by the respective side surface sections 206 and 206 at back ends thereof such that the opening-closing lid 203 can be rotated with respect to the side surface sections 206 and 206.

In the state in which the opening 202a in the main body 202 is closed by the opening-closing lid 203, the opening-closing lid 203 is locked by a lock mechanism (not shown).

A positioning portion 224a is provided on the opening-closing portion 224 of the opening-closing lid 203 at a central position thereof in the left-right direction. The positioning portion 224a is provided on an inner surface of the opening-closing portion 224 such that the positioning portion 224a extends in a direction perpendicular to the direction in which the opening-closing portion 224 extends. The length of the positioning portion 224a is substantially equal to the width of the opening 202a in the main body 202 in the vertical direction.

### Disc Tray

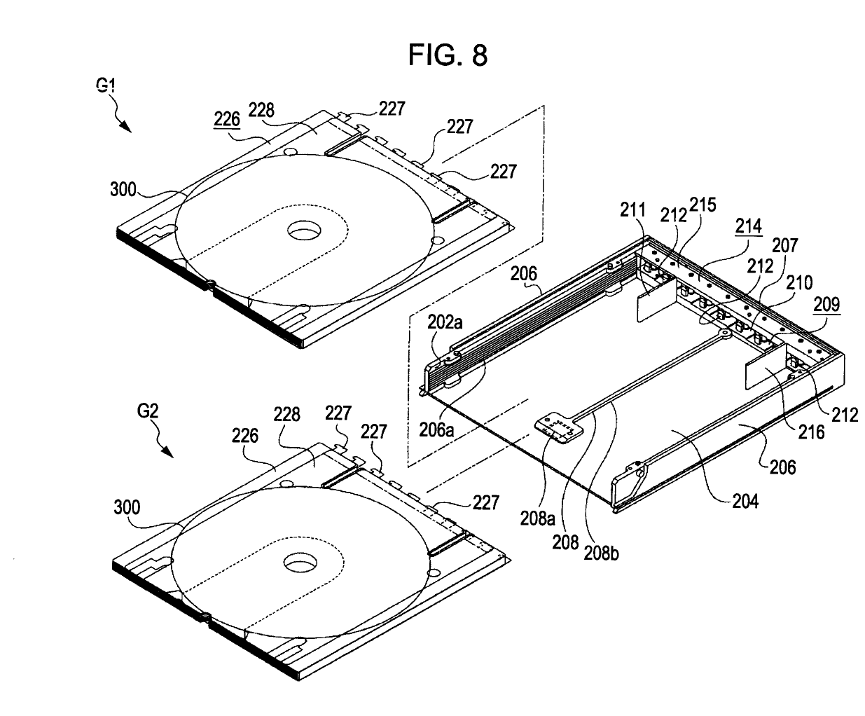

A plurality of disc trays 226, 226, . . . are stored in the storage case 201 such that the disc trays 226, 226, . . . are arranged in the vertical direction (see FIG. 8).

Each disc tray 226 is made of a sheet-shaped, conductive metal material having a thickness of, for example, 0.15 mm, and is formed as an elastic body having a high Young's modulus. A material, such as stainless steel, having high rigidity and bending strength is used as the material of each disc tray 226.

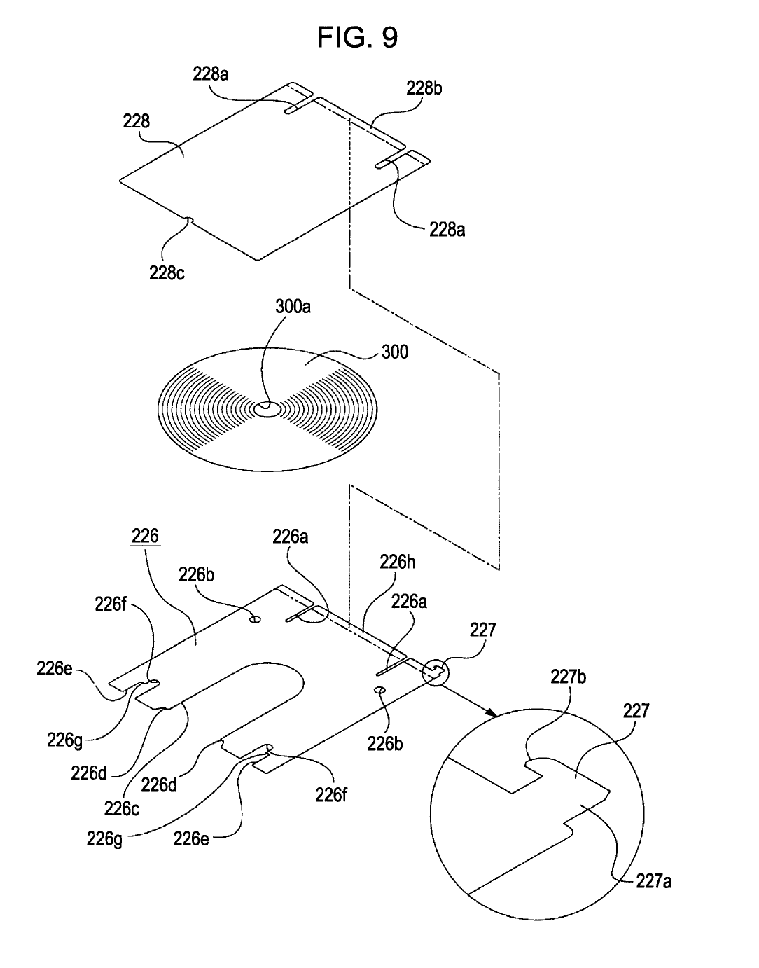

Rib arrangement notches 226a and 226a are formed in each disc tray 226 at the front end thereof such that the rib arrangement notches 226a and 226a are separated from each other in the left-right direction (see FIG. 9). The rib arrangement notches 226a and 226a extend in the front-back direction and are slit-shaped such that the rib arrangement notches 226a and 226a open at the front ends thereof.

Each disc tray 226 is provided with a tab 227 which projects forward from the front edge of the disc tray 226. The tab 227 includes a pushing portion 227a which continues from the front edge of the disc tray 226 and a lock-receiving projection 227b which projects rightward from the front end of the pushing portion 227a.

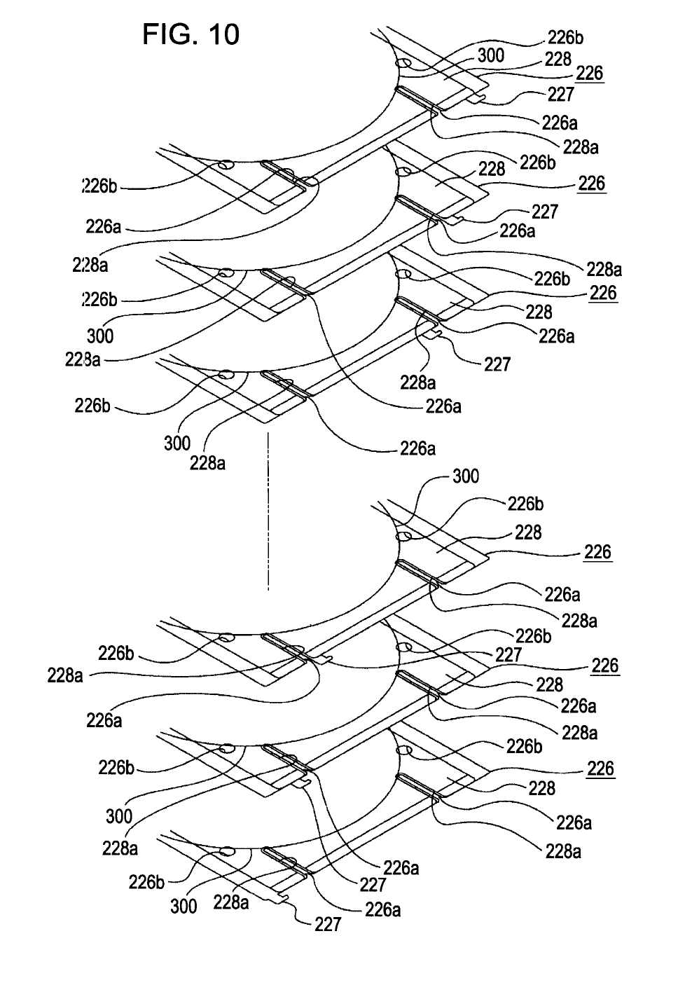

As shown in FIGS. 8 and 10, the tabs 227, 227, . . . on the respective disc trays 226, 226, . . . are formed at different positions in the left-right direction in accordance with the positions at which the respective disc trays 226, 226, . . . are stored in the storage case 201. For example, twenty disc trays 226, 226, . . . are stored in the storage case 201 (see FIG. 8). A group including ten disc trays 226, 226, . . . positioned in an upper section is defined as a first group G1, and a group including ten disc trays 226, 226, . . . positioned in a lower section is defined as a second group G2. In this case, the tab 227 on the disc tray 226 at the top in the first group G1 and the tab 227 on the disc tray 226 at the top in the second group G2 are disposed at the rightmost position. In each of the groups G1 and G2, the position at which each tab 227 is formed is successively shifted leftward as the height of the position at which the corresponding disc tray 226 is stored in the storage case 201 decreases. Accordingly, the tab 227 formed on the tenth disc tray 226 from the top in each of the groups G1 and G2 is at the leftmost position.

In each of the first group G1 and the second group G2, the intervals between the tabs 227, 227, . . . spaced from each other in the vertical direction are set to, for example, 5 mm. In addition, in each of the groups G1 and G2, a pitch in the left-right direction between the tabs 227, 227, . . . formed on the disc trays 226, 226, . . . arranged next to each other in the vertical direction is set to, for example, 12 mm. Therefore, in the state in which the disc trays 226, 226, . . . are stored in the storage case 201, the tabs 227, 227, . . . are positioned behind the respective tray levers 212, 212, . . . , which are disposed at the front end of the storage case 201, at positions close to the respective tray levers 212, 212, . . . .

Each disc tray 226 has shaft insertion holes 226b formed therein at positions near the front end of the disc tray 226 such that the shaft insertion holes 226b are separated from each other in the left-right direction (see FIG. 9).

An arrangement cutout 226c is formed in each disc tray 226 such that the arrangement cutout 226c opens backward. The arrangement cutout 226c extends from the back end of each disc tray 226 to a central position thereof, and a disc tray, which will be described below, is placed at the arrangement cutout 226c.

Each disc tray 226 has small notches formed continuously from the arrangement cutout 226c at the front end of the arrangement cutout 226c, and front edges of these notches function as positioning edges 226d and 226d.

Insertion notches 226e and 226e are formed in each disc tray 226 at either side of the arrangement cutout 226c in the left-right direction. Front-end portions of the insertion notches 226e and 226e function as shaft insertion holes 226f and 226f, and operation edges 226g and 226g are formed in the open edges of the insertion notches 226e and 226e at positions near the front ends thereof. A front-end portion of each disc tray 226 functions as a bonding portion 226h.

### Cover Sheet

Cover sheets 228, 228, . . . are made of a sheet-shaped resin material having a thickness smaller than the thickness of the disc trays 226, 226, . . . .

Rib arrangement notches 228a and 228a are formed in each cover sheet 228 at the front end thereof such that the rib arrangement notches 228a and 228a are separated from each other in the left-right direction. The rib arrangement notches 228a and 228a extend in the front-back direction and are slit-shaped such that the rib arrangement notches 226a and 226a open at the front ends thereof. The rib arrangement notches 228a and 228a are positioned directly above the rib arrangement notches 226a and 226a formed in each disc tray 226.

A front-end portion of each cover sheet 228 functions as a bonding portion 228b, and is bonded to the bonding portion 226h of the corresponding disc tray 226 by, for example, adhesion.

A positioning recess 228c which opens backward is formed in the back edge of each cover sheet 228 at a central position thereof in the left-right direction.

The dimension of each cover sheet 228 in the left-right direction is smaller than that of each disc tray 226 in the left-right direction, and the dimension of each cover sheet 228 in the front-back direction is substantially equal to that of each disc tray 226 in the front-back direction. Therefore, in the state in which the bonding portion 228b of each cover sheet 228 is bonded to the bonding portion 226h of the corresponding disc tray 226, the front edge of the cover sheet 228 substantially coincides with the front edge of the disc tray 226. In addition, the left and right edges of the cover sheet 228 are positioned inside the left and right edges of the disc tray 226.

### Disc-shaped Recording Medium

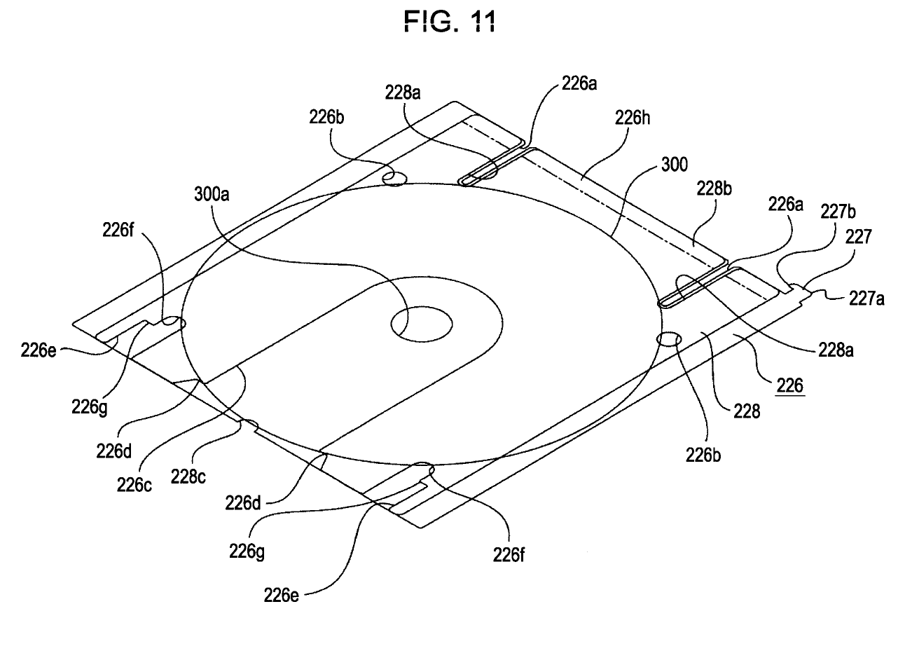

A disc-shaped recording medium 300 having a sheet shape and made of a thin resin material whose thickness is larger than that of each cover sheet 228 and smaller than that of each disc tray 226 is placed between each disc tray 226 and the corresponding cover sheet 228 (see FIGS. 10 and 11). The diameter of each disc-shaped recording medium 300 is smaller than the dimensions of each disc tray 226 in the front-back and left-right directions. In the state in which each disc-shaped recording medium 300 is placed between the disc tray 226 and the cover sheet 228, the outer peripheral edge of the disc-shaped recording medium 300 is positioned near the inner portions of the open edges of the four shaft insertion holes 226b, 226b, 226f, and 226f formed in the disc tray 226.

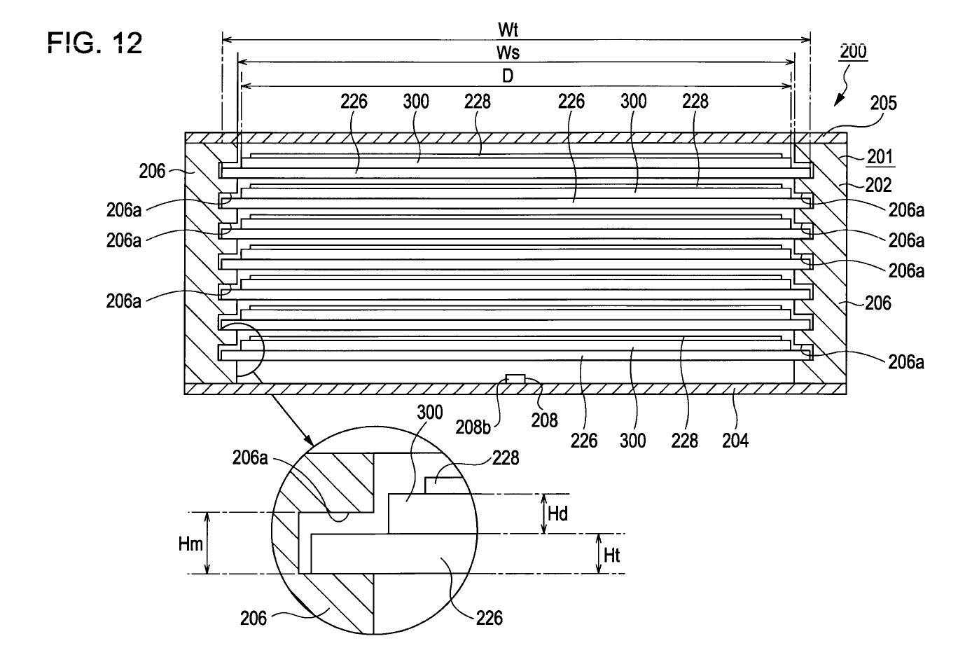

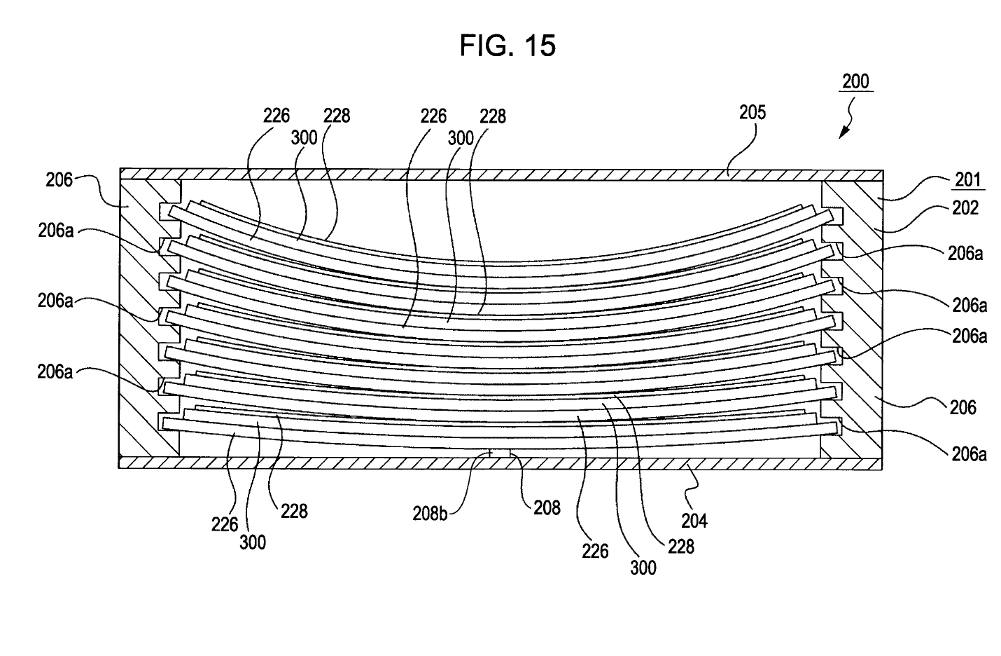

Each disc-shaped recording medium 300 is retained by being placed between the disc tray 226 and the cover sheet 228 as described above, and is stored in the storage case 201 together with the disc tray 226 and the cover sheet 228. In the state in which each disc-shaped recording medium 300 is stored, as shown in FIG. 12, the left and right edge portions of each disc tray 226 are inserted into and retained by the retaining grooves 206a and 206a formed in the side surface sections 206 and 206. FIG. 12 and FIG. 15, which will be described below, are the conceptual diagrams illustrating the manner in which the disc trays 226, 226, . . . , the disc-shaped recording media 300, 300, . . . and the cover sheets 228, 228, . . . are stored in the storage case 201, and the number of disc trays 226, 226, . . . , disc-shaped recording media 300, 300, . . . , and cover sheets 228, 228, . . . shown in the figures is smaller than the actual number.

Since each disc tray 226 is made of a conductive material, as described above, each disc-shaped recording medium 300 can be prevented from being charged with electricity. Each disc-shaped recording medium 300 can also be prevented from being charged with electricity by forming each cover sheet 228 using a conductive material.

In addition, since the side surface sections 206 and 206 of the storage case 201 are made of a conductive material, as described above, each disc tray 226 and each disc-shaped recording medium 300 can be prevented from being charged with electricity.

### Dimensions of Disc Cartridge

In the disc cartridge 200, a width Wt of each disc tray 226 in the left-right direction is larger than a diameter D of each disc-shaped recording medium 300, and a distance Ws between the side surface sections 206 and 206 is larger than the diameter D of each disc-shaped recording medium 300 and smaller than the width Wt of each disc tray 226 in the left-right direction. In addition, a width Hm in the vertical direction of each retaining groove 206a formed in each side surface section 206 is larger than a thickness Ht of each disc tray 226 and smaller than the sum of the thickness Ht of each disc tray 226 and a thickness Hd of each disc-shaped recording medium 300.

Therefore, each disc-shaped recording medium 300 is not inserted into the retaining grooves 206a and 206a but is positioned by the inner surfaces of the side surface sections 206 and 206 in the left-right direction. Thus, in the disc cartridge 200, it is not necessary to provide a positioning portion for positioning each disc-shaped recording medium 300 on the disc tray 226. Therefore, the thickness of each disc tray 226 can be reduced and the number of disc-shaped recording media 300, 300, . . . which can be stored in the disc cartridge 200 can be increased.

### Storage of Disc-shaped Recording Media

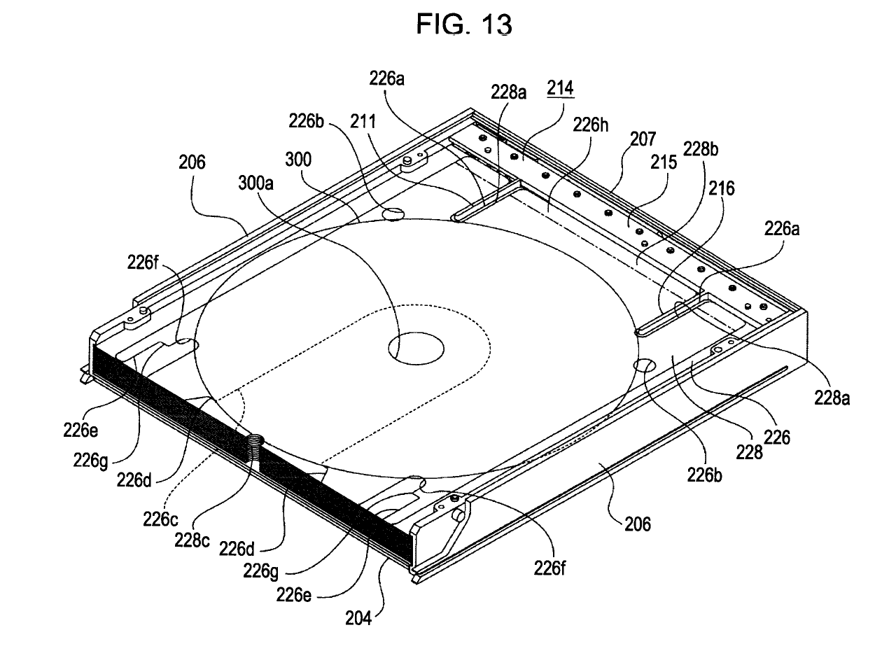

In the state in which the disc-shaped recording media 300, 300, . . . are stored in the above-described manner, as shown in FIG. 13, the positioning ribs 211 and 216 are inserted into the rib arrangement notches 226a, 226a, . . . in all of the disc trays 226, 226, . . . and the rib arrangement notches 228a, 228a, . . . in all of the cover sheets 228, 228, . . . .

In this state, the back ends of the positioning ribs 211 and 216 are in contact with or close to the outer peripheral surfaces of the disc-shaped recording media 300, 300, . . . . Therefore, the disc-shaped recording media 300, 300, . . . are positioned in the front-back direction by the positioning ribs 211 and 216.

Since all of the disc-shaped recording media 300, 300, . . . can be positioned by the positioning ribs 211 and 216, it is not necessary to provide the same number of positioning ribs 211 and 216 as the number of disc-shaped recording media 300, 300, . . . . As a result, the number of components can be reduced and the structure can be simplified.

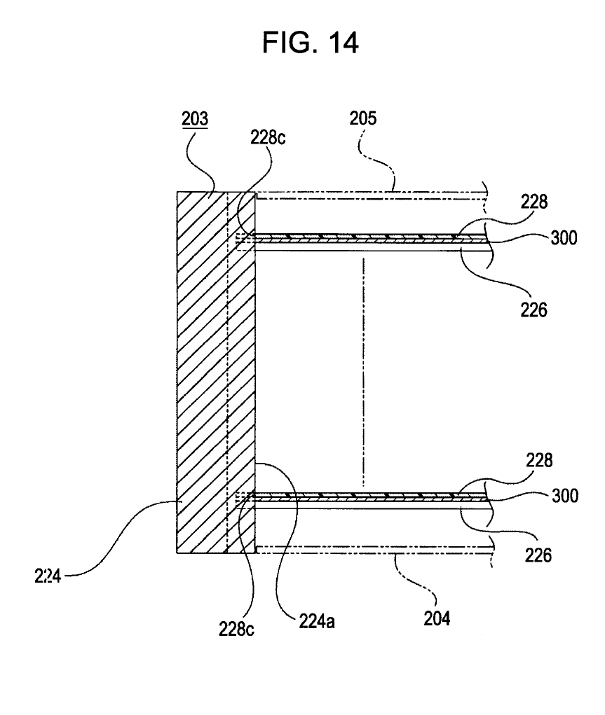

In the state in which the disc-shaped recording media 300, 300, . . . are stored, as shown in FIG. 14, the opening 202a in the main body 202 is closed by the opening-closing lid 203 and the positioning portion 224a on the opening-closing lid 203 is inserted into the positioning recesses 228c, 228c, . . . in all of the cover sheets 228, 228, . . . .

In this state, the positioning portion 224a is in contact with or close to the outer peripheral surfaces of the disc-shaped recording media 300, 300, . . . . Therefore, the disc-shaped recording media 300, 300, . . . are positioned in the front-back direction by the positioning portion 224a.

Thus, the disc-shaped recording media 300, 300, . . . are positioned by the positioning portion 224a on the opening-closing lid 203 with which the opening 202a is closed. Therefore, the disc-shaped recording media 300, 300, . . . can be prevented from falling from the storage case 201, and can be positioned at the same time.

In addition, since all of the disc-shaped recording media 300, 300, . . . are positioned by the opening-closing lid 203, the number of components can be reduced and the structure can be simplified.

### Bending of Disc Trays

The state in which the disc trays 226, 226, . . . are bent while the disc-shaped recording media 300, 300, . . . are held by the disc trays 226, 226, . . . and are stored in the storage case 201 will now be described (see FIG. 15).

As described above, each disc tray 226, each disc-shaped recording medium 300, and each cover sheet 228 are sheet-shaped, and may therefore be bent such that central areas thereof in the left-right direction are displaced downward with respect to the other areas when a load due to vibration or external force is applied.

The tray receiver 208 is attached to the bottom surface section 204 of the storage case 201. In the state in which the disc trays 226, 226, . . . and the other components are bent to the maximum extent, a central portion of the bottommost disc tray 226 in the left-right direction thereof comes into contact with the tray receiver 208. In this state, the disc trays 226, 226, . . . are retained by the retaining grooves 206a, 206a, . . . formed in the side surface sections 206 and 206. Since the retaining grooves 206a, 206a, . . . are arranged with a predetermined pitch in the vertical direction, the topmost disc tray 226 is bent by the maximum amount.

In the disc cartridge 200, when a load due to vibration or external force is applied, there may also be a case in which the disc trays 226, 226, . . . and the other components are bent such that the central areas thereof in the left-right direction are displaced upward with respect to the other areas. However, only the case in which the disc trays 226, 226, . . . and the other components are bent downward will be described.

Each disc tray 226 is made of a material having high rigidity and bending strength, as described above, and each cover sheet 228 and each disc-shaped recording medium 300 are made of a material, such as plastic film, having low rigidity and bending strength. Therefore, in the following discussion regarding the state in which each disc tray 226 and the other components are bent, the bending strengths of each cover sheet 228 and each disc-shaped recording medium 300 are ignored.

In addition, the weights of each cover sheet 228 and each disc-shaped recording medium 300 are extremely smaller than that of each disc tray 226. Therefore, in the following discussion regarding the state in which each disc tray 226 and the other components are bent, the weights of each cover sheet 228 and each disc-shaped recording medium 300 are also ignored.

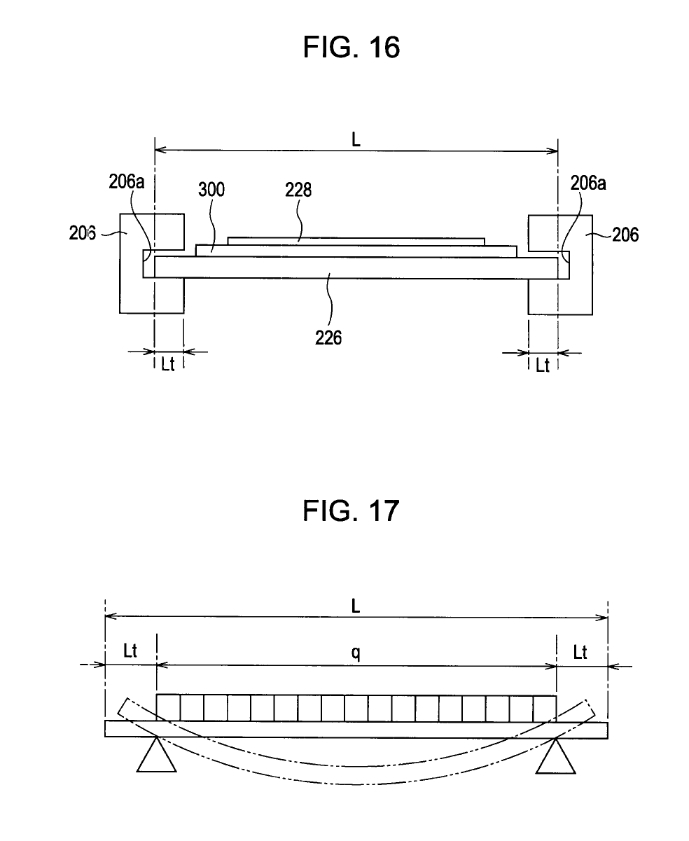

As shown in FIG. 16, the length of each disc tray 226 in the left-right direction is expressed as L, and amounts of insertion (lengths in the left-right direction) by which the disc tray 226 is inserted into the respective retaining grooves 206a and 206a in the state in which the disc tray 226 is not bent are expressed as Lt and Lt.

The state in which the disc tray 226 is bent can be considered as a model of a simply supported beam which receives a uniformly distributed load q, as shown in FIG. 17. In this state, when δ is the maximum amount of bending and θ is the maximum bending angle, δ and θ can be expressed as follows:

δ=5qL⁴/384EI (1)

θ=qL³/24EI (2)

In the above equations, E is the Young's modulus of each disc tray 226 and I is the moment of second order of each disc tray 226. The maximum amount of bending 6 is obtained at the topmost disc tray 226.

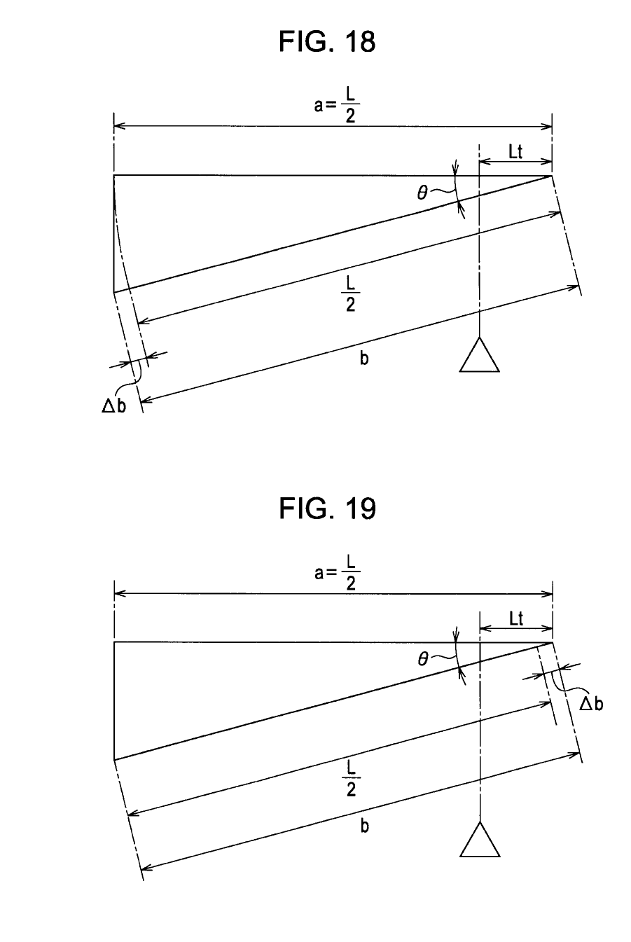

FIG. 18 is a diagram illustrating a simplified model of the right half of the simply supported beam in the state in which the uniformly distributed load q is applied. In the state in which the uniformly distributed load q is applied to the simply supported beam, no force is applied to the simply supported beam in the longitudinal direction thereof (in the left-right direction in FIG. 18). In addition, in the state in which the simply supported beam is bent, a compressive stress is applied to an upper portion of the simply supported beam which is above the neutral axis and a tensile stress is applied to a lower portion of the simply supported beam which is below the neutral axis. However, the amounts of these stresses are negligible as a force applied to the simply supported beam in the longitudinal direction thereof. Therefore, in the state in which the uniformly distributed load q is applied to the simply supported beam, it is assumed that the simply supported beam neither expands nor contracts in the longitudinal direction thereof.

The length L/2 of the right half of the simply supported beam is defined as follows:

L/2=a (where Δa=Δb cos θ) (3)

In this case, the distance b between the right end of the simply supported beam before the simply supported beam is bent and the center of the simply supported beam after the simply supported beam is bent can be calculated as follows:

$$\begin{matrix}b = L / 2 + Δ b \\ = a + Δ b\end{matrix} \qquad ( 4 )$$

Therefore, as shown in FIG. 19, in the state in which the simply supported beam is bent, the right end of the simply supported beam is shifted leftward by Δb.

Accordingly, it can be determined that each disc tray 226 can be prevented from falling from the retaining grooves 206a and 206a even when the disc tray 226 is bent if the amount of insertion Lt by which the disc tray 226 is inserted into each retaining groove 206a satisfies the following condition:

Lt>Δa (5)

Therefore, the disc cartridge 200 is structured such that Conditional Expression (5) can be satisfied even if the amount of bending is at the maximum value δ.

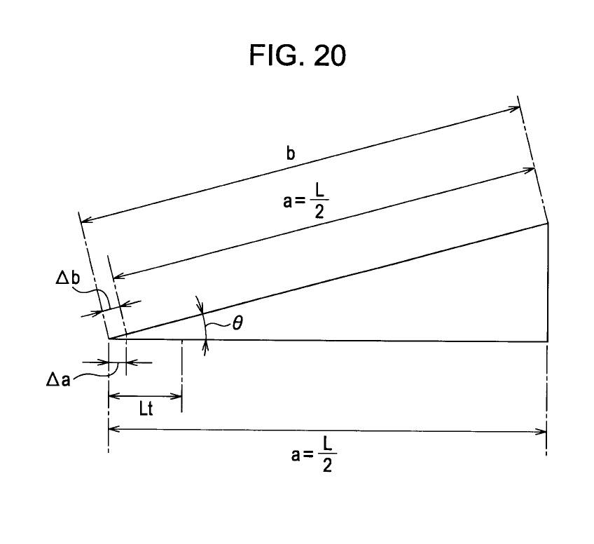

FIG. 20 is a diagram obtained by changing the orientation of FIG. 19 to facilitate understanding. Referring to FIG. 20, the following equations can be derived.

$$\begin{matrix}b = a / cos θ & ( 6 ) \\ \begin{matrix}Δ b = b - L / 2 \\ = ( 1 / cos θ ) \cdot ( L / 2 ) - L / 2 \\ = ( L / 2 ) \cdot ( 1 / cos θ - 1 )\end{matrix} & ( 7 ) \\ \begin{matrix}Δ a = Δ b \cdot cos θ \\ = ( L / 2 ) \cdot ( 1 / cos θ - 1 ) \cdot cos θ \\ = ( L / 2 ) \cdot ( 1 - cos θ )\end{matrix} & ( 8 )\end{matrix}$$

Thus, Δa can be calculated from the bending angle θ and the length L of the simply supported beam (disc tray 226). The bending angle θ can be calculated from the amount of bending δ using Equations (1) and (2).

As described above, the disc cartridge 200 is structured such that Conditional Expression (5), i.e., Lt>Δa, can be satisfied. Therefore, each disc trays 226 can be prevented from falling from the respective retaining grooves 206a and 206a when the disc tray 226 is bent.

The disc tray 226, the disc-shaped recording medium 300, and the cover sheet 228 which are bent by vibration or external force returns to the original positions thereof mainly by the elasticity of the disc tray 226 when the vibration or the external force is eliminated.

### Operation of Tray Levers

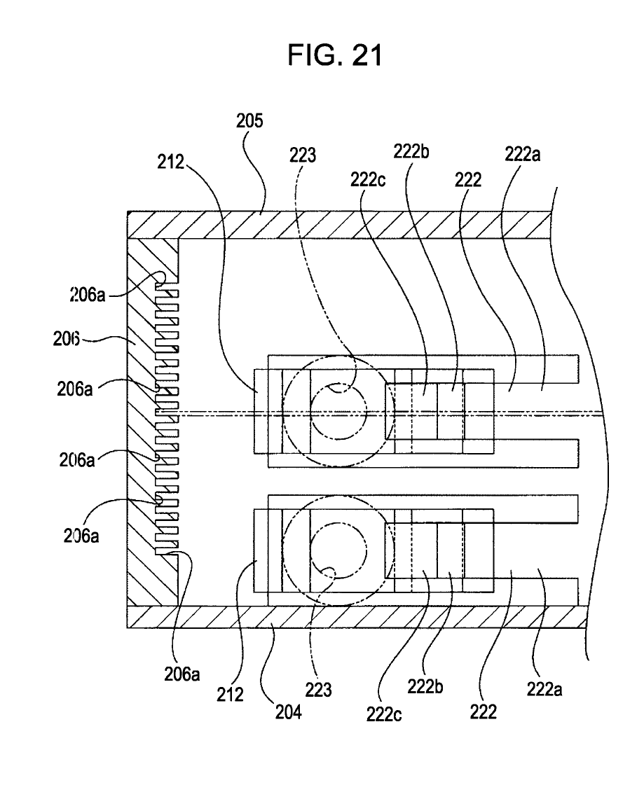

The operation of each tray lever 212 will now be described with reference to FIGS. 21 to 29.

The second projections 219, 219, . . . of the tray levers 212, 212, . . . are positioned directly behind the respective pushing through holes 220a, 220a, . . . formed in the metal plate 220 (see FIG. 21). In addition, the pushing through holes 220a, 220a, . . . are positioned directly behind the respective pin-insertion holes 223, 223, . . . formed in the front surface section 207.

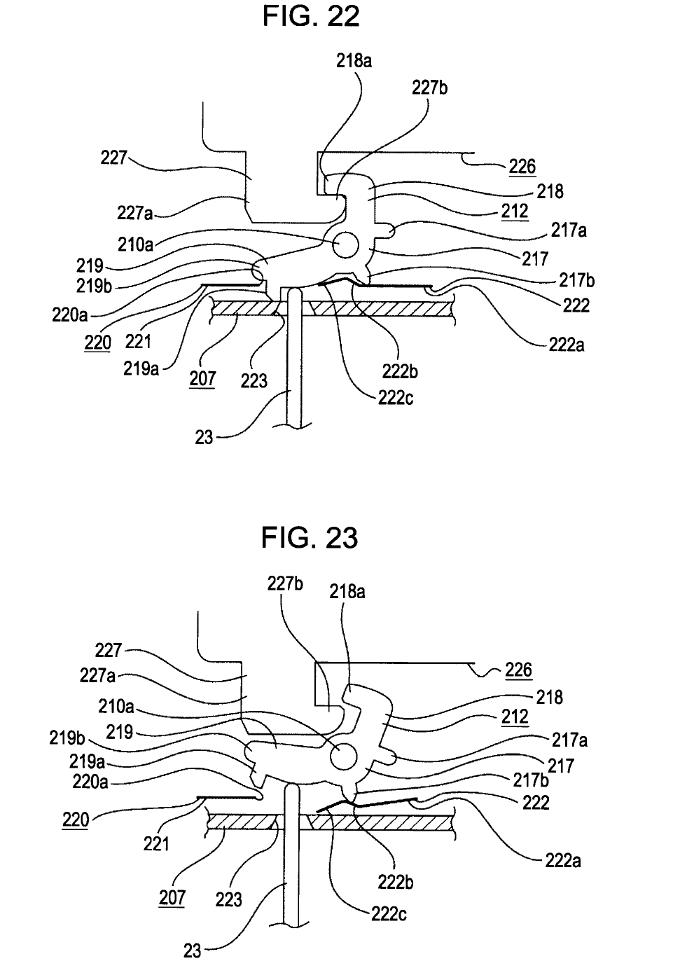

Referring to FIG. 22, in the state in which each disc-shaped recording medium 300 held by the disc tray 226 is stored in the storage case 201, the lock projection 218a of the corresponding tray lever 212 engages with the lock-receiving projection 227b of the tab 227 on the disc tray 226 from the back so that the disc tray 226 is locked at a lock position thereof.

When the disc tray 226 is at the lock position, the second engagement projection 217b is in contact with the base portion 222a of the corresponding urging spring 222. In addition, the second projection 219 is partially inserted into the pushing through hole 220a and the stopper projection 219a is in contact with the back surface of the front surface section 207.

Then, when an operation pin (23), which will be described below, is successively inserted through the pin-insertion hole 223 in the front surface section 207 and the pushing through hole 220a in the metal plate 220, the second projection 219 is pushed backward by the operation pin and the tray lever 212 is rotated clockwise (first rotational direction) in a plan view. The pin-insertion hole 223 is formed such that the diameter thereof increases toward the front. Therefore, the operation pin can be reliably inserted into the storage case 201 by being guided by the pin-insertion hole 223.

When the second projection 219 is pushed backward by the operation pin, the disc cartridge 200 is retained by a cartridge-holding block, which will be described below, and the opening-closing lid 203 is rotated to open the opening 202a in the main body 202.

When the second projection 219 is pushed backward by the operation pin, the tray lever 212 is rotated in the first rotational direction and the tab 227 becomes released from the lock projection 218a (see FIG. 23). Accordingly, the second engagement projection 217b leaves the base portion 222a of the urging spring 222 and slides along the first inclined portion 222b, so that the urging spring 222 is displaced forward against the urging force thereof.

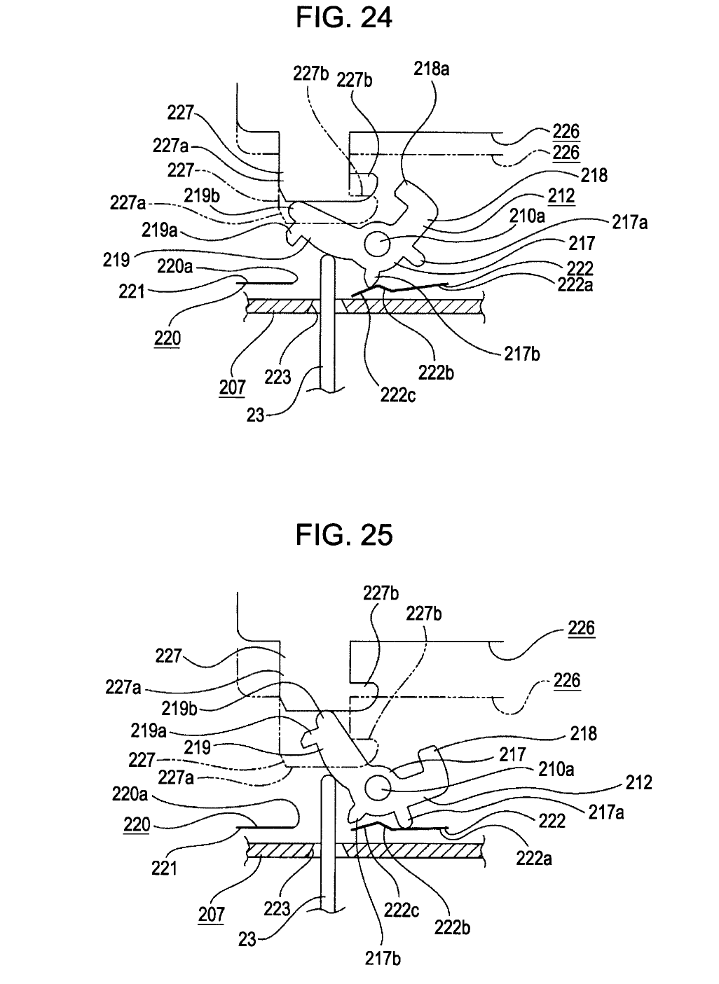

Then, when the second projection 219 is further pushed backward by the operation pin, the tray lever 212 is further rotated in the first rotational direction and the pushing portion 227a of the tab 227 is pushed backward by the pushing portion 219b (see FIG. 24). Therefore, the disc tray 226, the disc-shaped recording medium 300, and the cover sheet 228 are moved backward together and are caused to project from the storage case 201 through the opening 202a. Accordingly, the second engagement projection 217b leaves the first inclined portion 222b of the urging spring 222 and slides along the second inclined portion 222c. At this time, the urging spring 222 remains displaced forward against the urging force thereof.

Then, when the second projection 219 is further pushed backward by the operation pin, the tray lever 212 is further rotated in the first rotational direction and the pushing portion 227a of the tab 227 is further pushed backward by the pushing portion 219b (see FIG. 25). Therefore, the disc tray 226, the disc-shaped recording medium 300, and the cover sheet 228 are further moved backward together and are caused to further project from the storage case 201 through the opening 202a. Accordingly, the second engagement projection 217b becomes separated from the urging spring 222 and the first engagement projection 217a comes into contact with the base portion 222a of the urging spring 222. Therefore, the urging spring 222 moves backward and returns to the original position at which no urging force is generated.

Then, when the second projection 219 is further pushed backward by the operation pin, the tray lever 212 is further rotated in the first rotational direction and the pushing portion 227a of the tab 227 is further pushed backward by the pushing portion 219b. At this time, the operation pin slides along the outer peripheral surface of the second projection 219 and comes into contact with the stopper projection 219a (see FIG. 26). When the operation pin comes into contact with the stopper projection 219a, the state in which further rotation of the tray lever 212 is restrained is established and the tray lever 212 is retained at the pushing completion position. Therefore, the backward movement of the disc tray 226, the disc-shaped recording medium 300, and the cover sheet 228 is stopped. At this time, the first engagement projection 217a leaves the base portion 222a of the urging spring 222 and slides along the first inclined portion 222b, so that the urging spring 222 is again displaced forward against the urging force thereof. Therefore, the tray lever 212 is urged counterclockwise (second rotational direction) by the urging spring 222 in a plan view.

The disc tray 226, the disc-shaped recording medium 300, and the cover sheet 228 which partially project backward through the opening 202a are conveyed backward by a disc-conveying mechanism, which will be described below.

When the disc tray 226, the disc-shaped recording medium 300, and the cover sheet 228 are conveyed backward by the disc-conveying mechanism, the operation pin is pulled out in the forward direction through the pin-insertion hole 223 in the front surface section 207, and the pushing force applied to the tray lever 212 is eliminated.

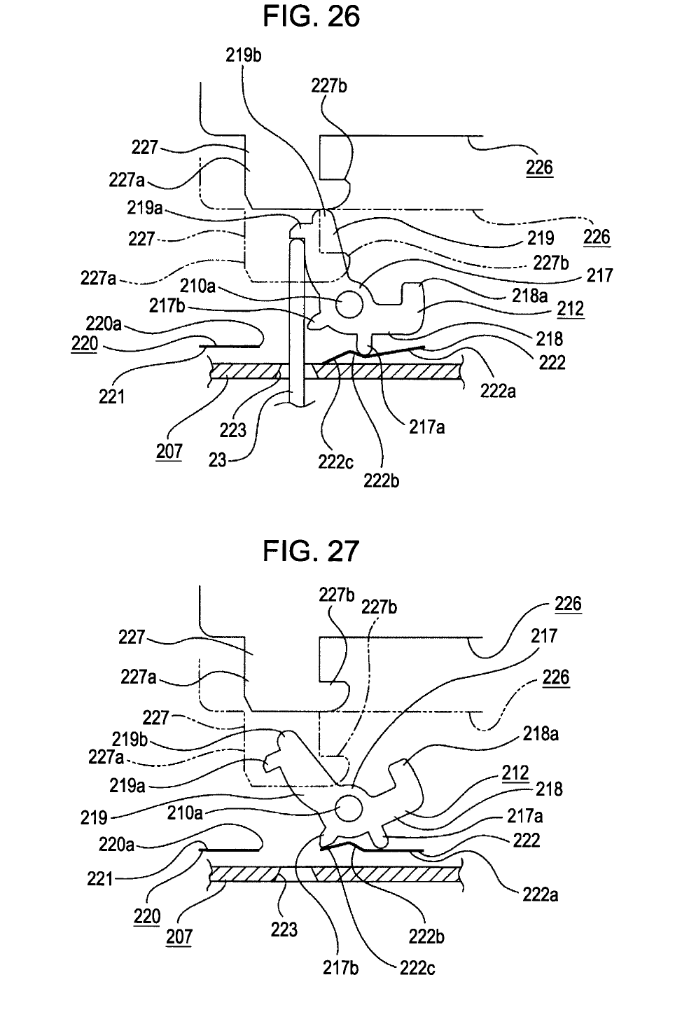

When the pushing force applied to the tray lever 212 by the operation pin is eliminated, the tray lever 212 is rotated in the second rotational direction by the urging force applied by the urging spring 222 (see FIG. 27). When the tray lever 212 is rotated in the second rotational direction, both the first engagement projection 217a and the second engagement projection 217b come into contact with the urging spring 222, and the rotation of the tray lever 212 stops. Thus, the tray lever 212 is retained at a standby position.

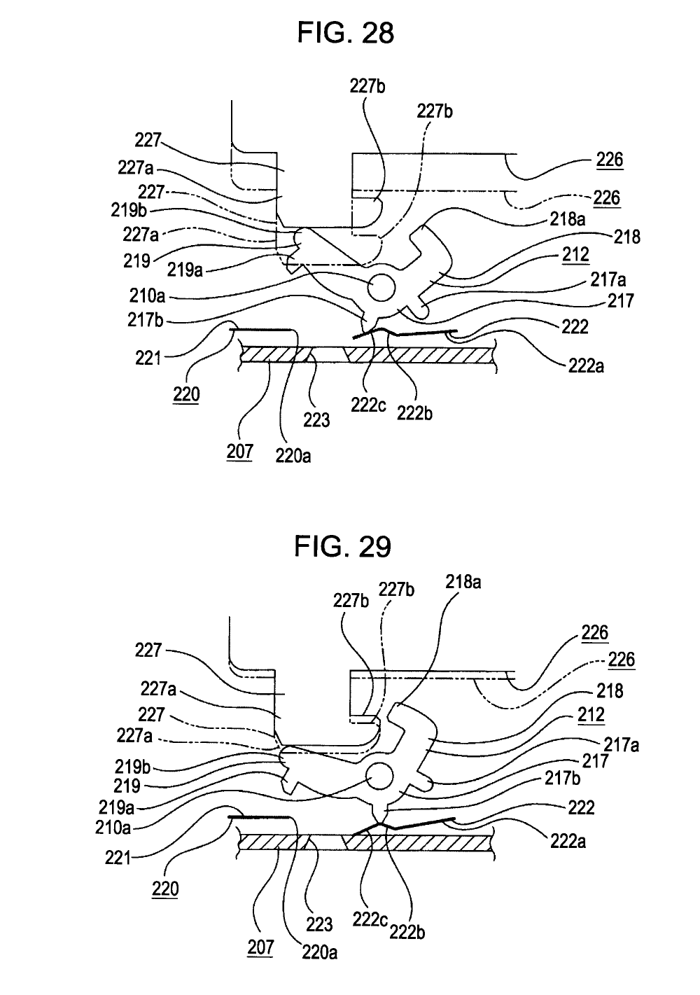

The disc tray 226, the disc-shaped recording medium 300, and the cover sheet 228, which have been conveyed backward, are conveyed forward again by the disc-conveying mechanism. When the disc tray 226, the disc-shaped recording medium 300, and the cover sheet 228 are conveyed forward to be inserted into the storage case 201, the pushing portion 219b of the tray lever 212 retained at the standby position is pushed forward by the pushing portion 227a of the tab 227. As a result, the tray lever 212 is rotated in the second rotational direction (see FIG. 28). Accordingly, the first engagement projection 217a becomes separated from the urging spring 222 and the second engagement projection 217b slides along the second inclined portion 222c of the urging spring 222. Therefore, the urging spring 222 is displaced forward against the urging force thereof.

Then, when the pushing portion 219b of the tray lever 212 is further pushed forward by the pushing portion 227a of the tab 227, the tray lever 212 is further rotated in the second rotational direction (see FIG. 29). Accordingly, the second engagement projection 217b leaves the second inclined portion 222c of the urging spring 222 and slides along the first inclined portion 222b of the urging spring 222. Therefore, the urging spring 222 is further displaced forward against the urging force thereof.

Then, when the pushing portion 219b of the tray lever 212 is further pushed forward by the pushing portion 227a of the tab 227, the tray lever 212 is further rotated in the second rotational direction. When the tray lever 212 is rotated in the second rotational direction, the lock projection 218a engages with the lock-receiving projection 227b of the tab 227 on the disc tray 226 from the back so that the disc tray 226 is locked at the lock position again (see FIG. 22). At this time, the second engagement projection 217b leaves the first inclined portion 222b of the urging spring 222 and slides along the base portion 222a of the urging spring 222. Therefore, the urging spring 222 returns to the original position at which no urging force is generated.

As described above, in the disc cartridge 200, the tabs 227, 227, . . . are provided on the disc trays 226, 226, . . . and are formed such that the tabs 227, 227, . . . on the disc trays 226, 226, . . . arranged next to each other in the thickness direction are disposed at different positions in the left-right direction. In addition, the tray levers 212, 212, . . . are disposed at positions near the respective tabs 227, 227, . . . .

Therefore, the tabs 227, 227, . . . on the disc trays 226, 226, . . . disposed next to each other in the thickness direction are not arranged in the thickness direction, so that the disc trays 226, 226, . . . can be easily extracted from the storage case 201 using the tray levers 212, 212, . . . . In addition, a large number of disc trays 226, 226, . . . and the disc-shaped recording media 300, 300, . . . can be stored in the storage case 201.

In addition, in the disc cartridge 200, the tabs 227, 227, . . . on the disc trays 226, 226, . . . and the tray levers 212, 212, . . . are arranged in the vertical direction and the left-right direction.

Therefore, a large number of disc-shaped recording media 300, 300, . . . can be stored in the storage case 201 without degrading the ease of extracting the disc trays 226, 226, . . . from the storage case 201 using the tray levers 212, 212, . . . or increasing the width of the disc cartridge 200 in the left-right direction.

In addition, in the disc cartridge 200, the tabs 227, 227, . . . of the disc trays 226, 226, . . . are arranged with constant intervals therebetween in the left-right direction in each of the groups G1 and G2.

Therefore, the tray levers 212, 212, . . . can be arranged with constant intervals therebetween in the left-right direction, and the space efficiency can be improved.

In addition, as described above, in the disc cartridge 200, the tab 227 of each disc tray 226 includes the lock-receiving projection 227b, and each tray lever 212 includes the lock projection 218a which locks the corresponding disc tray 226 when the disc-shaped recording media 300, 300, . . . are stored in the storage case 201.

Thus, each disc tray 226 is locked by the corresponding tray lever 212, which has a function of pushing the tab 227 backward and causing the disc tray 226 to project from the storage case 201, and it is not necessary to provide a dedicated component for locking the disc tray 226. Therefore, the number of components can be reduced.

When each tray lever 212 rotates in the first rotational direction, the pushing portion 219b of the tray lever 212 pushes the tab 227 of the corresponding disc tray 226. When the tray lever 212 rotates in the second rotational direction, the lock projection 218a of the tray lever 212 engages with the lock-receiving projection 227b of the tab 227 of the corresponding disc tray 226.

Thus, each disc tray 226 is either pushed or locked in accordance with the rotational direction of the corresponding tray lever 212. Therefore, the movements of the components are simple, and the mechanism can be simplified.

Each tray lever 212 is rotatable between the lock position and the pushing completion position, and, when the tray lever 212 is rotated toward the lock position, the tray lever 212 receives an urging force in the second rotational direction from the urging spring 222.

Therefore, the corresponding disc tray 226 can be reliably locked at the lock position by the urging force applied by the urging spring 222.

In addition, each tray lever 212 has a standby position at which the tray lever 212 waits for the corresponding disc tray 226 such that the tab 227 can come into contact with the pushing portion 219b when the disc tray 226 is moved forward to be inserted into the storage case 201, and each tray lever 212 can be retained at the standby position by the urging spring 222.

Thus, the urging spring 222 has a function of reliably locking the disc tray 226 at the lock position and a function of retaining the tray lever 212 at the standby position. Therefore, the urging spring 222 serves multiple functions. As a result, the mechanism can be simplified and the number of components can be reduced.

In addition, the pin-insertion holes 223, 223, . . . , which correspond to the tray levers 212, 212, . . . , are formed in the storage case 201 of the disc cartridge 200. The tray levers 212, 212, . . . are rotated by inserting the operation pin through the respective pin-insertion holes 223, 223, . . . and pushing the tray levers 212, 212, . . . .

Thus, the pin-insertion holes 223, 223, . . . function as guide members in the process of pushing the disc trays 226, 226, . . . , and the tray levers 212, 212, . . . can be pushed by the operation pin at optimum positions thereof.

The thickness of the pushing portion 219b of each tray lever 212 is larger than that of the tab 227 of each disc tray 226. Therefore, the tab 227 can be reliably pushed. In addition, it is not necessary to position each tray lever 212 with respect to the corresponding disc tray 226 with high accuracy, and the manufacturing cost can be reduced. In addition, each tray lever 212 can be reliably pushed by the operation pin. It is not necessary to position each tray lever 212 with respect to the operation pin with high accuracy, and the manufacturing cost can be reduced.

In the case where each disc tray 226, which is sheet-shaped, is easily bent, it is particularly effective to set the thickness of the pushing portion 219b of each tray lever 212 to be larger than that of the tab 227 of each disc tray 226 in view of the operational reliability.

In addition, since the thickness of the pushing portion 219b of each tray lever 212 is larger than that of the tab 227 of each disc tray 226, the tray levers 212, 212, . . . can be reliably pushed by the operation pin inserted through the pin-insertion holes 223, 223, . . . .

### Schematic Inner Structure of Disc Changer

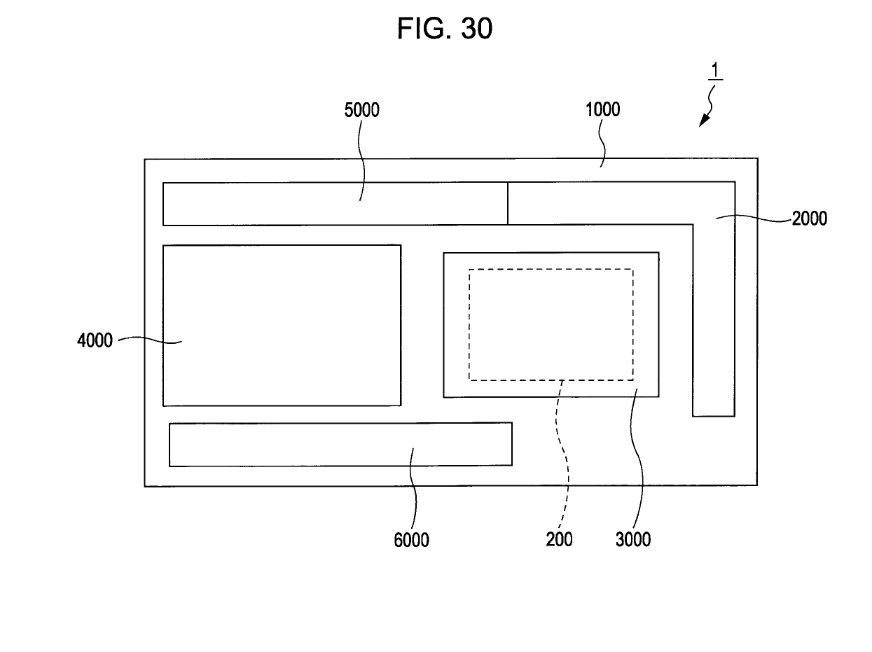

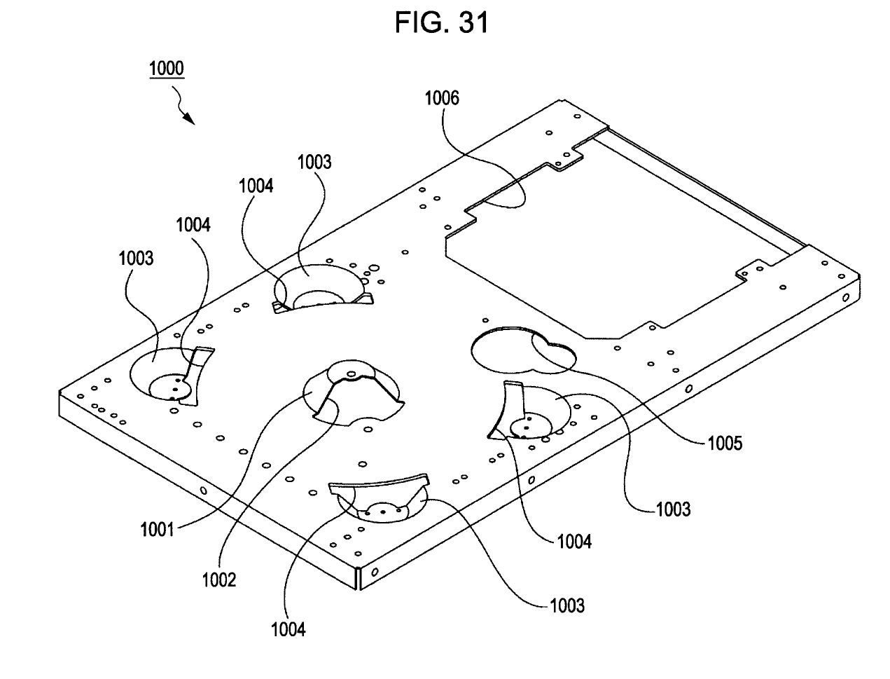

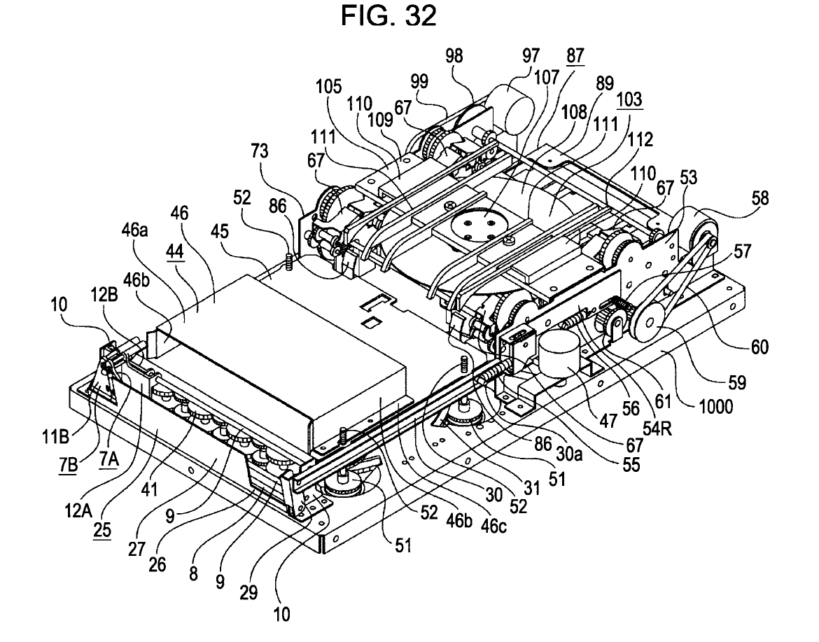

The schematic inner structure of the disc changer 1 will now be described with reference to FIG. 30.

A base chassis 1000 made of, for example, a conductive metal material is disposed in the housing 2. The base chassis 1000 has an oblong shape and extends substantially perpendicular to the vertical direction. A disc-selecting block 2000, a cartridge-holding block 3000, and a disc drive block 4000 are disposed on the base chassis 1000. The disc-selecting block 2000 extends along the front edge of the base chassis 1000 and along a front section of the right side of the base chassis 1000. The cartridge-holding block 3000 and the disc drive block 4000 are arranged in the front-back direction behind the disc selection block 2000 disposed at the front edge of the base chassis 1000. A disc-loading block 5000 is disposed along a back section of the right side of the base chassis 1000. A disc-ejecting block 6000 is disposed along a back section of the left side of the base chassis 1000.

The disc-loading block 5000 and the disc-ejecting block 6000 function as a disc-conveying block which conveys the disc trays 226, 226, . . . and the disc-shaped recording media 300, 300, . . . between the storage case 201 and a recording-reproducing position, which will be described below.

### Base Chassis

As shown in FIG. 31, the base chassis 1000 includes an arrangement projection 1001 which projects upward at a central position of a front half section of the base chassis 1000. A connection hole 1002 which opens toward one side is formed in the arrangement projection 1001.

Four arrangement recesses 1003, 1003, . . . which open upward, are formed around the arrangement projection 1001 in the front half section of the base chassis 1000. Connection holes 1004, 1004, . . . are formed in the respective arrangement recesses 1003, 1003, . . . so as to extend therethrough in a direction such that the connection holes 1004, 1004, . . . face the arrangement projection 1001.

A gear arrangement hole 1005 is formed in the base chassis 1000 so as to extend therethrough in the vertical direction at a central position in the front-back direction of the base chassis 1000.

In addition, a large, rectangular arrangement hole 1006 is formed in a back half section of the base chassis 1000.

### Selection Slider

The disc-selecting block 2000 includes two selection sliders 7A and 7B, a guide shaft 8 which extends in the left-right direction, and guide shafts 9 and 9 which also extend in the left-right direction (see FIGS. 32 to 35).

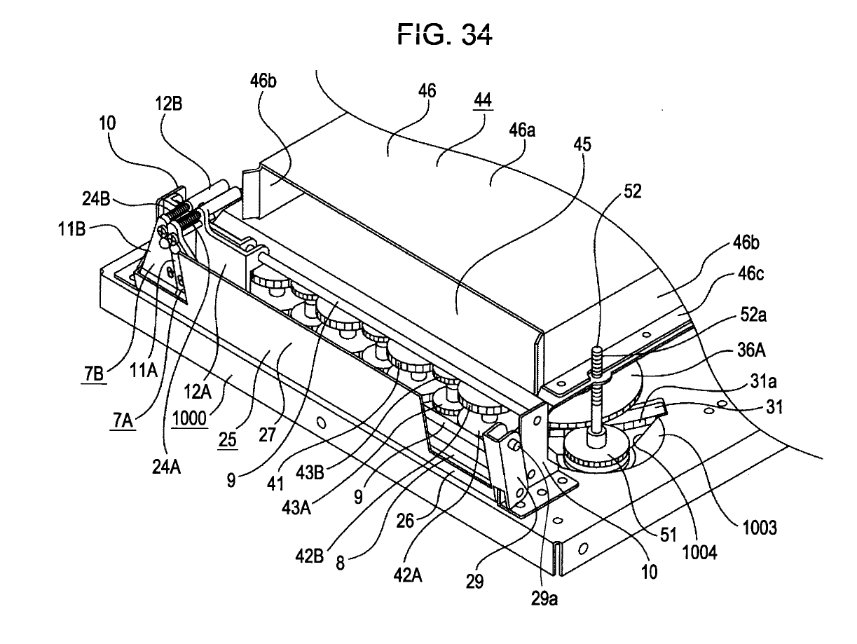

The guide shaft 8 and the guide shafts 9 and 9 are attached to retaining members 10 and 10, which are attached to the base chassis 1000, at the left and right ends thereof (see FIGS. 34 to 36).

The guide shaft 8 is positioned in front of the guide shafts 9 and 9, and the guide shafts 9 and 9 are separated from each other in the vertical direction.

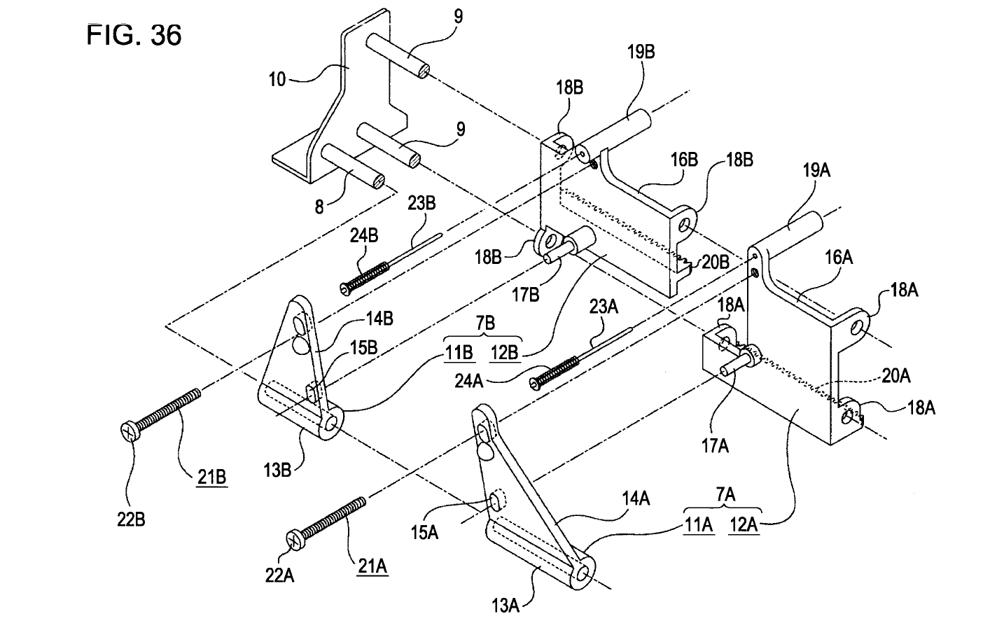

The selection slider 7A includes a pin attachment member 11A which is supported by the guide shaft 8 and a pin-supporting member 12A which is supported by the guide shafts 9 and 9 (see FIG. 36).

The pin attachment member 11A includes a bearing portion 13A through which the guide shaft 8 is inserted and a pin attachment portion 14A which projects substantially upward from the bearing portion 13A. A guide hole 15A is formed in the pin attachment portion 14A. The pin attachment member 11A is slidable with respect to the guide shaft 3 in the axial direction thereof, and is rotatable in a direction around the axis.

The pin-supporting member 12A includes a base plate portion 16A which extends substantially perpendicular to the front-back direction, a guide pin 17A which projects forward from the base plate portion 16A, bearing portions 18A, 18A, and 18A which project backward from the base plate portion 16A at the left and right ends thereof and through which the guide shafts 9 and 9 are inserted, a pin-supporting portion 19A provided on the base plate portion 16A at the top end thereof, and a rack portion 20A which projects backward from the base plate portion 16A the bottom end thereof and which extends in the left-right direction.

The pin-supporting portion 19A has a long, cylindrical shape which extends in the front-back direction.

The guide pin 17A on the pin-supporting member 12A is inserted into the guide hole 15A in the pin attachment member 11A, so that the pin attachment member 11A is slidably supported.

A restraining screw 21A is inserted through the pin attachment portion 14A of the pin attachment member 11A at a position near the top end of the pin attachment portion 14A. A back end of portion the restraining screw 21A is attached to the base plate portion 16A of the pin-supporting member 12A at a position near the top end thereof. A flange-shaped restraining portion 22A which expands outward is provided at the front end of the restraining screw 21A, and the restraining portion 22A is positioned at the front side of the pin attachment portion 14A.

A front-end portion of an operation pin 23A is attached to a top end portion of the pin attachment member 11A, and the operation pin 23A is slidably supported by the pin-supporting portion 19A of the pin-supporting member 12A.

A compression coil spring 24A is supported by the operation pin 23A at a position between the pin-supporting portion 19A and the pin attachment portion 14A. Therefore, the pin attachment member 11A is urged by the compression coil spring 24A in a rotational direction in which the pin attachment portion 14A moves away from the pin-supporting member 12A. In the state in which no force is applied to the pin attachment member 11A in a backward direction, the restraining portion 22A of the restraining screw 21A is in contact with the front surface of the pin attachment portion 14A, so that rotation of the pin attachment member 11A in a direction away from the pin-supporting member 12A is restricted.

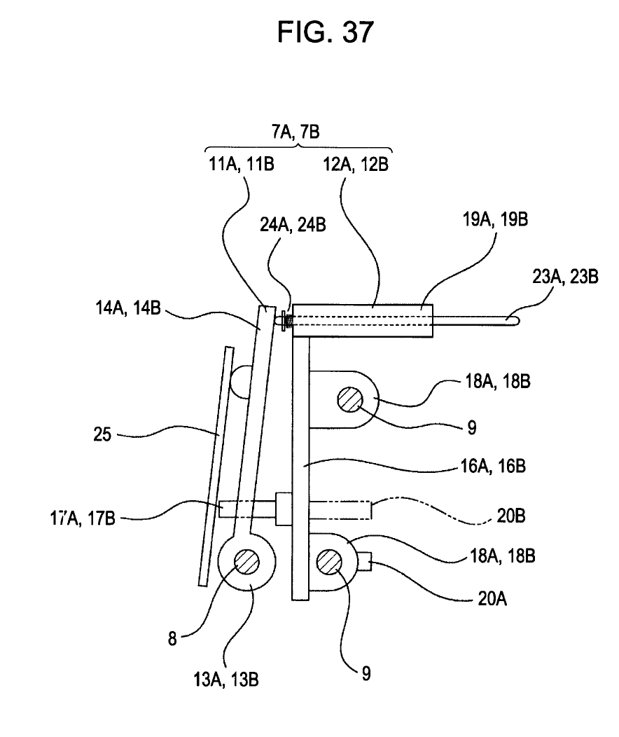

When the pin attachment member 11A is pushed by an operation lever (25), which will be described below, the pin attachment member 11A is rotated around the guide shaft 8 in a direction in which the pin attachment portion 14A approaches the base plate portion 16A of the pin-supporting member 12A against the urging force applied by the compression coil spring 24A (see FIG. 37). While the pin attachment member 11A is being rotated around the guide shaft 8, the guide hole 15A is guided by the guide pin 17A on the base plate portion 16A.

When the pin attachment member 11A is rotated around the guide shaft 8 in the direction in which the pin attachment portion 14A approaches the base plate portion 16A of the pin-supporting member 12A against the urging force applied by the compression coil spring 24A, the operation pin 23A is moved backward. When the operation pin 23A is moved backward, the end portion of the operation pin 23A projects backward from the pin-supporting portion 19A of the pin-supporting member 12A, and is inserted into the corresponding pin-insertion hole 223 formed in the front surface section 207 of the disc cartridge 200.

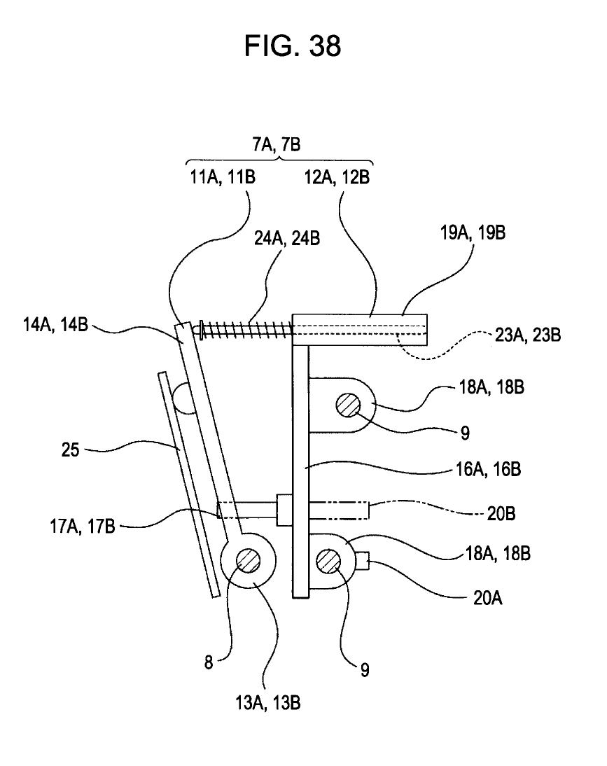

When a pushing force applied to the pin attachment member 11A by the operation lever is eliminated, the pin attachment member 11A is rotated in a direction in which the pin attachment portion 14A of the pin attachment member 11A moves away from the base plate portion 16A by the urging force applied by the compression coil spring 24A (see FIG. 38).

The selection slider 7B includes a pin attachment member 11B which is supported by the guide shaft 8 and a pin-supporting member 12B which is supported by the guide shafts 9 and 9 (see FIG. 36). The pin attachment member 11B is disposed at the left side of the pin attachment member 11A.

The pin attachment member 11B includes a bearing portion 13B through which the guide shaft 8 is inserted and a pin attachment portion 14B which projects substantially upward from the bearing portion 13B. A guide hole 15B is formed in the pin attachment portion 14B. The pin attachment member 11B is slidable with respect to the guide shaft 8 in the axial direction thereof, and is rotatable in a direction around the axis.

The pin-supporting member 12B includes a base plate portion 16B which extends substantially perpendicular to the front-back direction, a guide pin 17B which projects forward from the base plate portion 16B, bearing portions 18B, 18B, and 18B which project backward from the base plate portion 16B at the left and right ends thereof and through which the guide shafts 9 and 9 are inserted, a pin-supporting portion 19B provided on the base plate portion 16B at the top end thereof, and a rack portion 20B which projects backward from the base plate portion 16B the bottom end thereof and which extends in the left-right direction.

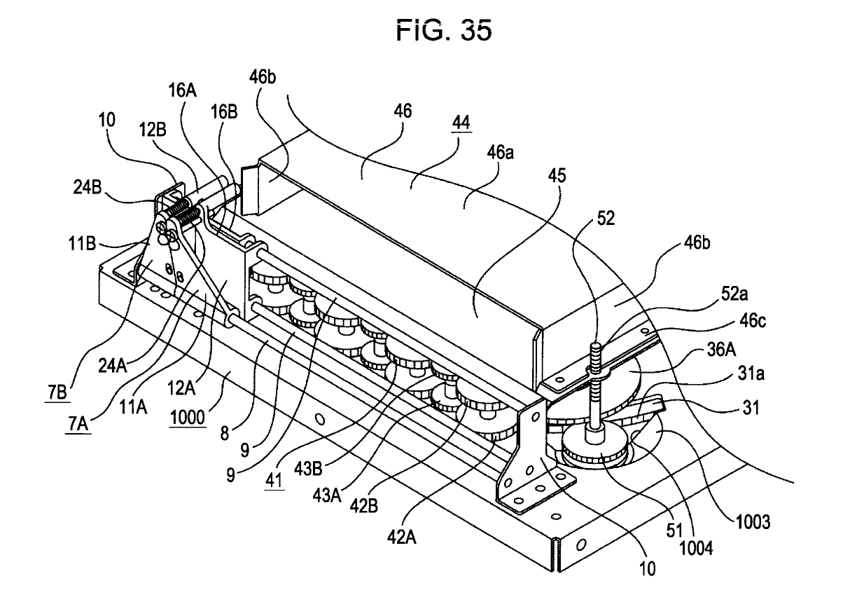

As shown in FIG. 35, the base plate portion 16B is positioned behind the base plate portion 16A, and the bearing portions 18B, 18B, and 18B are positioned at the left side of the bearing portions 18A, 18A, and 18A. In addition, the pin-supporting portion 19B is positioned at the left side of the pin-supporting portion 19A, and the rack portion 20B is positioned above the rack portion 20A.

The pin-supporting portion 19B has a long, cylindrical shape which extends in the front-back direction (see FIG. 36).

The guide pin 17B on the pin-supporting member 12B is inserted into the guide hole 15B in the pin attachment member 11B, so that the pin attachment member 11B is slidably supported.

A restraining screw 21B is inserted through the pin attachment portion 14B of the pin attachment member 11B at a position near the top end of the pin attachment portion 14B. A back end of portion the restraining screw 21B is attached to the base plate portion 16B of the pin-supporting member 12B at a position near the top end thereof. A flange-shaped restraining portion 22B which expands outward is provided at the front end of the restraining screw 21B, and the restraining portion 22B is positioned at the front side of the pin attachment portion 14B.

A front-end portion of an operation pin 23B is attached to a top end portion of the pin attachment member 11B, and the operation pin 23B is slidably supported by the pin-supporting portion 19B of the pin-supporting member 12B.

A compression coil spring 24B is supported by the operation pin 23B at a position between the pin-supporting portion 19B and the pin attachment portion 14B. Therefore, the pin attachment member 11B is urged by the compression coil spring 24B in a direction in which the pin attachment portion 14B moves away from the pin-supporting member 12B. In the state in which no force is applied to the pin attachment member 11B in a backward direction, the restraining portion 22B of the restraining screw 21B is in contact with the front surface of the pin attachment portion 14B, so that rotation of the pin attachment member 11B in a direction away from the pin-supporting member 12B is restricted.

When the pin attachment member 11B is pushed by the operation lever, the pin attachment member 11B is rotated around the guide shaft 8 in a direction in which the pin attachment portion 14B approaches the base plate portion 16B of the pin-supporting member 12B against the urging force applied by the compression coil spring 24B (see FIG. 37). While the pin attachment member 11B is being rotated around the guide shaft 8, the guide hole 15B is guided by the guide pin 173 on the base plate portion 16B.

When the pin attachment member 11B is rotated around the guide shaft 8 in the direction in which the pin attachment portion 14B approaches the base plate portion 16B of the pin-supporting member 12B against the urging force applied by the compression coil spring 24B, the operation pin 233 is moved backward. When the operation pin 23B is moved backward, the end portion of the operation pin 23B projects backward from the pin-supporting portion 19B of the pin-supporting member 12B, and is inserted into the corresponding pin-insertion hole 223 formed in the front surface section 207 of the disc cartridge 200.

When a pushing force applied to the pin attachment member 11B by the operation lever is eliminated, the pin attachment member 11B is rotated in a direction in which the pin attachment portion 14B of the pin attachment member 11B moves away from the base plate portion 16B by the urging force applied by the compression coil spring 24B (see FIG. 38).

### Operation Lever

The operation lever 25 is supported by the guide shaft 8 (see FIGS. 32 to 34) in a pivotable manner. The operation lever 25 includes an oblong, rectangular base surface portion 26 which is plate-shaped and extends in the left-right direction, an operation portion 27 which projects upward from the base surface portion 26 in an area excluding areas near the left and right ends thereof, support surface portions which project backward from the base surface portion 26 at the left and right ends thereof, and a connection portion 29 which continues from the support surface portion at the right.

The connection portion 29 is positioned on the right side of the support surface portion at the right, and is provided with a connecting pin 29a which projects rightward at the top end of the connection portion 29.

When the operation lever 25 is pivoted, the pin attachment portions 14A and 14B of the pin attachment members 11A and 11B of the selection sliders 7A and 7B, respectively, are pushed by the operation portion 27 from the front.

### Connection Lever

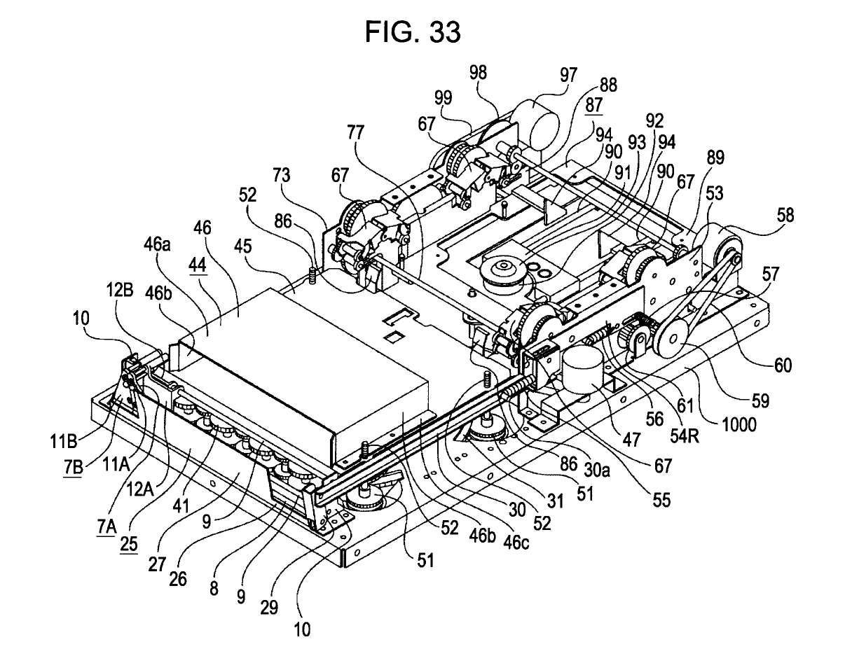

The connecting pin 29a on the connection portion 29 is connected to a connection lever 30 such that the connection portion 29 is rotatable (see FIGS. 32 and 33). The connection lever 30 is long in the front-back direction, and the connecting pin 29a is connected to the connection lever 30 at the front end thereof. A spring support pin 30a, which projects rightward, is provided on the connection lever 30 at a position near the back end thereof.

### Drive Gear

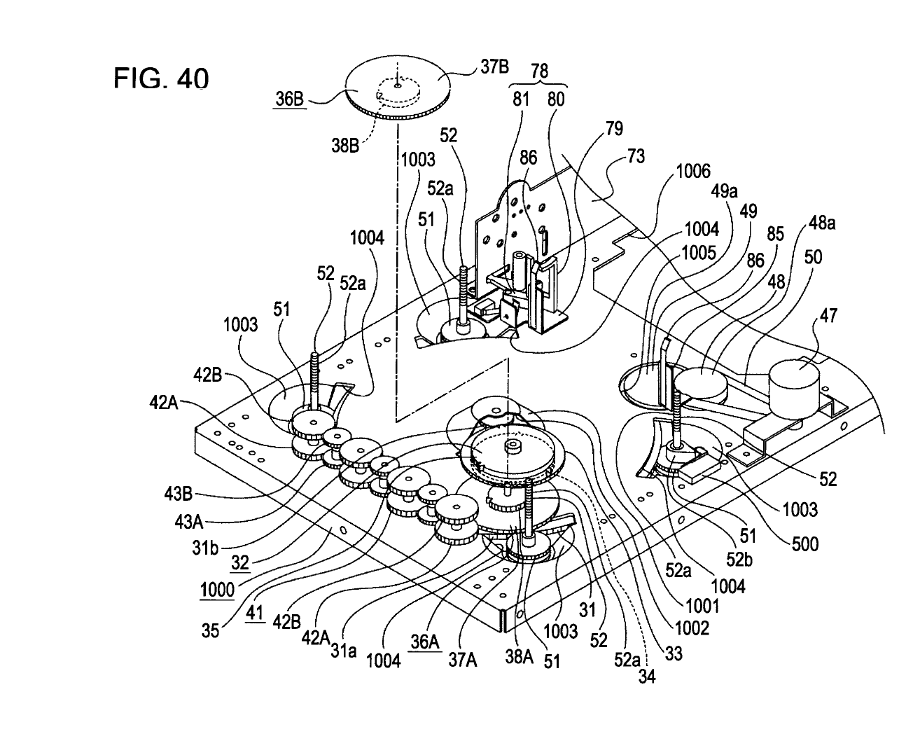

A drive gear 31 is supported at the lower side of the base chassis 1000 in an area near the front end thereof (see FIGS. 29 and 40). The drive gear 31 includes a large-diameter portion 31a and a small-diameter portion 31b which is positioned above the large-diameter portion 31a and which is formed integrally with the large-diameter portion 31a. The large-diameter portion 31a is disposed such that parts of the large-diameter portion 31a along the outer periphery thereof project into the arrangement recesses 1003, 1003, . . . through the connection holes 1004, 1004, . . . , and the small-diameter portion 31b is disposed inside the arrangement projection 1001 of the base chassis 1000.

### Driven Gear

The small-diameter portion 31b of the drive gear 31 meshes with a first driven gear 32 which is supported at the upper side of the base chassis 1000.

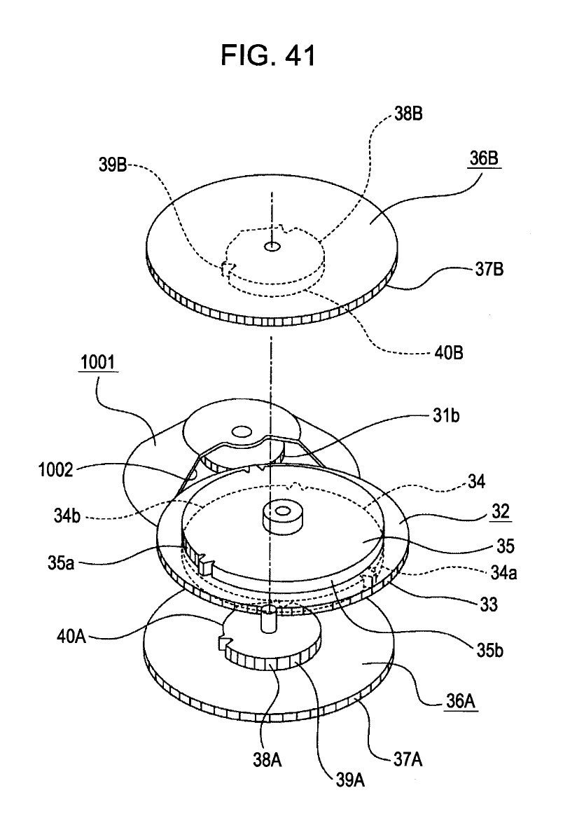

As shown in FIG. 41, the first driven gear 32 includes a spur gear portion 33, a partially toothed gear portion 34 positioned at the lower side of the spur gear portion 33, and a partially toothed gear portion 35 positioned at the upper side of the spur gear portion 33, all of which are formed integrally with each other. The spur gear portion 33 of the first driven gear 32 meshes with the small-diameter portion 31b of the drive gear 31.

The partially toothed gear portions 34 and 35 respectively include toothed sections 34a and 35a and toothless sections 34b and 35b. The toothed sections 34a and 35a are provided at positions corresponding to about 160° in terms of the rotational angle. The phases of the toothed sections 34a and 35a are shifted from each other by 180°.

Second driven gears 36A and 36B, which are supported at the upper side of the base chassis 1000, are capable of meshing with the first driven gear 32. The second driven gears 36A and 36B have the same rotational axis. The second driven gear 36A is disposed at the lower side, and the second driven gear 36B is disposed at the upper side.

The second driven gear 36A includes a large-diameter portion 37A at the lower side thereof and a small-diameter portion 38A at the upper side thereof, and the large-diameter portion 37A and the small-diameter portion 38A are formed integrally with each other. The small-diameter portion 38A includes a toothed section 39A and a toothless section 40A. The toothed section 39A of the small-diameter portion 38A of the second driven gear 36A is capable of meshing with the toothed section 34a of the first driven gear 32.

The second driven gear 36B includes a large-diameter portion 37B at the upper side thereof and a small-diameter portion 38B at the lower side thereof, and the large-diameter portion 37B and the small-diameter portion 38B are formed integrally with each other. The small-diameter portion 38B includes a toothed section 39B and a toothless section 40B. The toothed section 39B of the small-diameter portion 38B of the second driven gear 36B is capable of meshing with the toothed section 35a of the first driven gear 32.

### Gear Train

A gear train 41 is disposed on the base chassis 1000 at a position near the front end thereof (see FIGS. 34, 35, and 40). The gear train 41 includes large gears 42A, 42A, . . . , large gears 42B, 42B, . . . , small gears 43A, 43A, . . . , and small gears 43B, 43B, . . . . Each large gear 42A and the corresponding large gear 42B have the same rotational axis, and each small gear 43A and the corresponding small gear 43B have the same rotational axis.

In the gear train 41, the large gears 42A, 42A, . . . and the small gears 43A, 43A, . . . are alternately arranged in the left-right direction such that the large gears 42A, 42A, . . . and the small gears 43A, 43A, . . . mesh with each other, and the large gears 42B, 42B, . . . and the small gears 43B, 43B, . . . are alternately arranged in the left-right direction such that the large gears 42B, 42B, . . . and the small gears 43B, 43B, . . . mesh with each other.

As shown in FIG. 40, the large gear 42A at the rightmost position in the gear train 41 meshes with the large-diameter portion 37A of the second driven gear 36A, and the large gear 42B at the rightmost position in the gear train 41 meshes with the large-diameter portion 37B of the second driven gear 36B.

In the gear train 41, each large gear 42A is capable of meshing with the rack portion 20A of the pin-supporting member 12A included in the selection slider 7A, and each large gear 42B is capable of meshing with the rack portion 20B of the pin-supporting member 12B included in the selection slider 7B. The length of the rack portions 20A and 20B in the left-right direction is determined such that the rack portions 20A and 20B can respectively mesh with the large gears 42A and 42A disposed next to each other and with the large gears 42B and 42B disposed next to each other at the left and right ends of the rack portions 20A and 20B.

When a driving force of an elevation motor, which will be described below, is successively transmitted to the drive gear 31, the first driven gear 32, and the second driven gear 36A, the large gears 42A, 42A, . . . and the small gears 43A, 42A, . . . are rotated in directions corresponding to the rotational direction of the elevation motor. Therefore, the rack portion 20A of the selection slider 7A successively meshes with the large gears 42A, 42A, . . . and the selection slider 7A moves in the left-right direction while being guided by the guide shaft 8 and the guide shafts 9 and 9.

In addition, when a driving force of an elevation motor, which will be described below, is successively transmitted to the drive gear 31, the first driven gear 32, and the second driven gear 36B, the large gears 42B, 42B, . . . and the small gears 43B, 43B, . . . are rotated in directions corresponding to the rotational direction of the elevation motor. Therefore, the rack portion 20B of the selection slider 7B successively meshes with the large gears 42B, 42B, . . . , and the selection slider 7B moves in the left-right direction while being guided by the guide shaft 8 and the guide shafts 9 and 9.

As described above, the first driven gear 32 includes two partially toothed gear portions 34 and 35. The second driven gear 36A is rotated when the toothed section 34a of the partially toothed gear portion 34 meshes with the toothed section 39A of the small-diameter portion 38A of the second driven gear 36A. In addition, the second driven gear 36B is rotated when the toothed section 35a of the partially toothed gear portion 35 meshes with the toothed section 39B of the small-diameter portion 38B of the second driven gear 36B.

As described above, the toothed sections 34a and 35a are positioned such that the phases thereof are shifted from each other by 180°. Therefore, when the drive gear 31 is rotated, one of the toothed sections 34a and 35a meshes with the corresponding one of the toothed sections 39A and 39B of the second driven gears 36A and 36B. Therefore, the selection sliders 7A and 7B do not move simultaneously, and only one of the selection sliders 7A and 7B is selectively moved in the left-right direction.

### Cartridge Holder

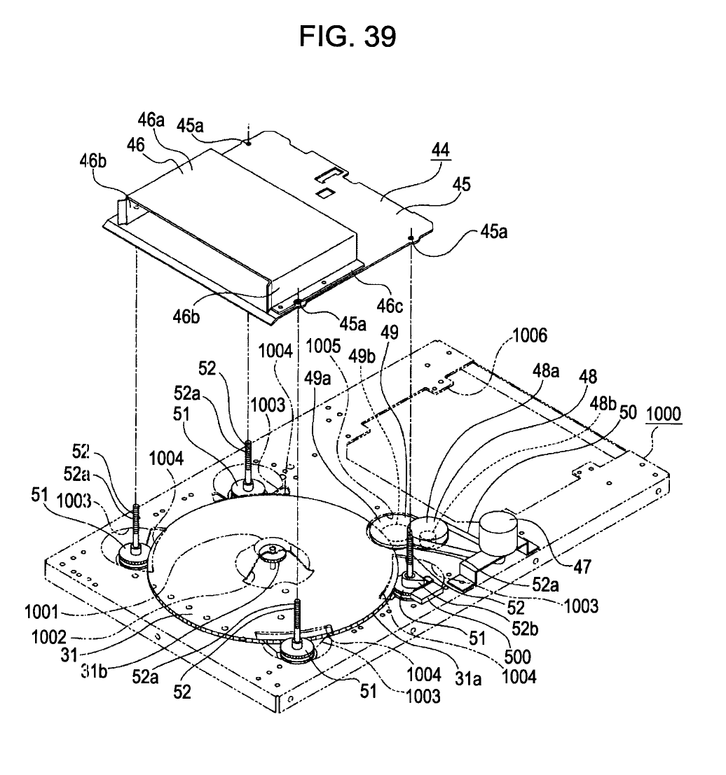

The cartridge-holding block 3000 includes a cartridge holder 44 (see FIG. 39).

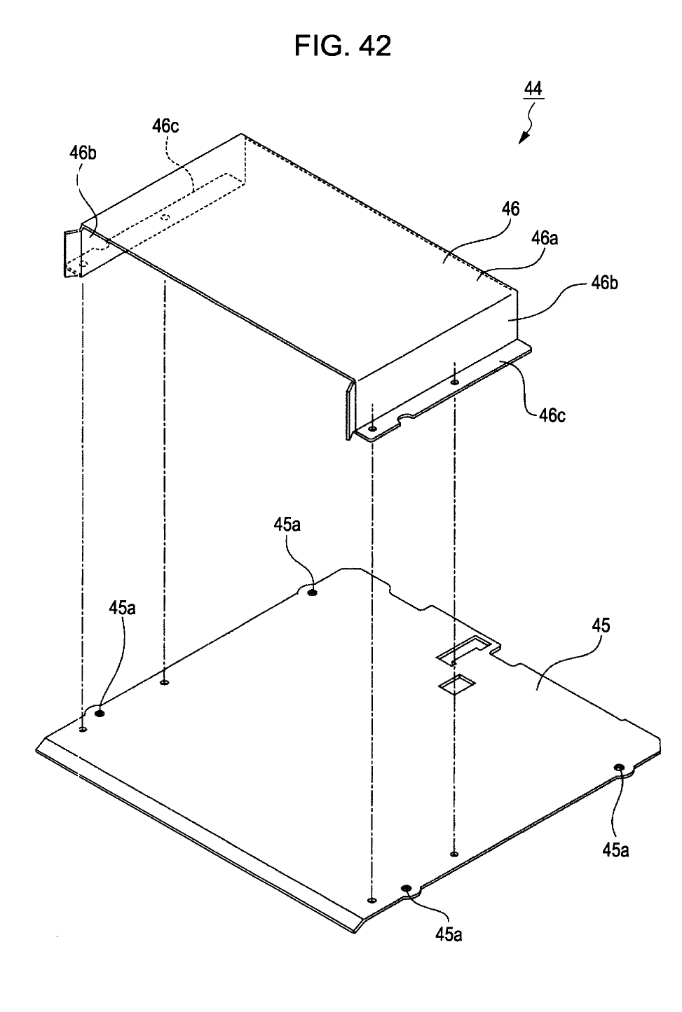

As shown in FIGS. 39 and 42, the cartridge holder 44 includes a support plate 45 which extends substantially perpendicular to the vertical direction and a holding member 46 which is attached to the support plate 45. The holding member 46 includes a top plate portion 46a, side plate portions 46b and 46b which project downward from the left and right edges of the top plate portion 46a, and attachment plate portions 46c and 46c which project leftward and rightward from the bottom edges of the side plate portions 46b and 46b. The attachment plate portions 46c and 46c of the holding member 46 are attached to the top surface of the support plate 45 at the left and right edges thereof.

Screw holes 45a, 45a, . . . are formed along the left and right edges of the support plate 45 with intervals therebetween in the front-back direction (see FIG. 42).

### Elevation Motor

An elevation motor 47 is disposed on the base chassis 1000 at the right edge thereof (see FIGS. 39 and 40).

A pulley gear 48 and a connection gear 49 are supported on the bottom surface of the housing 2. The pulley gear 48 and the connection gear 49 are disposed in the gear arrangement hole 1005 formed in the base chassis 1000. The pulley gear 48 includes a belt-winding portion 48a and a gear portion 48b. The connection gear 49 includes a large-diameter portion 49a and a small-diameter portion 49b.

A belt 50 is wound around the belt-winding portion 48a of the pulley gear 48 and the elevation motor 47.

The large-diameter portion 49a of the connection gear 49 meshes with the gear portion 48b of the pulley gear 48, and the small-diameter portion 49b of the connection gear 49 meshes with the large-diameter portion 31a of the drive gear 31.

Therefore, when the elevation motor 47 is rotated, the driving force of the elevation motor 47 is transmitted to the drive gear 31 through the belt 50, the pulley gear 48, and the connection gear 49, and the drive gear 31 is rotated in a direction corresponding to the rotational direction of the elevation motor 47.

### Elevation Gears

Elevation gears 51, 51, . . . are supported in the respective arrangement recesses 1003, 1003, . . . in the base chassis 1000. The elevation gears 51, 51, . . . mesh with the large-diameter portion 31a of the drive gear 31.

Feed screws 52, 52, . . . are attached to the elevation gears 51, 51, . . . at central positions thereof. Each feed screw 52 projects upward from the corresponding elevation gear 51 and is provided with a thread groove 52a formed in an area excluding a bottom end portion of the feed screw 52.

The feed screw 52 at the back right position is provided with a switch operation projection 52b which projects rightward at the bottom end of the feed screw 52.

The thread grooves 52a, 52a, . . . formed in the feed screws 52, 52, . . . mesh with the screw holes 45a, 45a, . . . formed in the support plate 45 of the cartridge holder 44. Therefore, when the elevation gears 51, 51, . . . are rotated by the rotation of the drive gear 31, the feed screws 52, 52, . . . are also rotated and the screw holes 45a, 45a, . . . are moved in a direction corresponding to the rotational direction of the feed screws 52, 52, . . . . As a result, the cartridge holder 44 is moved upward or downward.

### Elevation Position Detection Switch

An elevation position detection switch 500 is disposed at the right edge of the base chassis 1000 at a position near the feed screw 52 provided with the switch operation projection 52b. The elevation position detection switch 500 is operated by the switch operation projection 52b on the feed screw 52 each time the switch operation projection 52b rotates one turn, and thereby detects the elevation position of the cartridge holder 44. When the elevation position of the cartridge holder 44 is detected, the vertical positions of the pin-insertion holes 223, 223, . . . formed in the disc cartridge 200 retained by the cartridge holder 44 can be determined.

As described above, when the drive gear 31 is rotated by the rotation of the elevation motor 47, the selection sliders 7A and 7B are moved in the left-right direction and the cartridge holder 44 is moved upward or downward.

Thus, in the disc changer 1, the cartridge holder 44 is moved in the vertical direction and the selection sliders 7A and 7B are moved in the left-right direction by the same elevation motor 47. Therefore, the number of components can be reduced.

As described above, in the disc changer 1, the elevation motor 47 moves the cartridge holder 44 in the vertical direction and the selection sliders 7A and 7B in the left-right direction in association with each other. At this time, the ratio between the amount of upward or downward movement (amount of movement in the vertical direction) per unit time of the cartridge holder 44 and the amount of movement per unit time of the selection sliders 7A and 7B in the left-right direction is set to be equal to the ratio between the pitches with which the pin-insertion holes 223, 223, . . . formed in the front surface section 207 are arranged in the vertical direction and the left-right direction. The positions of the centers of the pin-insertion holes 223, 223, . . . are defined as selection positions for selecting one of the disc trays 226, 226, . . . and extracting the selected disc tray 226 from the storage case 201.

In the case where the pitches with which the pin-insertion holes 223, 223, . . . are arranged in the vertical direction and the left-right direction are, for example, 0.5 mm and 12 mm, respectively, the ratio between the pitches is 1:24. Therefore, the ratio between the amount of movement per unit time of the cartridge holder 44 in the vertical direction and the amount of movement per unit time of the selection sliders 7A and 7B in the left-right direction is set to 1:24. For example, when the cartridge holder 44 moves upward or downward by 0.5 mm in a certain time period, the selection sliders 7A and 7B move by 12 mm in the left-right direction in that time period.

Thus, the ratio between the amount of movement of the cartridge holder 44 per unit time and that of the selection sliders 7A and 7B per unit time is set to be equal to the ratio between the pitches between the selection positions in the vertical direction and the left-right direction. Therefore, when the cartridge holder 44 which holds the disc cartridge 200 is moved upward or downward, the position of each of the operation pins 23A and 23B on the selection sliders 7A and 7B, respectively, coincides with one of the positions of the pin-insertion holes 223, 223, . . . in the front-hack direction.

Thus, the operation of placing each of the operation pins 23A and 23B on the selection sliders 7A and 7B, respectively, at one of the selection positions can be easily performed.

In addition, since the selection positions are not arranged with a predetermined pitch in the thickness direction, it is not necessary to perform high-accuracy positioning for the selection positions. Therefore, the selecting operation can be facilitated.

In the disc changer 1, the group including ten disc trays 226, 226, . . . in the upper section is defined as the first group G1, and the group including ten disc trays 226, 226, . . . in the lower section is defined as the second group G2. The disc trays 226, 226, . . . in the first group G1 are selected by the selection slider 7A, and the disc trays 226, 226, . . . in the second group G2 are selected by the selection slider 7B. When one of the selection sliders 7A and 7B is being operated, the operation of the other one of the selection sliders 7A and 7B is stopped.

Therefore, the efficiency of the operation of selecting the disc trays 226, 226, . . . with the selection sliders 7A and 7B is increased.

Although the example in which two groups G1 and G2 and two selection sliders 7A and 7B are provided is described above, the number of groups is not limited. The efficiency of the selecting operation can be increased irrespective of the number of groups if the same number of selection sliders as the number of groups are provided.

In addition, since the selection sliders 7A and 7B are moved while being guided by the same guide shaft 8, the number of components can be reduced.

The disc changer 1 includes the gear train 41 in which the large gears 42A, 42A, . . . , the small gears 43A, 43A, . . . , the large gears 42B, 42B, . . . , and the small gears 43B, 43B, . . . , which mesh with each other, are arranged in the left-right direction. The rack portion 20A of the selection slider 7A successively meshes with the large gears 42A, 42A, . . . in the gear train 41 so that the selection slider 7A is moved, and the rack portion 20B of the selection slider 7B successively meshes with the large gears 42B, 42B, . . . in the gear train 41 so that: the selection slider 7B is moved.

Therefore, the length of the rack portions 20A and 20B of the selection sliders 7A and 7B, respectively, in the left-right direction can be reduced, and the size of the disc changer 1 can be reduced accordingly.

### Support Plate

The disc-loading block 5000 includes a support plate 53 attached to a back half section of the base chassis 1000 at the right edge thereof and components supported by the support plate 53 (see FIGS. 32 and 33). The support plate 53 is made of, for example, a conductive metal material.

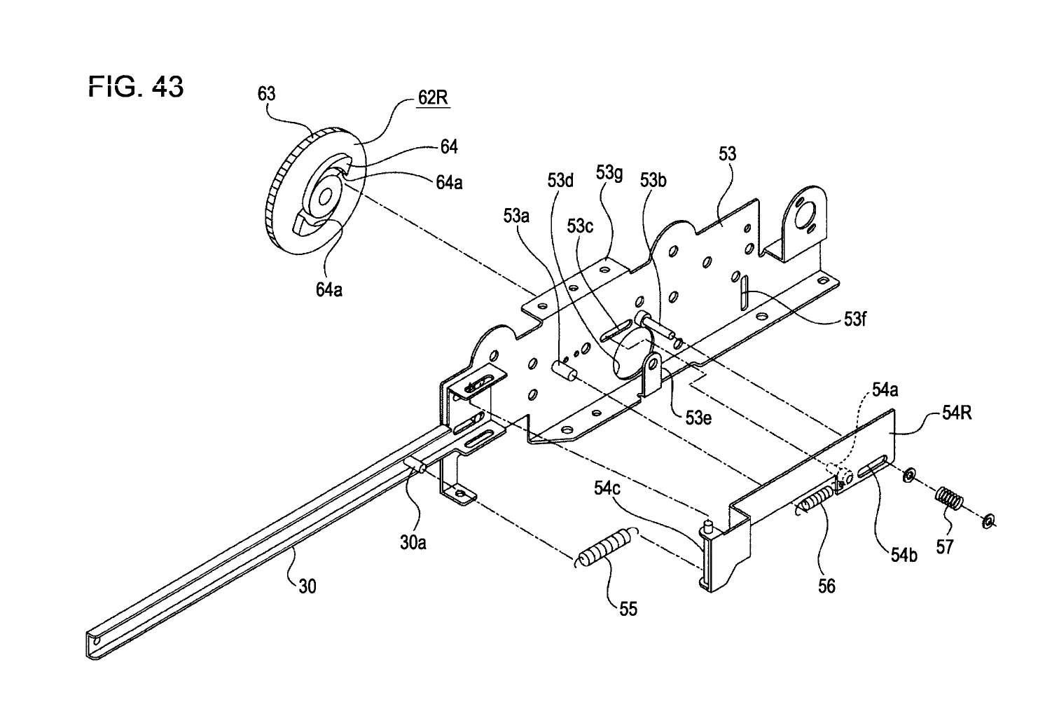

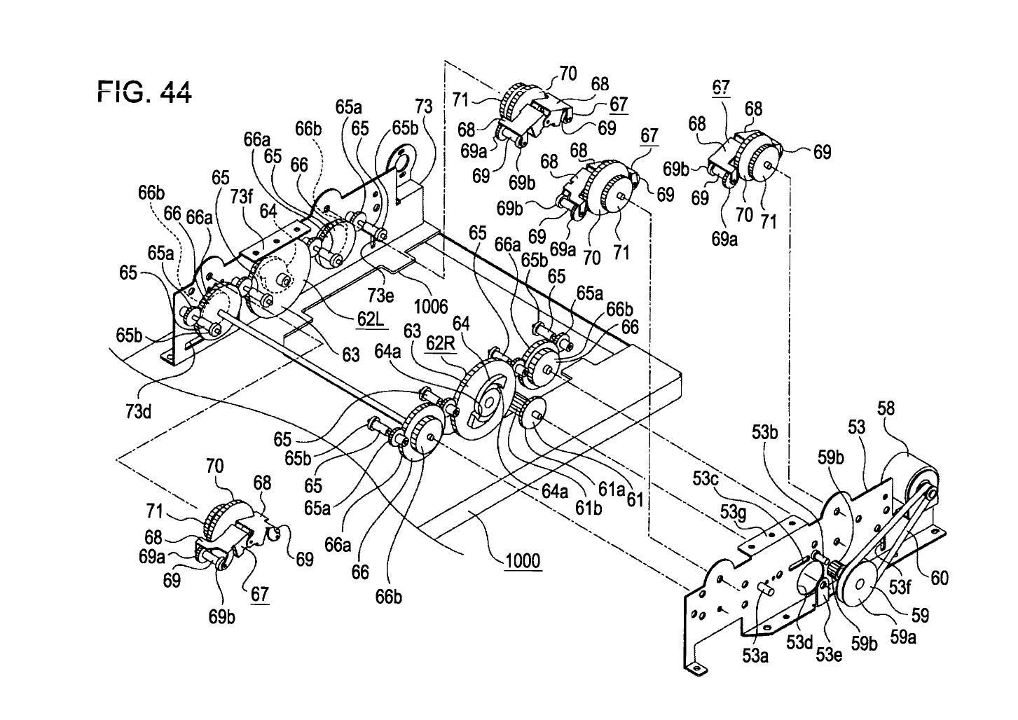

As shown in FIG. 43, a spring-receiving pin 53a and a spring support pin 53b which project rightward are provided on the support plate 53 at positions separated from each other in the front-back direction. A pin support hole 53c which extends in the front-back direction and a circular gear insertion hole 53d are formed in the support plate 53 at positions between the spring-receiving pin 53a and the spring support pin 53b. A gear support tab 53e is provided on the support plate 53 such that the support plate 53 is positioned at the right side of the gear insertion hole 53d. A shaft guide hole 53f, which extends in the vertical direction, is formed in the support plate 53 at a position near the back end thereof. An attachment surface portion 53g, which extends substantially perpendicular to the vertical direction, is provided at the top end of the support plate 53.

The above-described connection lever 30 is supported by the support plate 53 at the front end thereof such that the connection lever 30 is movable in the front-back direction.

### Activation Lever

An activation lever 54R is supported by the connection lever 30 such that the activation lever 54R is movable in the front-back direction and pivotable about a front-end portion thereof.

The activation lever 54R is positioned at the outer side of the support plate 53 and is provided with a cam pin 54a which projects leftward at a position near the back end of the activation lever 54R. A support hole 54b which extends in a front-back direction is formed in a back end portion of the activation lever 54R.

A support shaft 54c which extends in the vertical direction is provided at the front end of the activation lever 54R. The support shaft 54c of the activation lever 54R is supported by the connection lever 30.

A limiter spring 55 is disposed between the support shaft 54c of the activation lever 54R and the spring support pin 30a on the connection lever 30. The limiter spring 55 is, for example, an extension coil spring. The limiter spring 55 reduces unnecessary load applied to the activation lever 54R and the connection lever 30 so that the activation lever 54R and the connection lever 30 can be moved smoothly.

An extension coil spring 56 is provided between the activation lever 54R and the spring-receiving pin 53a on the support plate 53. Therefore, the activation lever 54R is urged forward with respect to the support plate 53. The extension coil spring 56 serves to constantly press the cam pin 54a against the outer peripheral surface of a cam projection on a cam gear, which will be described below.

The spring support pin 53b on the support plate 53 is inserted through the support hole 54b in the activation lever 54R. In this state, a restraining spring 57, which is a compression coil spring, is supported by the spring support pin 53b. The restraining spring 57 has a function of restraining the activation lever 54R from pivoting around the support shaft 54c by a predetermined amount or more in a direction away from the support plate 53.

The cam pin 54a on the activation lever 54R is inserted into the pin support hole 53c in the support plate 53.

### Loading Motor

A loading motor 58 is attached to the support plate 53 at the back end thereof (see FIG. 44).

A gear pulley 59 is supported on the outer surface of the support plate 53. The gear pulley 59 includes a pulley portion 59a and a gear portion 59b. A transmission belt 60 is wound around the pulley portion 59a of the gear pulley 59 and the loading motor 58.

An intermediate gear 61 is supported by the gear supports tab 53e on the support plate 53. The intermediate gear 61 includes a large-diameter portion 61a and a small-diameter portion 61b. The intermediate gear 61 is inserted through the gear insertion hole 53d in the support plate 53, and the large-diameter portion 61a of the intermediate gear 61 meshes with the gear portion 59b of the gear pulley 59.

### Cam Gear

A cam gear 62R is supported at the inner side of the support plate 53. The cam gear 62R includes a disc-shaped gear portion 63 and a cam projection 64 which projects rightward from the right side surface of the gear portion 63. The cam projection 64 has cam grooves 64a and 64a formed at symmetrical positions with respect to the rotational axis. Each cam groove 64a has one end which continues from the right side surface of the gear portion 63, and is inclined rightward toward the other end. Each cam groove 64a has an arc shape which is centered on the rotational center of the cam gear 62R.

The gear portion 63 of the cam gear 62R meshes with the small-diameter portion 61b of the intermediate gear 61, and the cam pin 54a on the activation lever 54R slidably engages with the cam projection 64 of the cam gear 62R.

### Feed Rollers

Four feed rollers 65, 65, . . . are supported at the inner side of the support plate 53 at positions separated from each other in the front-back direction. Each feed roller 65 includes a gear portion 65a and a roller portion 65b which are separated from each other in the axial direction. The gear portions 65a and 65a of the second and third feed rollers 65 and 65 from the front mesh with the gear portion 63 of the cam gear 62R at the front and back ends thereof.

### Connection Gears

Connection gears 66 and 66 are supported at the inner side of the support plate 53 at positions separated from each other in the front-back direction. Each connection gear 66 includes a large-diameter portion 66a and a small-diameter portion 66b. One connection gear 66 is disposed between two feed rollers 65 and 65 closer to the front, and the other connection gear 66 is disposed between two feed rollers 65 and 65 closer to the back. The large-diameter portion 66a of each connection gear 66 meshes with the gear portions 65a and 65a of the two corresponding feed rollers 65.

### Conveying Units

Conveying units 67 and 67 are rotatably supported on the inner surface of the support plate 53 at positions separated from each other in the front-back direction.

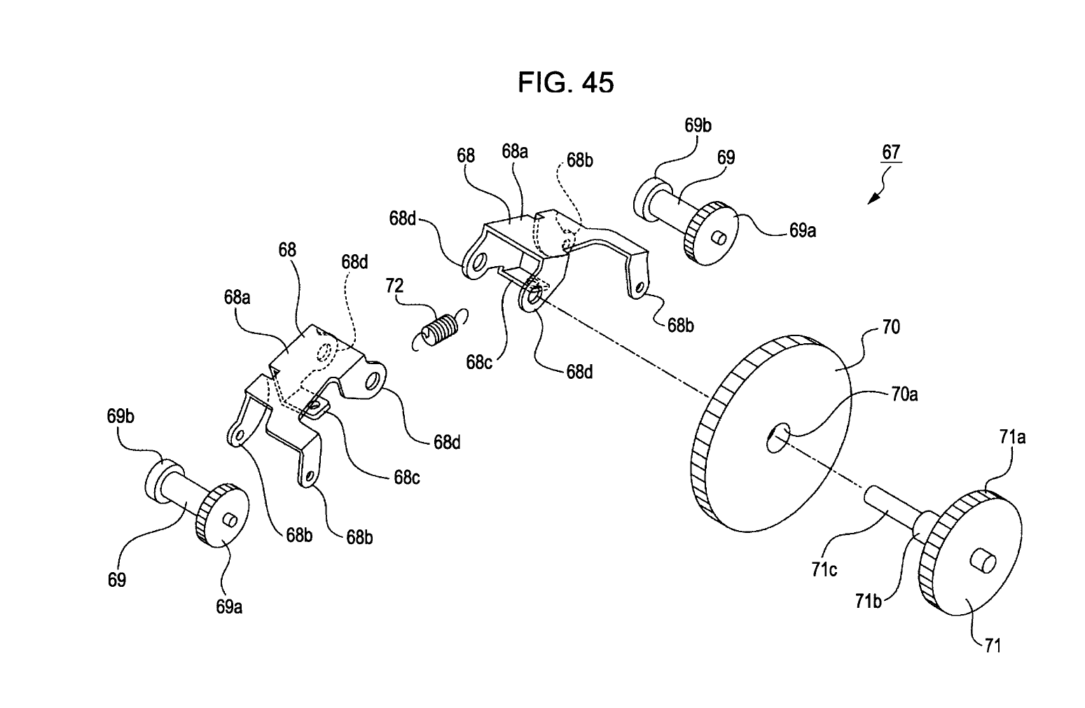

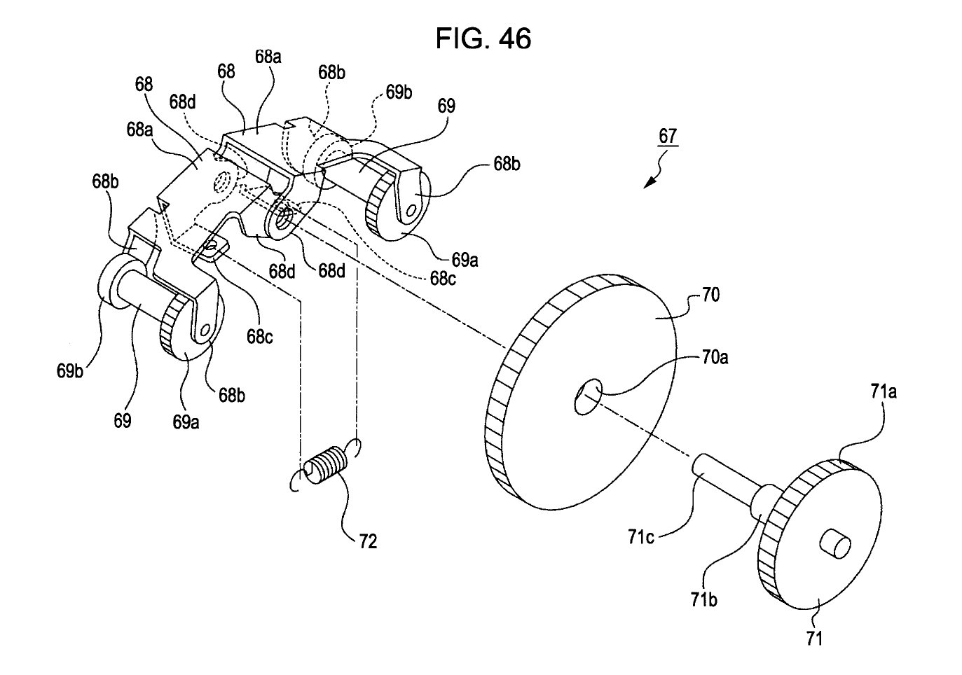

As shown in FIGS. 45 and 46, each conveying unit 67 includes a pair of support parts 68 and 68, feed rollers 69 and 69 supported by the respective support parts 68 and 68, a large gear 70 and a small gear 71 supported by the support parts 68 and 68, and an attachment spring 72.

Each support part 68 includes a base portion 68a which extends substantially perpendicular to the vertical direction, gear support portions 68b and 68b which project substantially downward from the left and right edges of the base portion 68a at one end thereof, a spring-receiving portion 68c which projects rightward from the bottom edge of one of the gear support portions 68b and 68b, and support arms 68d and 68d which project substantially downward from the left and right edges of the base portion 68a at the other end thereof.

Each feed roller 69 includes a gear portion 69a and a roller portion 69b which are separated from each other in the axial direction thereof. Each feed roller 69 is rotatably supported by the corresponding gear support portions 68b and 68b.

The large gear 70 is a spur gear, and is provided with a shaft insertion hole 70a at a central position thereof.

The small gear 71 includes a gear portion 71a, a shaft portion 71b which projects leftward from the gear portion 71a at a central position thereof, and a rotating shaft portion 71c which projects leftward from the end of the shaft portion 71b and which has a diameter smaller than that of the shaft portion 71b.

The rotating shaft portion 71c of the small gear 71 is inserted into the shaft insertion hole 70a in the large gear 70 from the right side thereof and is fixed to the shaft insertion hole 70a.

The support arms 68d, 68d, . . . of the support parts 68 and 68 are disposed so as to overlap each other in the left-right direction. In this state, the rotating shaft portion 71c of the small gear 71 is rotatably supported by the support part 68. The small gear 71 and the large gear 70 are separated from each other by a distance corresponding to the dimension of the shaft portion 71b.

The gear portions 69a and 69a of the feed rollers 69 and 69 mesh with the large gear 70. The small gear 71 and the large gear 70 rotate together with respect to the support parts 68 and 68, and the feed rollers 69 and 69 are rotated by the rotation of the small gear 71 and the large gear 70.

The attachment spring 72 is disposed between the spring-receiving portions 68c and 68c of the support parts 68 and 68. Therefore, the support parts 68 and 68 are urged by the attachment spring 72 in rotational directions in which the feed rollers 69 and 69 are rotated substantially downward about the rotating shaft portion 71c of the small gear 71.

Center shafts of the small gears 71 and 71 of the conveying units 67 and 67 are rotatably supported by the support plate 53.

In the state in which each conveying unit 67 is supported by the support plate 53, the large-diameter portion 66a of the corresponding connection gear 66 is placed between the large gear 70 and the gear portion 71a of the small gear 71, and the small-diameter portion 66b of the connection gear 66 meshes with the gear portion 71a of the small gear 71. In this state, the gear portion 69a of each feed roller 69 is disposed between the gear portion 65a and the roller portion 65b of the corresponding feed roller 65 such that the gear portion 69a does not come into contact with the feed roller 65. In addition, the roller portion 69b of each feed roller 69 is pressed against the roller portion 65b of the corresponding feed roller 65 by the urging force applied by the attachment spring 72.

In the disc-loading block 5000 which is structured as described above, when the loading motor 58 is rotated, the driving force of the loading motor 58 is successively transmitted to the transmission belt 60, the gear pulley 59, the intermediate gear 61, the cam gear 62R, the feed rollers 65 and 65 with the gear portions 65a and 65a which mesh with the cam gear 62R, the connection gears 66 and 66, and the feed rollers 65 and 65 positioned at the front and back ends, so that these components are rotated.

In addition, the driving force is successively transmitted from the connection gears 66 and 66 to the small gears 71 and 71, the large gears 70 and 70, and the gear portions 69a, 69a, . . . , and the feed rollers 69, 69, . . . are rotated as a result. The roller portions 65b, 65b, . . . of the feed rollers 65, 65, . . . and the roller portions 69b, 69b, . . . of the feed rollers 69, 69, . . . are rotated while being in contact with each other.

The rotation of the feed rollers 65, 65, . . . and 69, 69, . . . in one direction (forward direction) corresponds to an operation of extracting each disc tray 226 and each disc-shaped recording medium 300 from the storage case 201, and the rotation of the feed rollers 65, 65, . . . and 69, 69, . . . in the opposite direction (reverse direction) corresponds to an operation of inserting each disc tray 226 and each disc-shaped recording medium 300 into the storage case 201.

When the feed rollers 65, 65, . . . and 69, 69, . . . are rotated in the forward direction, the cam pin 54a on the activation lever 54R is pressed against the outer peripheral surface of the cam projection 64 of the cam gear 62R. Therefore, the activation lever 54R is moved in the front-back direction, and the connection lever 30 is moved in the front-back direction by the movement of the activation lever 54R. As a result, the operation lever 25 is pivoted around the guide shaft 8.

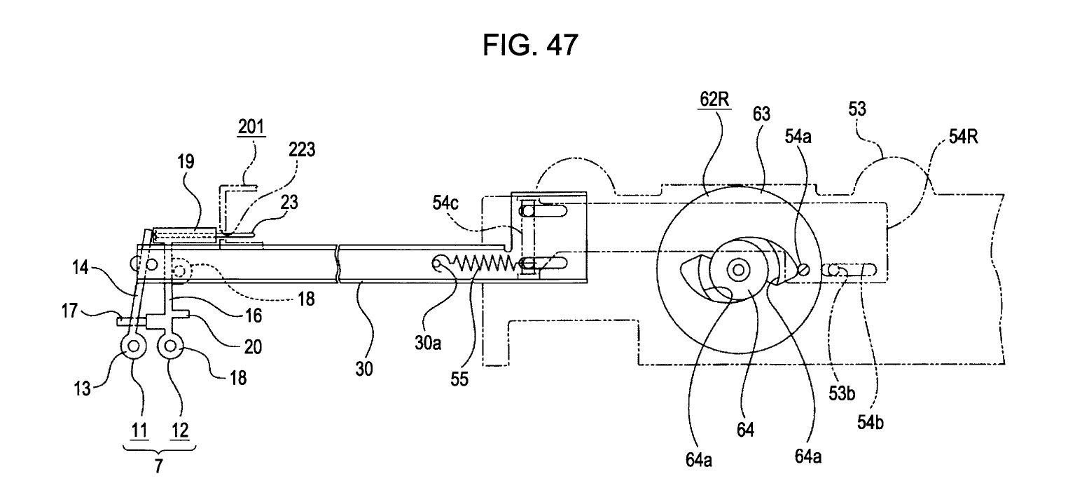

When the feed rollers 65, 65, . . . and 69, 69, . . . are rotated in the forward direction and the activation lever 54R is moved to the back end of the movable range thereof by the rotation of the cam gear 62R, the state shown in FIG. 47 is established. More specifically, the pin attachment member 11 of the selection slider 7 is pushed backward by the operation lever 25 and the operation pin 23 is inserted through one of the pin-insertion holes 223, 223, . . . in the front surface section 207 of the disc cartridge 200 so that the tab 227 of the corresponding disc tray 226 is pushed by the operation pin 23.

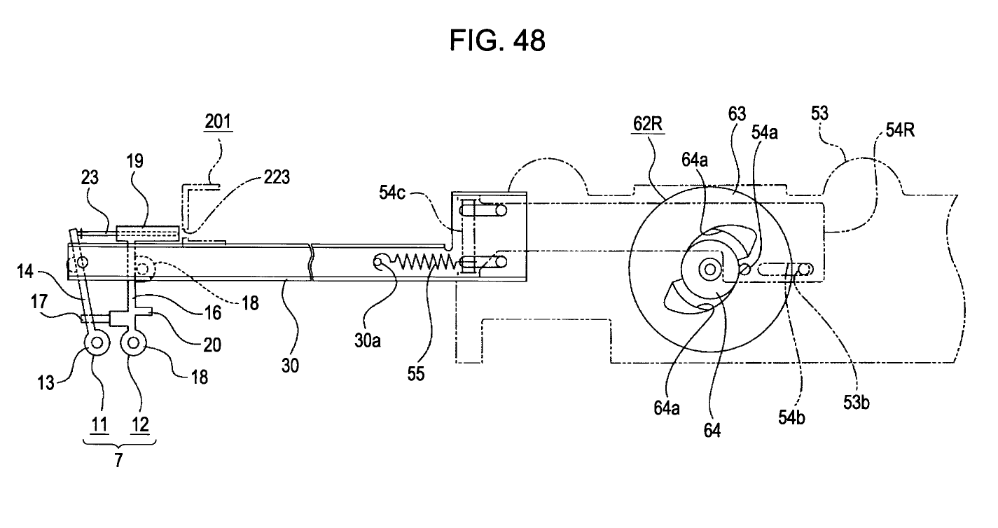

When the feed rollers 65, 65, . . . and 69, 69, . . . are rotated in the forward direction and the activation lever 54R is moved to the front end of the movable range thereof by the rotation of the cam gear 62R, the state shown in FIG. 48 is established. More specifically, the pushing force applied to the pin attachment member 11 of the selection slider 7 by the operation lever 25 is eliminated and the operation pin 23 is pulled out from the pin-insertion hole 223 in the front surface section 207.

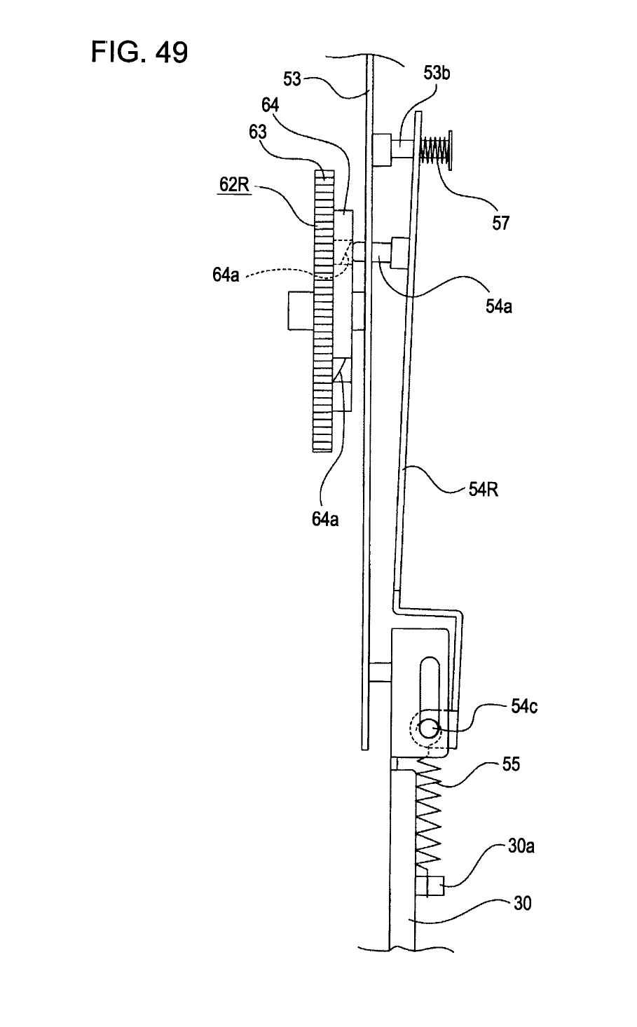

When the feed rollers 65, 65, . . . and 69, 69, . . . are rotated in the reverse direction, the cam pin 54a on the activation lever 54R slides along the cam gear 62R while repeatedly entering and leaving the cam grooves 64a and 64a in the cam gear 62R. Therefore, the activation lever 54R does not move in the front-back direction, but pivots around the support shaft 54c such that the activation lever 54R substantially moves in the left-right direction as the cam pin 54a slides along the inclined surfaces of the cam grooves 64a and 64a (see FIG. 49). At this time, the end face of the cam pin 54a is pressed against the cam grooves 64a and 64a by the urging force applied by the restraining spring 57.

Therefore, when the feed rollers 65, 65, . . . and 69, 69, . . . are rotated in the reverse direction, the connection lever 30 and the operation lever 25 do not move.

### Support Plate

The disc-ejecting block 6000 includes a support plate 73 attached to a back half section of the base chassis 1000 at the left edge thereof and components supported by the support plate 73 (see FIGS. 32 and 33). The support plate 73 is made of, for example, a conductive metal material.

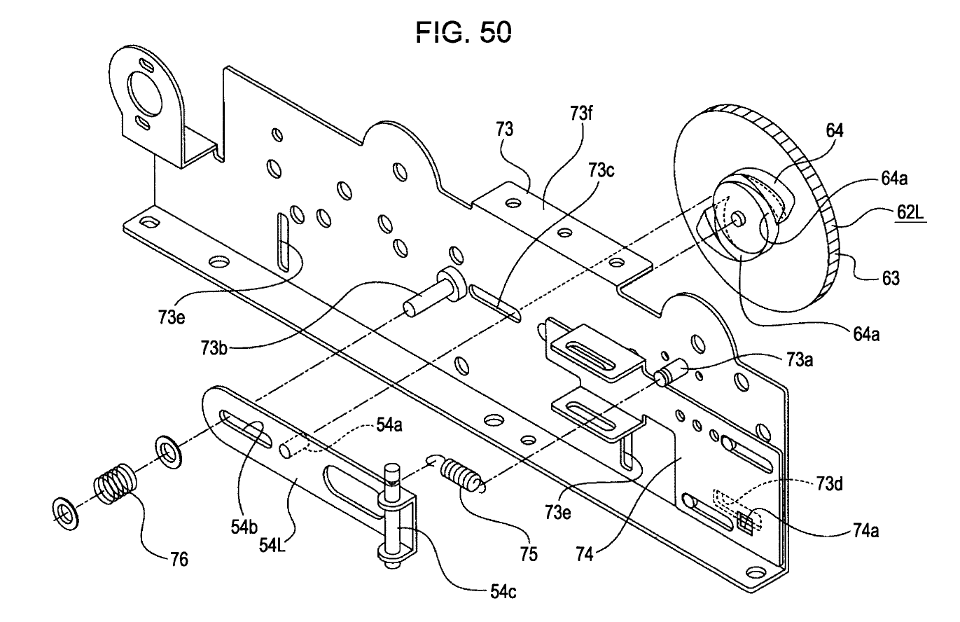

As shown in FIG. 50, a spring-receiving pin 73a and a spring support pin 73b which project leftward are provided on the support plate 73 at positions separated from each other in the front-back direction. A pin support hole 73c which extends in the front-back direction is formed in the support plate 73 at a position between the spring-receiving pin 73a and the spring support pin 73b. A lever insertion hole 73d which extends in the front-back direction is formed in the support plate 73 at the front end thereof. Shaft guide holes 73e and 73e, which extend in the vertical direction, are formed in the support plate 73 at positions separated from each other in the front-back direction. An attachment surface portion 73f, which extends substantially perpendicular to the vertical direction, is provided at the top end of the support plate 73.

### Connection Slider

A connection slider 74 is supported by the support plate 73 at the front end thereof such that the connection slider 74 is movable in the front-back direction. A lever support hole 74a is formed in a front-end portion the connection slider 74 at the bottom end thereof.

### Activation Lever

An activation lever 54L is supported by the connection slider 74 such that the activation lever 54L is movable in the front-back direction and pivotable about a front-end portion thereof.

The activation lever 54L is positioned at the outer side of the support plate 73 and is provided with a cam pin 54a which projects rightward at a position near the back end of the activation lever 54L. A support hole 54b which extends in a front-back direction is formed in a back end portion of the activation lever 54L.

A support shaft 54c which extends in the vertical direction is provided at the front end of the activation lever 54L. The support shaft 54c of the activation lever 54L is supported by the connection slider 74.

An extension coil spring 75 is provided between the activation lever 54L and the spring-receiving pin 73a on the support plate 73. Therefore, the activation lever 54L is urged forward with respect to the support plate 73. The extension coil spring 75 serves to constantly press the cam pin 54a against the outer peripheral surface of a cam projection on a cam gear, which will be described below.

The spring support pin 73b on the support plate 73 is inserted through the support hole 54b in the activation lever 54L. In this state, a restraining spring 76, which is a compression coil spring, is supported by the spring support pin 73b. The restraining spring 76 has a function of restraining the activation lever 54L from pivoting around the support shaft 54c by a predetermined amount or more in a direction away from the support plate 73.

The cam pin 54a on the activation lever 54L is inserted into the pin support hole 73c in the support plate 73.

A cam gear 62L is supported at the inner side of the support plate 73. The cam gear 62L has the same size and shape as those of the above-described cam gear 62R, and includes a gear portion 63 and a cam projection 64 which projects leftward from the left side surface of the gear portion 63.

As shown in FIG. 44, four feed rollers 65, 65, . . . two connection gears 66 and 66, and two conveying units 67 and 67 are supported at the inner side of the support plate 73 at positions separated from each other in the front-back direction.

The feed rollers 65, 65, . . . , the connection gears 66 and 66, and the conveying units 67 and 67 respectively have the same sizes and shapes as those of the feed rollers 65, 65, . . . , the connection gears 66 and 66, and the conveying units 67 and 67 included in the disc-loading block 5000, and are arranged symmetrically in the left-right direction. In addition, the manner in which these components mesh with each other and with the cam gear 62L is similar to that in the disc-loading block 5000, and explanations thereof are thus omitted.

The connection gear 66 at the front in the disc-loading block 5000 and the connection gear 66 at the front in the disc-ejecting block 6000 are connected to each other by a synchronizing shaft 77 (see FIG. 44). Therefore, the disc-ejecting block 6000 receives the driving force of the loading motor 58 from the disc-loading block 5000 through the synchronizing shaft 77 and is driven by the driving force.

As described above, in the disc changer 1, the operation lever 25, which pushes the pin attachment members 11A and 11B of the selection sliders 7A and 7B, respectively, and the feed rollers 65, 65, . . . and 69, 69, . . . are driven by a single loading motor 58.

Since the operation lever 25 and the feed rollers 65, 65, . . . and 69, 69, . . . which are separate components, are driven by a single loading motor 58, the number of components can be reduced and the structure can be simplified.

In addition, since the operation lever 25 and the feed rollers 65, 65, . . . and 69, 69, . . . are not driven by individual motors, it is not necessary to switch between the motors. Therefore, the operation speed can be increased and power consumption can be reduced.

### Return Lever

A return lever unit 78 is disposed on the base chassis 1000 at a position directly behind the cartridge holder 44 and near the left edge of the base chassis 1000 (see FIG. 40).

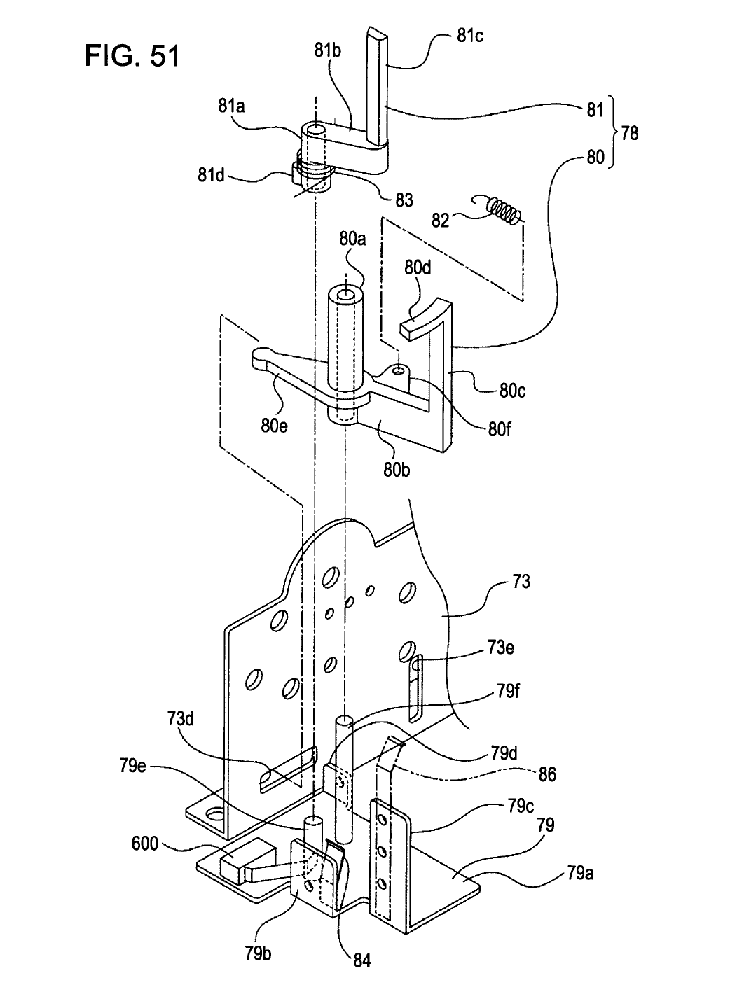

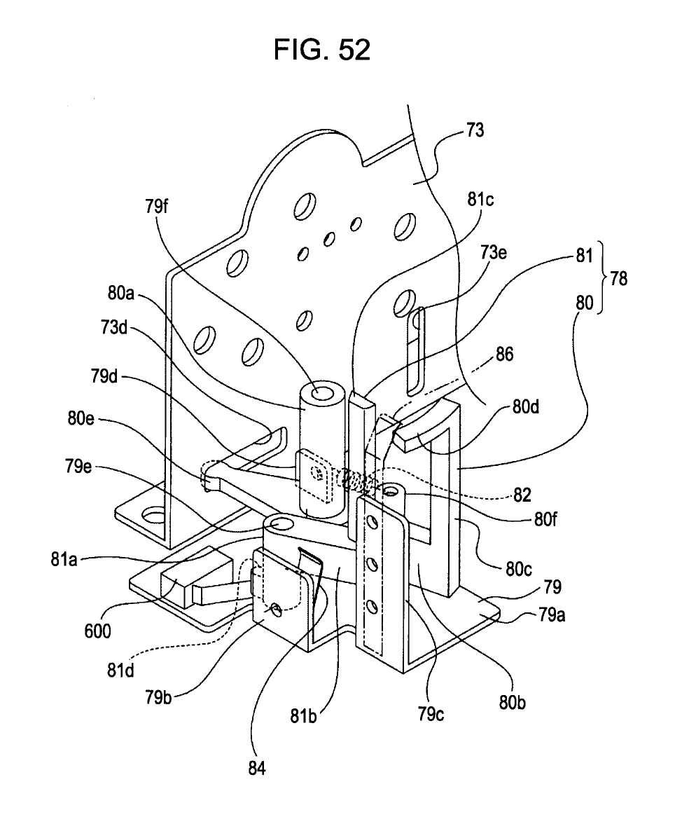

The return lever unit 78 is supported by a lever support member 79 attached to the top surface of the base chassis 1000 (see FIGS. 51 and 52).

The lever support member 79 includes an attachment surface portion 79a which extends substantially perpendicular to the vertical direction, a spring attachment surface portion 79b which projects upward from the front edge of the attachment surface portion 79a, a lever attachment surface portion 79c which projects upward from the front edge of the attachment surface portion 79a, a spring support surface portion 79d which projects upward from the back edge of the attachment surface portion 79a, a first rotating shaft 79e which projects upward from the top surface of the attachment surface portion 79a, and a second rotating shaft 79f which projects upward from the top surface of the attachment surface portion 79a at a position behind the first rotating shaft 79e.

The return lever unit 78 includes a swing lever 80 and a transmission lever 81.

The swing lever 80 is rotatably supported by the second rotating shaft 79f. The swing lever 80 includes a support cylindrical portion 80a which extends in the vertical direction and is supported by the second rotating shaft 79f, a first arm portion 80b which projects to the side from the bottom end of the support cylindrical portion 80a, a second arm portion 80c which projects upward from an end of the first arm portion 80b, a pushing projection 80d which projects horizontally from the top end of the second arm portion 80c, a support arm portion 80e which projects from a position near the bottom end of the support cylindrical portion 80a in a direction opposite to the direction in which the first arm portion 80b projects, and a spring-receiving projection 80f which projects horizontally from the first arm portion 80b.

A limit spring 82 is provided between the spring support surface portion 79d of the lever support member 79 and the spring-receiving projection 80f of the swing lever 80. The limit spring 82 is, for example, a compression coil spring, and the swing lever 80 is urged counterclockwise in a plan view by the limit spring 82.

The support arm portion 80e of the swing lever 80 is inserted into the lever support hole 74a in the connection slider 74 through the lever insertion hole 73d in the support plate 73. Therefore, when the connection slider 74 moves in the front-back direction, the swing lever 80 rotates around the second rotating shaft 79f.

The transmission lever 81 is rotatably supported by the first rotating shaft 79e. The transmission lever 81 includes a cylindrical portion 81a which extends in the vertical direction and is supported by the first rotating shaft 79e, an arm portion 81b which projects to the side from the top end of the cylindrical portion 81a, and an operation projection 81c which projects upward from an end of the arm portion 81b. An operation projection 81d which projects to the side is provided at the bottom end of the cylindrical portion 81a of the transmission lever 81.

The top end of the operation projection 81c of the transmission lever 81 is positioned above the pushing projection 80d of the swing lever 80.

The arm portion 81b of the transmission lever 81 is positioned above the first arm portion 80b of the swing lever 80.

A torsion coil spring 83 is supported by the cylindrical portion 81a of the transmission lever 81, and the torsion coil spring 83 engages with the lever support member 79 and the arm portion 81b at both ends thereof. Therefore, the transmission lever 81 is urged clockwise in a plan view by the torsion coil spring 83.

A bottom end portion of a return spring 84, which is long in the vertical direction, is attached to the spring attachment surface portion 79b of the lever support member 79. A leaf spring, for example, is used as the return spring 84, and the return spring 84 is positioned such that a top end portion thereof can come into contact with the arm portion 81b of the transmission lever 81. The urging force applied by the return spring 84 is larger than that applied by the torsion coil spring 83.

### Tray-Storage Detection Switch

A tray-storage detection switch 600 is disposed on the attachment surface portion 79a of the lever support member 79. The tray-storage detection switch 600 is operated by the operation projection 81d when the transmission lever 81 rotates, and detects the position of each disc tray 226 with respect to the storage case 201.

As described above, when the loading motor 58 is rotated, the disc-loading block 5000 starts to operate. At the same time, the driving force of the loading motor 58 is transmitted to the disc-ejecting block 6000 by the synchronizing shaft 77, and the disc-ejecting block 6000 also starts to operate.

More specifically, when the loading motor 58 is rotated, the can gear 62L, the feed rollers 65, 65, . . . and 69, 69, . . . , and the connection gears 66 and 66 in the disc-ejecting block 6000 receive the driving force of the loading motor 58 from the synchronizing shaft 77, and are rotated. At this time, the cam gear 62L, the feed rollers 65, 65, . . . , and the connection gears 66 and 66 in the disc-ejecting block 6000 are rotated in the same direction as the cam gear 62R, the feed rollers 65, 65, . . . , and the connection gears 66 and 66 in the disc-loading block 5000.

Therefore, when the feed rollers 65, 65, . . . and 69, 69, . . . are rotated in the forward direction, the cam gears 62R and 62L, all of the feed rollers 65, 65, . . . and 69, 69, . . . , and all of the connection gears 66, 66, . . . function as a disc loading mechanism for extracting the selected disc-shaped recording medium 300 from the disc cartridge 200 and conveying the disc-shaped recording medium 300 backward. When the feed rollers 65, 65, . . . and 69, 69, . . . are rotated in the reverse direction, the cam gears 62R and 62L, all of the feed rollers 65, 65, . . . and 69, 69, . . . , and all of the connection gears 66, 66, . . . function as a disc ejecting mechanism for conveying the disc-shaped recording medium 300 forward to insert the disc-shaped recording medium 300 into the disc cartridge 200.

In the disc-ejecting block 6000, when the feed rollers 65, 65, . . . and 69, 69, . . . are rotated in the reverse direction, the cam pin 54a on the activation lever 54L is pressed against the outer peripheral surface of the cam projection 64 of the cam gear 62L. Therefore, the activation lever 54L is moved in the front-back direction, and the connection slider 74 is moved in the front-back direction by the movement of the activation lever 54L. As a result, the swing lever 80 is caused to swing.

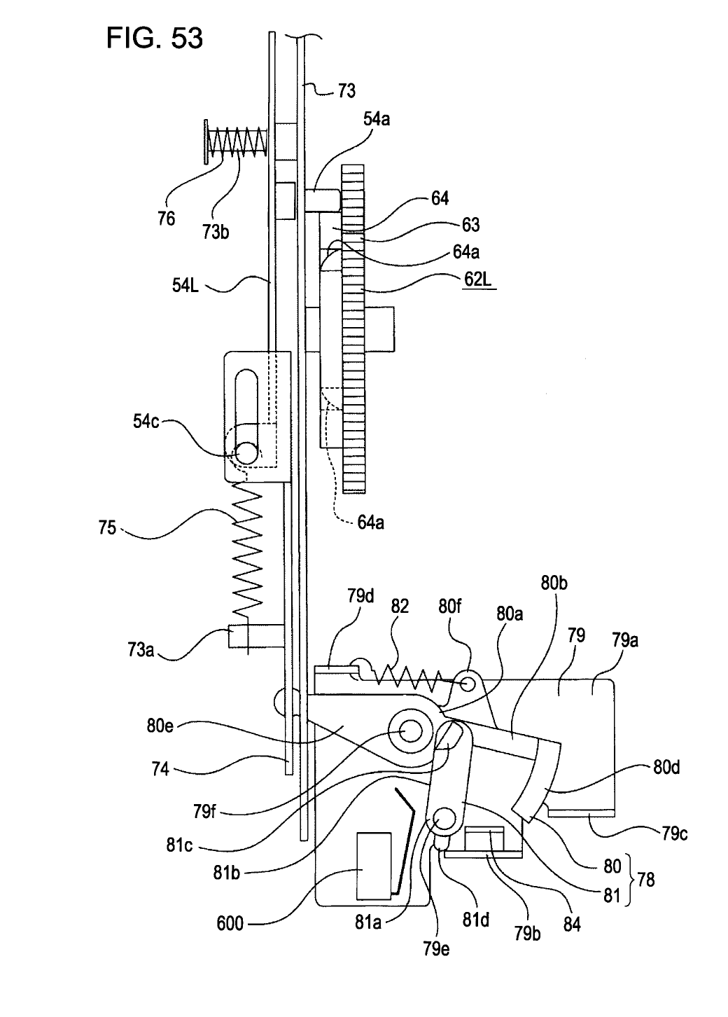

When the feed rollers 65, 65, . . . and 69, 69, . . . are rotated in the reverse direction and the activation lever 54L is moved to the back end of the movable range thereof by the rotation of the cam gear 62L, the swing lever 80 is moved to the front end of the movable range thereof in the rotational direction, as shown in FIG. 53.

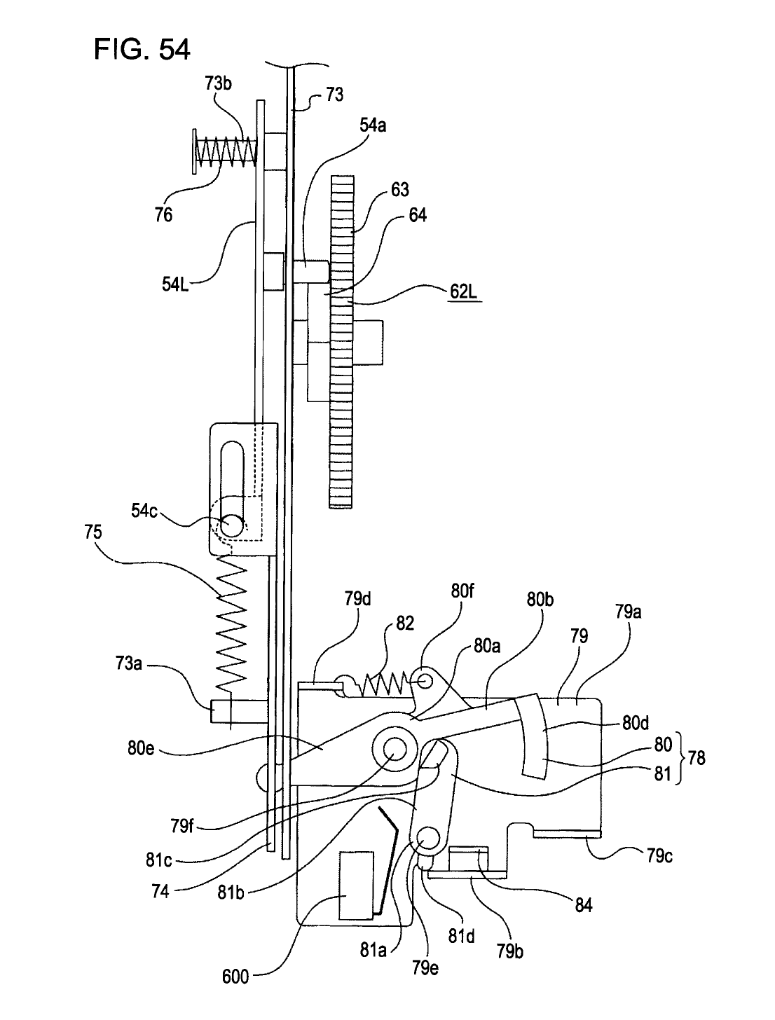

When the feed rollers 65, 65, . . . and 69, 69, . . . are rotated in the reverse direction and the activation lever 54L is moved to the front end of the movable range thereof by the rotation of the cam gear 62L, the swing lever 80 is moved to the back end of the movable range thereof in the rotational direction, as shown in FIG. 54.

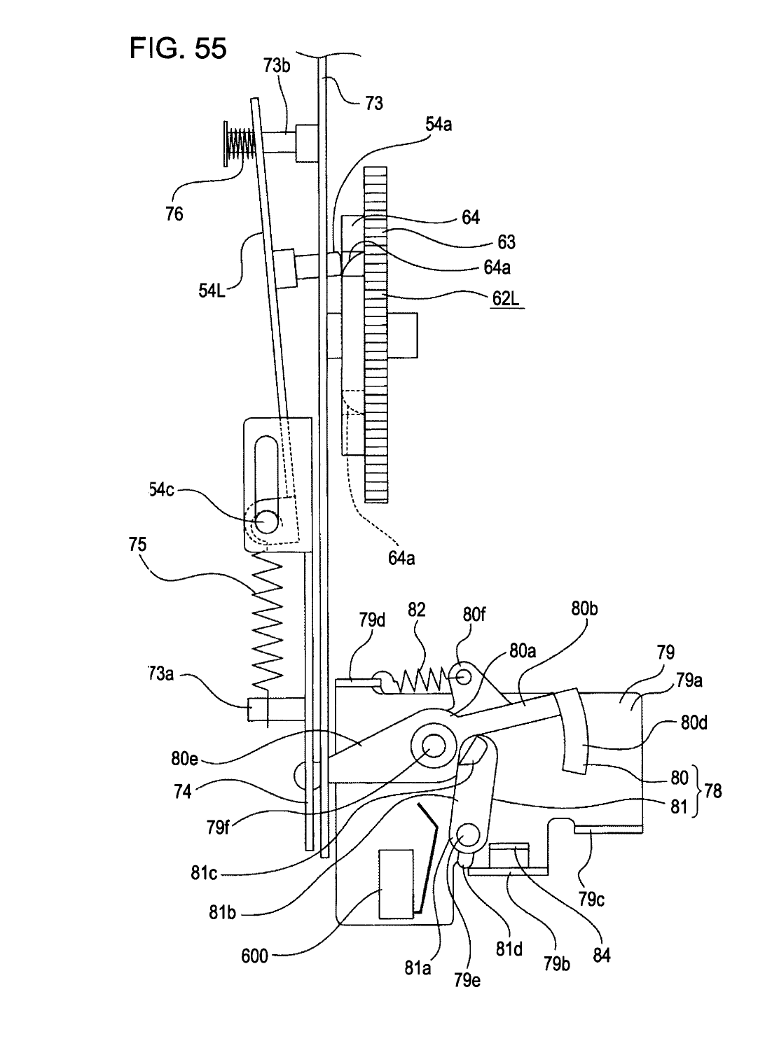

When the feed rollers 65, 65, . . . and 69, 69, . . . are rotated in the forward direction, the cam pin 54a on the activation lever 54L slides along the cam gear 62L while repeatedly entering and leaving the cam grooves 64a and 64a in the cam gear 62L. Therefore, the activation lever 54L does not move in the front-back direction, but pivots around the support shaft 54c such that the activation lever 54L substantially moves in the left-right direction as the cam pin 54a slides along the inclined surfaces of the cam grooves 64a and 64a (see FIG. 55). At this time, the end face of the cam pin 54a is pressed against the cam grooves 64a and 64a by the urging force applied by the restraining spring 76.

Therefore, when the feed rollers 65, 65, . . . and 69, 69, . . . are rotated in the forward direction, the connection slider 74 and the swing lever 80 do not move.

As described above, in the disc changer 1, the feed rollers 65, 65, . . . and 69, 69, . . . and the swing lever 80 for inserting each disc tray 226 into the storage case 201 are operated by a single loading motor 58.

Since the feed rollers 65, 65, . . . and 69, 69, . . . and the swing lever 80, which are separate components, are driven by a single loading motor 58, the number of components can be reduced and the structure can be simplified.

In addition, since the feed rollers 65, 65, . . . and 69, 69, . . . and the swing lever 80 are not driven by individual motors, it is not necessary to switch between the motors. Therefore, the operation speed can be increased and the power consumption can be reduced.

In addition, the operation lever 25 and the swing lever 80 can be selectively operated in accordance with the rotational direction of the loading motor 58. Therefore, the operation speed can be increased and the power consumption can be reduced.

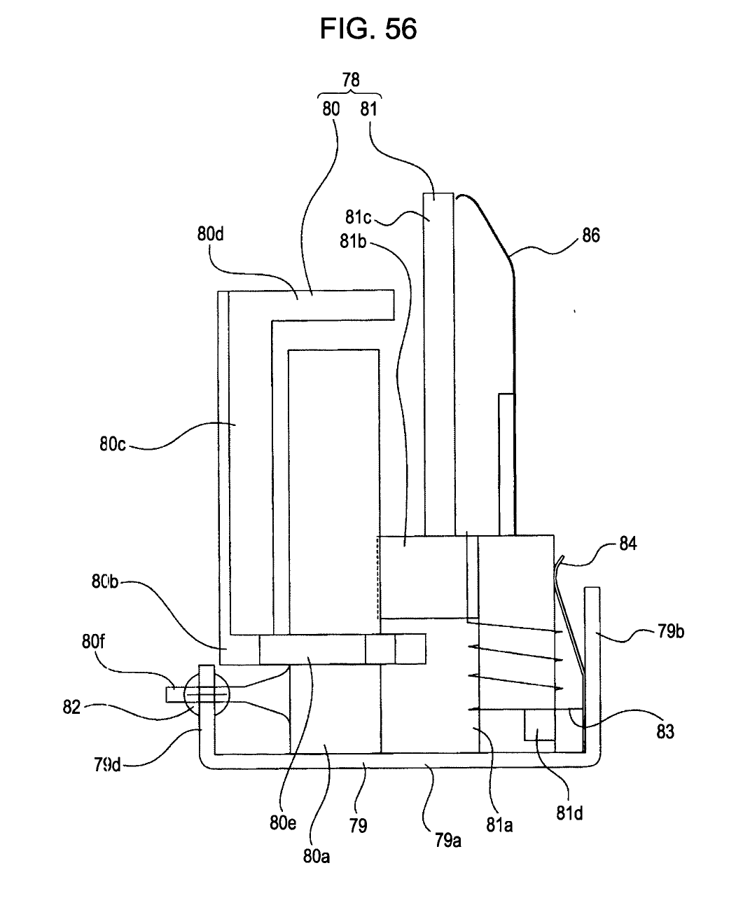

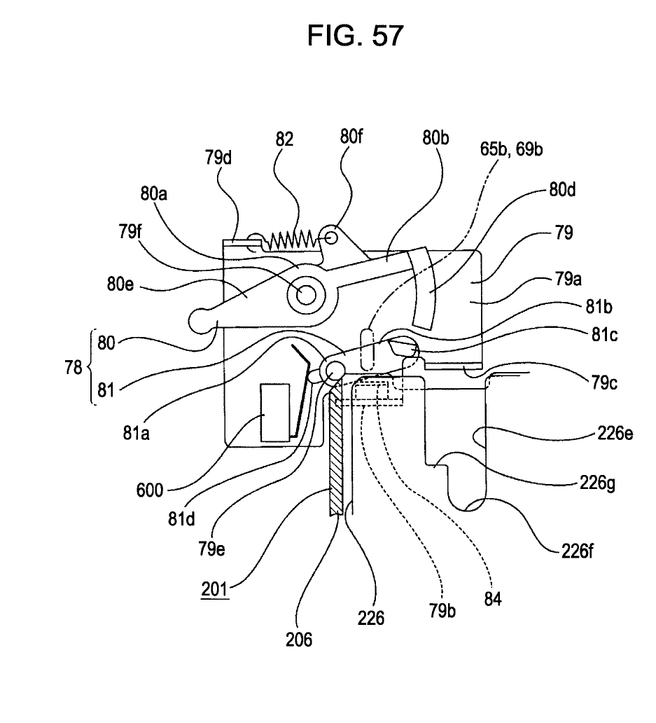

In the disc cartridge 200, in the state in which the disc trays 226, 226, . . . , the disc-shaped recording media 300, 300, . . . , and the cover sheets 228, 228, . . . are stored in the storage case 201, the transmission lever 81 is disposed at a position (standby position) behind the back surface of the disc cartridge 200, owing to the counterclockwise urging force applied by the return spring 84 in a plan view and the clockwise urging force applied by the torsion coil spring 83 (see FIGS. 56 and 57).

At this time, the activation lever 54L is retained at the front end of the movable range thereof, and the swing lever 80 is retained at the back end of the pivotable range thereof.

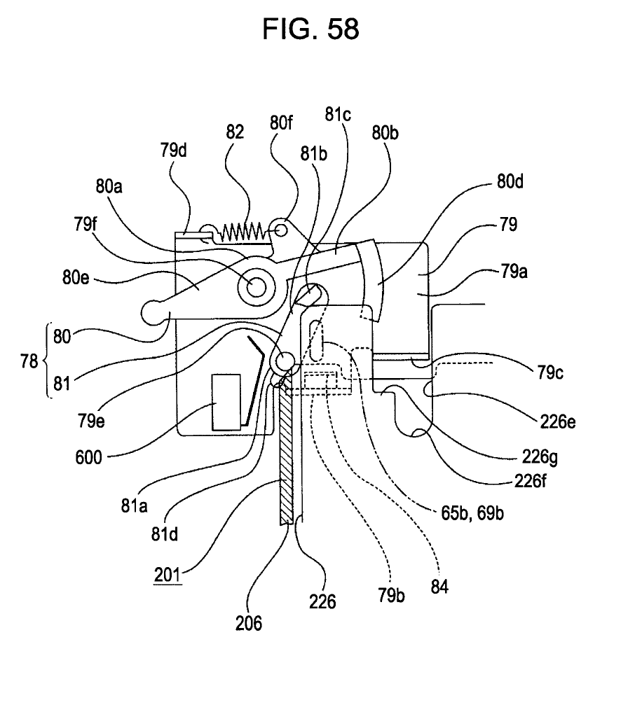

In a loading operation, when the tab 227 of the selected disc tray 226 is pushed by the operation pin 23 and a part of the disc tray 226 projects from the opening 202a in the storage case 201 together with the disc-shaped recording medium 300 and the cover sheet 228, the operation projection 81c of the transmission lever 81 is pushed by a left edge portion of the disc tray 226, as shown in FIG. 58. Accordingly, the transmission lever 81 is rotated counterclockwise in a plan view. At this time, the operation projection 81c is caused to slide along the outer peripheral surface of the disc tray 226 by the urging force applied by the torsion coil spring 83, and the arm portion 81b is moved backward away from the return spring 84.

After a portion of the disc tray 226 projects backward from the opening 202a, the disc tray 226 is moved backward by the feed rollers 65, 65, . . . and 69, 69, . . . rotated by the driving force of the loading motor 58. At this time, the operation projection 81c of the transmission lever 81 slides along the outer peripheral surface of the disc tray 226, and the transmission lever 81 is rotated counterclockwise against the urging force applied by the torsion coil spring 83.

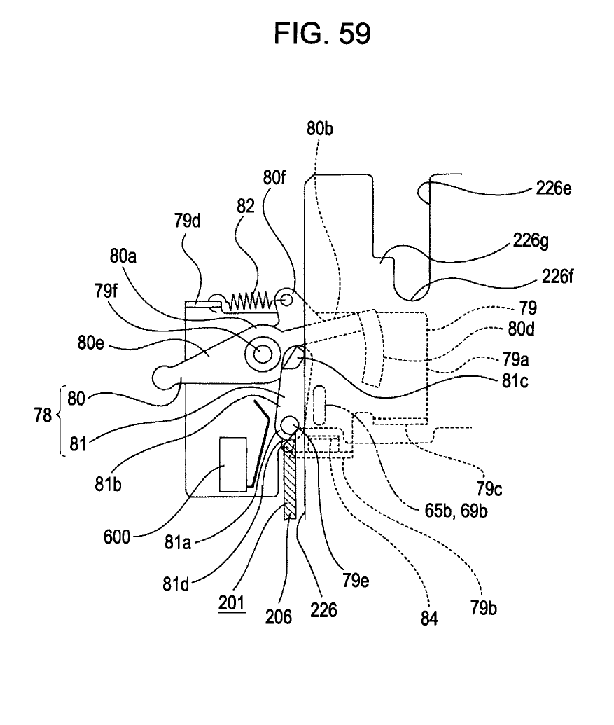

After the transmission lever 81 is rotated counterclockwise, the transmission lever 81 is retained at a certain rotational position (non-operating position) while the operation projection 81c slides along the left side surface of the disc tray 226 (see FIG. 59).

The disc tray 226 which is moved backward by the feed rollers 65, 65, . . . and 69, 69, . . . is conveyed to a recording-reproducing position together with the disc-shaped recording medium 300, as described in detail below.

In an ejecting operation, the disc tray 226 is conveyed forward from the recording-reproducing position together with the disc-shaped recording medium 300. Then, the disc tray 226 is inserted into the storage case 201 together with the disc-shaped recording medium 300 and the cover sheet 228 by the feed rollers 65, . . . , 69, 69, . . . .

While the disc tray 226 is being conveyed by the feed rollers 65, 65, . . . and 69, 69, . . . , the operation projection 81c slides along the left side surface of the disc tray 226. Therefore, the transmission lever 81 is retained at the non-operating position. Since the ejecting operation is being performed, the activation lever 54L is periodically moved forward and backward as described above, and the swing lever 80 is caused to swing accordingly.

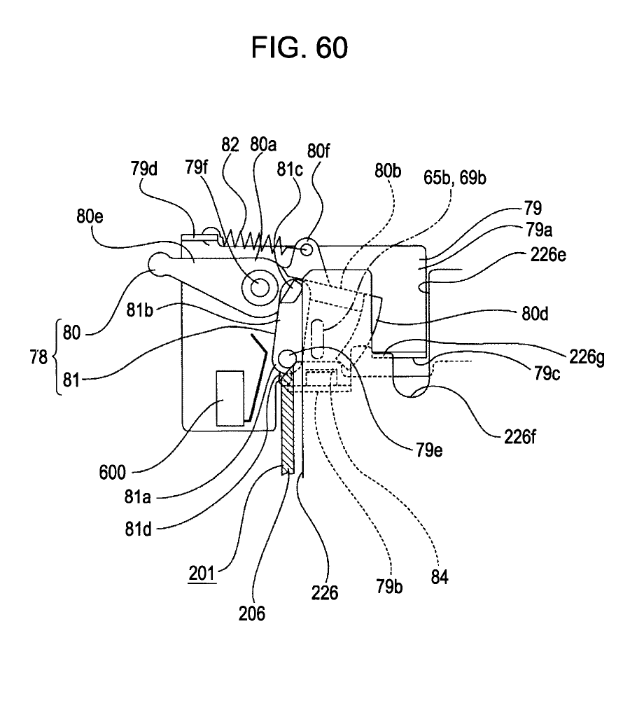

Although the swing lever 80 is caused to swing during the ejecting operation, while the transmission lever 81 is retained at the non-operating position, the first arm portion 80b of the swing lever 80 moves under the arm portion 81b of the transmission lever 81 when the swing lever 80 swings forward. Therefore, the swing lever 80 does not come into contact with the transmission lever 81 (see FIG. 60).

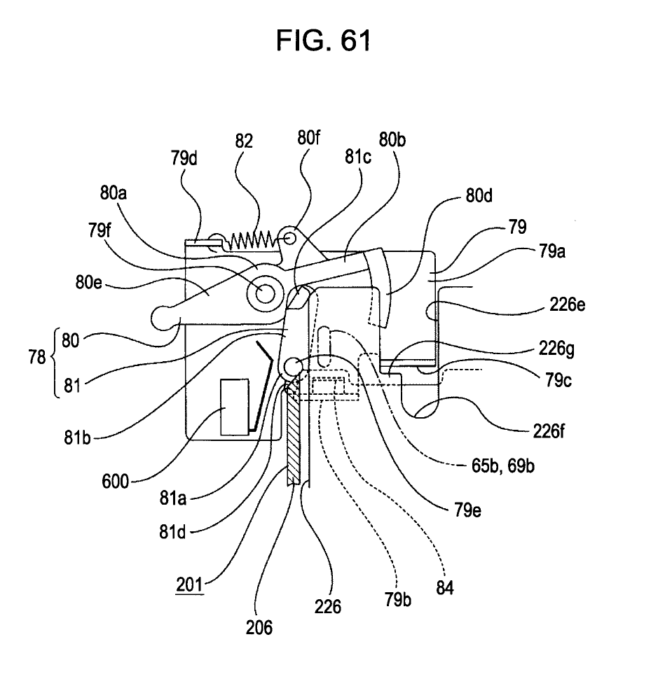

Then, when the swing lever 80 continuously swings and the disc tray 226 is further conveyed forward by the feed rollers 65, 65, . . . and 69, 69, . . . , the operation projection 81c of the transmission lever 81 is caused to slide from the left side surface to the back surface of the disc tray 226. Accordingly, the transmission lever 81 starts to rotate clockwise from the non-operating position (see FIG. 61).

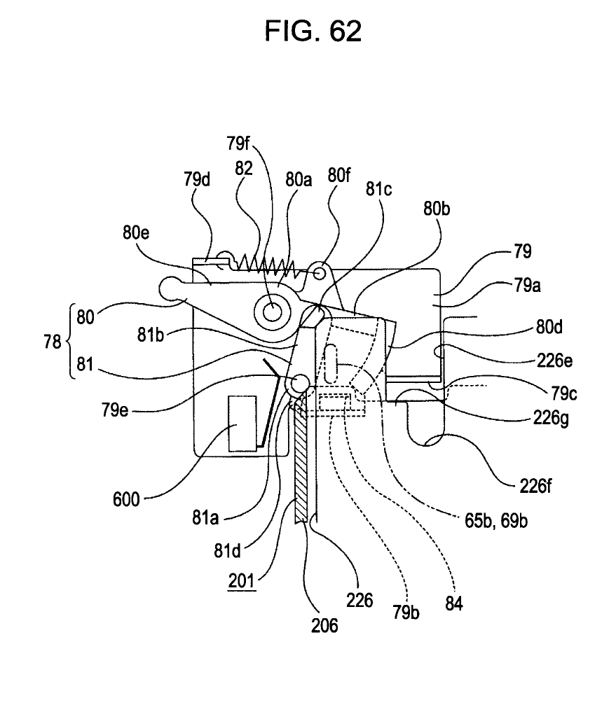

Also in this state, the first arm portion 80b of the swing lever 80 moves under the arm portion 81b of the transmission lever 81 when the swing lever 80 swings forward. Therefore, the swing lever 80 does not come into contact with the transmission lever 81 (see FIG. 62).

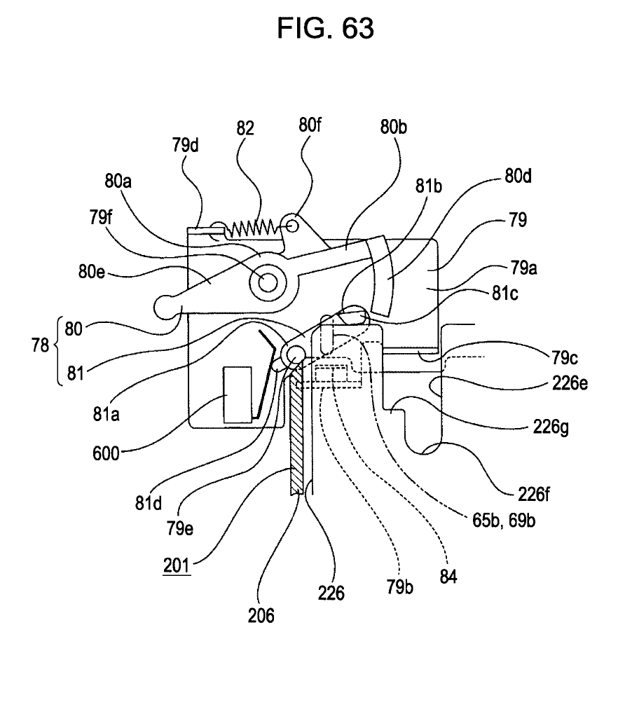

Then, the when the swing lever 80 continuously swings and the disc tray 226 is further conveyed forward by the feed rollers 65, 65, . . . and 69, 69, . . . , the operation projection 81c of the transmission lever 81 is caused to slide along the back surface of the disc tray 226. Accordingly, the transmission lever 81 rotates further clockwise (see FIG. 63).

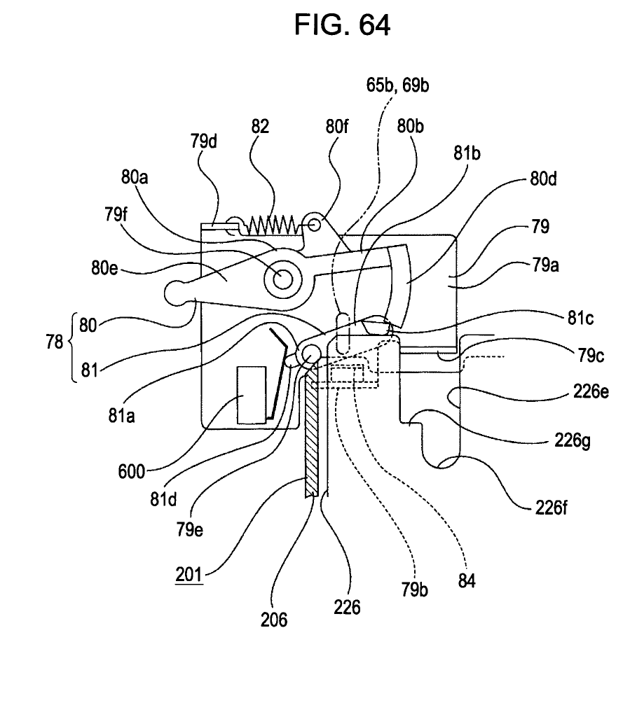

When the feed rollers 65, 65, . . . and 69, 69, . . . stop conveying the disc tray 226 forward and the disc tray 226 reaches a certain position, the pushing projection 80d of the swing lever 80, which is caused to swing, comes into contact with the operation projection 81c of the transmission lever 81, which has been rotated clockwise (see FIG. 64).

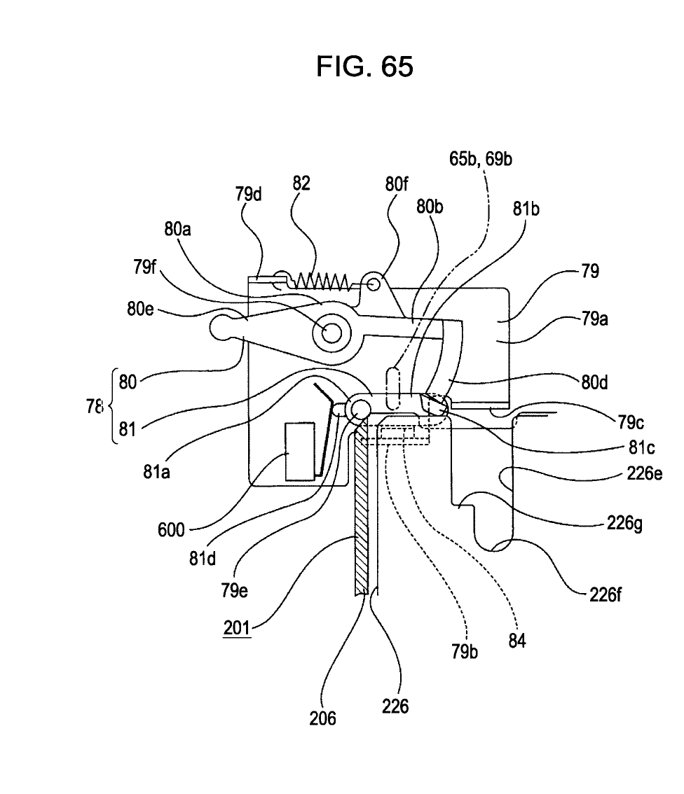

Then, when the swing lever 80 swings forward, the operation projection 81c of the transmission lever 81 is pushed by the pushing projection 80d of the swing lever 80, so that the back surface of the left edge portion of the disc tray 226 is pushed forward by the operation projection 81c and the disc tray 226 is pushed into the storage case 201 together with the disc-shaped recording medium 300 and the cover sheet 228 (see FIG. 65). At this time, the swing lever 80 receives a counterclockwise urging force applied by the limit spring 82, and the transmission lever 81 is prevented from receiving an excessive load from the transmission lever 81.

After the disc tray 226 and the other components are inserted into the storage case 201 and the swing lever 80 is rotated counterclockwise so that the pushing force applied to the operation projection 81c of the transmission lever 81 by the pushing projection 80d is eliminated, the transmission lever 81 is slightly rotated counterclockwise by the urging force applied by the return spring 84, and is retained at the standby position again (FIGS. 56 and 57).

When the operation projection 81c of the transmission lever 81 is pushed by the pushing projection 80d of the swing lever 80 as described above and the disc tray 226 and the other components are inserted into the storage case 201, the tray-storage detection switch 600 is operated by the operation projection 81d of the transmission lever 81 (see FIG. 64). Accordingly, the position of the disc tray 226 is detected and it is determined that the disc tray 226 has been inserted into the storage case 201. Conversely, when the transmission lever 81 is rotated counterclockwise from the standby position, the tray-storage detection switch 600 is released from the operation projection 81d of the transmission lever 81 and it is determined the disc tray 226 is not stored in the storage case 201.

As described above, in the disc changer 1, after the feed rollers 65, 65, . . . and 69, 69, . . . stop conveying the disc tray 226 and the other components, the disc tray 226 and the other components are inserted into the storage case 201 by the return lever unit 78 including the swing lever 80 and the transmission lever 81.

Thus, the return lever unit 78 assists the operation of conveying the disc tray 226 and the other components performed by the feed rollers 65, 65, . . . and 69, 69, . . . , and the disc tray 226, the disc-shaped recording medium 300, and the cover sheet 228 can be reliably inserted into the storage case 201.

In addition, after the feed rollers 65, 65, . . . and 69, 69, . . . stop conveying the disc tray 226 and the other components, the disc tray 226 receives the pushing force from the return lever unit 78 for only a short time period. Therefore, the load applied to the disc tray 226 can be minimized.

In addition, in the disc changer 1, in the state in which the disc tray 226 and the other components are stored in the storage case 201, the transmission lever 81 is moved away from the disc cartridge 200 by the return spring 84.

Therefore, in the operation of moving the cartridge holder 44 upward or downward after the disc tray 226 and the other components are inserted into the storage case 201, the transmission lever 81 is prevented from interfering with the cartridge holder 44. Therefore, the cartridge holder 44 can be smoothly moved upward or downward, and the cartridge holder 44 and the transmission lever 81 can be prevented from being damaged.

In addition, the disc changer 1 is provided with the tray-storage detection switch 600 which detects the position of the disc tray 226 with respect to the storage case 201 on the basis of the position of the transmission lever 81 in the rotational direction.

Therefore, it is not necessary to use a dedicated mechanism for detecting the position of the disc tray 226. As a result, the structure can be simplified and the manufacturing cost can be reduced.

### Removing Lever

A spring attachment member 85 is attached to the base chassis 1000 at the right side of the lever support member 79 (see FIG. 40).

Bottom end portions of removing levers 86 and 86 are attached to the lever attachment surface portion 79c of the lever support member 79 and the spring attachment member 85. The removing levers 86 and 86 extend in a substantially vertical direction and are composed of, for example, leaf springs made of a conductive metal material. The rigidity of each removing lever 86 is lower than that of each disc tray 226 and higher than that of each cover sheet 228. Therefore, the elasticity of each removing lever 86 is lower than that of each disc tray 226 and higher than that of each cover sheet 228.

### Disc Drive Mechanism

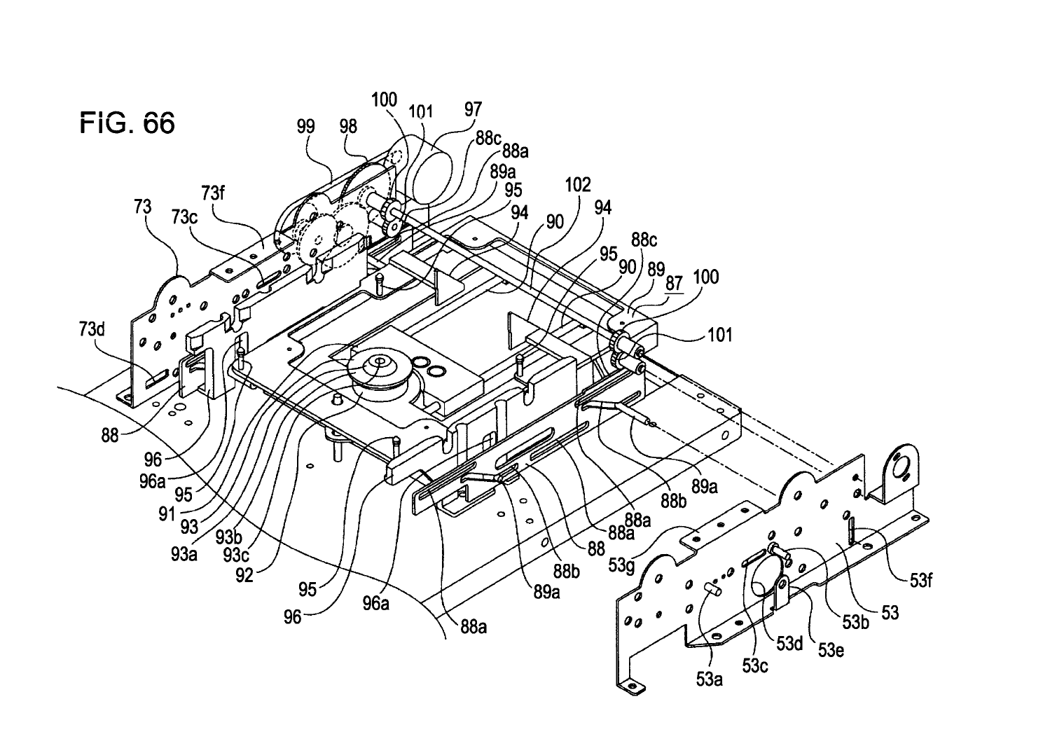

The disc drive block 4000 is disposed at the arrangement hole 1006 formed in the back half section of the base chassis 1000 (see FIG. 66). The disc drive block 4000 includes a disc drive mechanism 87 and a pair of elevation sliders 88 and 88.

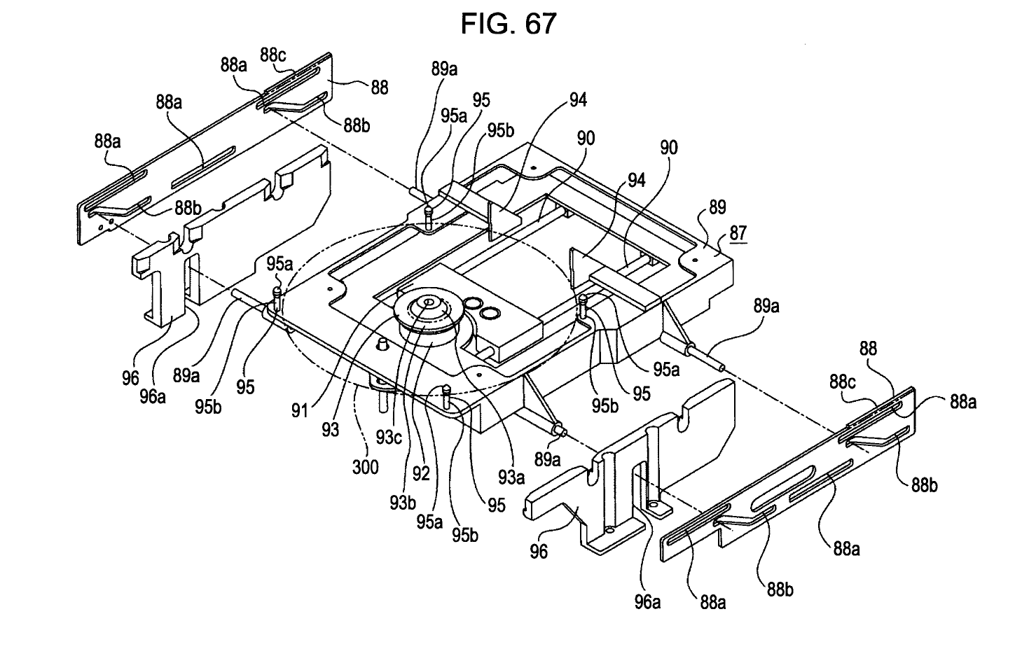

As shown in FIGS. 66 and 67, the disc drive mechanism 87 includes a traverse chassis 89; an optical pickup 91 supported by guides 90, which are provided on the traverse chassis 89, such that the optical pickup 91 is movable in the front-back direction (radial direction of the disc-shaped recording medium 300); a spindle motor 92 disposed at a position near the front end of the traverse chassis 89; and a disc table 93 rotated by the spindle motor 92.

The disc table 93 includes a table portion 93a and a centering projection 93b which projects upward from the table portion 93a at a central position thereof. A magnet is embedded in the centering projection 93b. An insertion recess 93c which opens upward is formed in the centering projection 93b at a central position thereof.

The traverse chassis 89 is provided with four guide shafts 89a, 89a, . . . which project to the side.

Positioning ribs 94 and 94 are provided on the top surface of the traverse chassis 89 at positions separated from each other in the left-right direction. The positioning ribs 94 and 94 are positioned behind the disc table 93, and have, for example, a rectangular shape.

Four positioning shafts 95, 95, . . . project upward from the top surface of the traverse chassis 89. The positioning shafts 95, 95, . . . are positioned in front of the positioning ribs 94 and 94, and are arranged radially around the center of the disc table 93 with a constant distance therefrom.

Each positioning shaft 95 has a large-diameter portion 95a, which has a larger diameter than that of the remaining portion, at the top end thereof, and the portion of the positioning shaft 95 other than the large-diameter portion 95a is formed as a small-diameter portion 95b.

The elevation sliders 88 and 88 are positioned at either side of the disc drive mechanism 87 in the left-right direction. Each elevation slider 88 extends substantially perpendicular to the left-right direction and includes guide holes 88a, 88a, and 88a which extend in the front-back direction and cam holes 88b and 88b including inclined portions.

A rack 88c is formed on the top surface of a back end portion of each elevation slider 88.

Guide pins (not shown) provided on the inner surfaces of the support plates 53 and 73 are engaged with the guide holes 88a formed in the elevation sliders 88 and 88 in a slidable manner, so that the elevation sliders 88 and 88 can move in the front-back direction with respect to the support plates 53 and 73.

### Chucking Motor

A chucking motor 97 is attached to a rear end portion of the support plate 73, which is attached to the base chassis 1000 at the left end thereof (see FIG. 66). A speed reduction mechanism 98, which includes a pulley gear and a plurality of two-speed gears, is supported on the left side surface of the support plate 73. The speed reduction mechanism 98 receives a driving force of the chucking motor 97 through a driving belt 99 stretched around the chucking motor 97 and the pulley gear.

Each of the support plates 53 and 73 is provided with a first gear 100 and a second gear 101 supported on the inner surface thereof. The first and second gears 100 and 101 mesh with each other in the vertical direction. The first gears 100 and 100 are connected to each other with a transmission shaft 102. The second gears 101 and 101 mesh with racks 88c and 88c provided on the respective elevation sliders 88 and 88. One of the first gears 100 is coaxially connected to one of the two-speed gears included in the speed reduction mechanism 98.

Therefore, when the driving force of the chucking motor 97 is transmitted to the speed reduction mechanism 98, the first gears 100 and 100 and the second gears 101 and 101 rotate in synchronization with each other and the racks 88c are moved in a direction corresponding to the rotational direction of the chucking motor 97. As a result, the elevation sliders 88 and 88 are moved in the front-back direction.

Positioning members 96 and 96 are attached to the base chassis 1000 at positions between the disc drive mechanism 87 and the elevation sliders 88 and 88. Each positioning member 96 is provided with a slit 96a which extends in the vertical direction.

In the disc drive mechanism 87, the guide shafts 89a, 89a, . . . are slidably inserted into the respective cam holes 88b, 88b, . . . formed in the elevation sliders 88 and 88, and three guide shafts 89a, 89a, and 89a are slidably inserted into the shaft guide holes 53f, 73e, and 73e in the support plates 53 and 73. At this time, the guide shafts 89a and 89a at the front are inserted through the slits 96a and 96a in the positioning members 96 and 96.

When the chucking motor 97 is rotated and the elevation sliders 88 and 88 are moved in the front-back direction as described above, the guide shafts 89a, 89a, . . . are guided by the cam holes 88b, 88b, . . . in the elevation sliders 88 and 88 and by the shaft guide holes 53f, 73e, and 73e in the support plates 53 and 73. Therefore, the disc drive mechanism 87 is moved in the vertical direction in accordance with the positions of the guide shafts 89a, 89a, . . . in the cam holes 88b, 88b, . . . .

### Disc-Holding Unit

A disc-holding unit 103 is disposed above the disc drive mechanism 87. The disc-holding unit 103 is attached to the attachment surface portions 53g and 73f of the support plates 53 and 73, respectively, at a position above the disc drive mechanism 87 (FIG. 32).

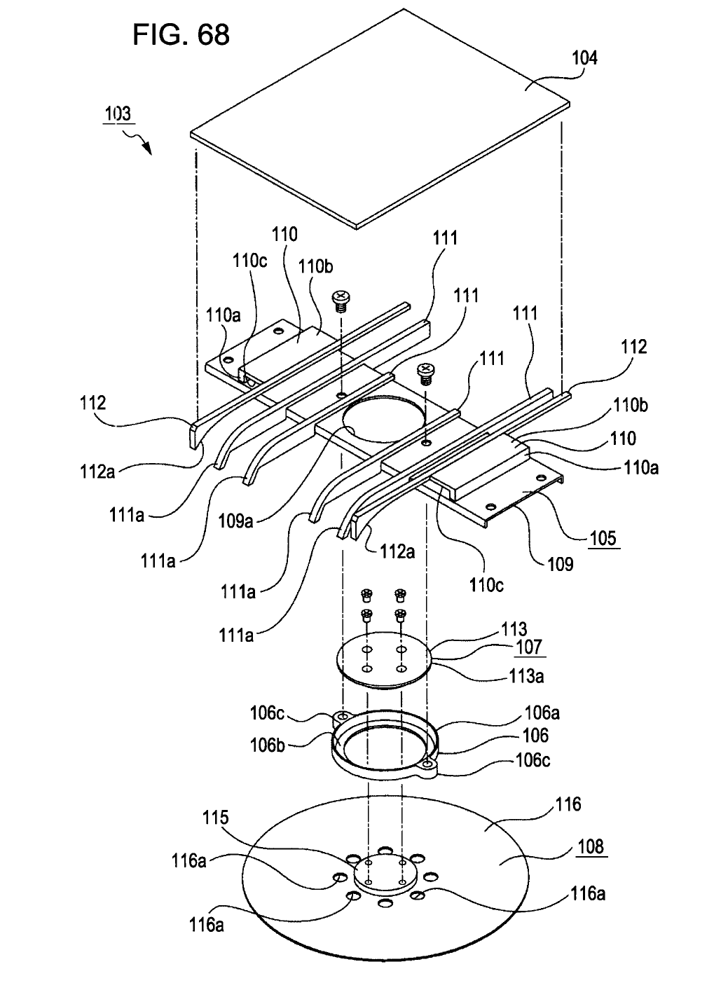

As shown in FIGS. 68 to 70, the disc-holding unit 103 includes a base plate 104, a holder body 105, a support ring 106, a support body 107, and a stabilizer 108.

The base plate 104 is made of, for example, a transparent, rectangular resin material.

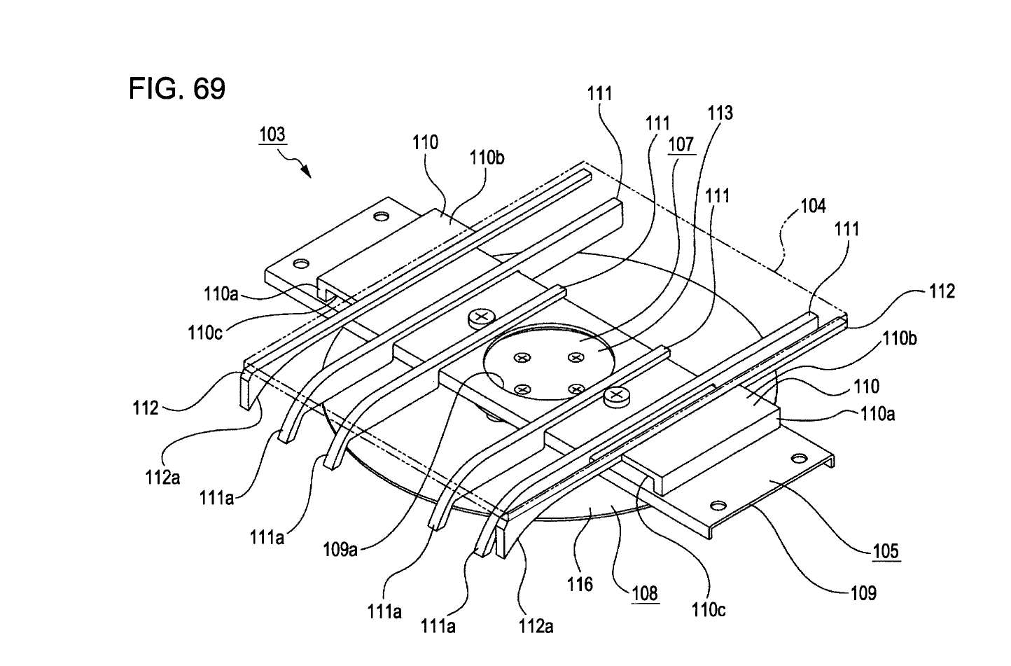

As shown in FIGS. 68 and 69, the holder body 105 includes an oblong rectangular attachment plate 109, attachment members 110 and 110 attached to the top surface of the attachment plate 109, first sheet guides 111, 111, . . . attached to the attachment plate 109, and second sheet guides 112 and 112 attached to the respective attachment members 110 and 110. The holder body 105 is made of, for example, a conductive metal material.

The attachment plate 109 is provided with a circular through hole 109a which vertically extends through the attachment plate 109 at a central position thereof.

The attachment members 110 and 110 respectively include vertical portions 110a and 110a which continuously project upward from the attachment plate 109 and horizontal portions 110b an 110b which project toward each other from the top ends of the vertical portions 110a and 110a. A certain gap 110c is provided between the horizontal portion 110b of each attachment member 110 and the attachment plate 109.

The first sheet guides 111, 111, . . . are spaced from each other in the left-right direction, and have an oblong shape which extends in the front-back direction. At least front portions of the first sheet guides 111, 111, . . . project forward from the attachment plate 109. Each first sheet guide 111 includes a front-end portion which functions as a guide portion 111a having an arc shape such that the top surface thereof is shifted downward toward the front end, and the top surface of a portion of the first sheet guide 111 other than the front-end portion is positioned above the top surface of the attachment plate 109.

The second sheet guides 112 and 112 are attached to the surfaces of the horizontal portions 110b and 110b of the attachment members 110 and 110 which face each other. Each second sheet guide 112 has an oblong shape which extends in the front-back direction. A front end portion of each second sheet guide 112 functions as a guide portion 112a, and the bottom surface of the guide portion 112a is formed in a gentle arc shape. The bottom surface of the guide portion 112a of each second sheet guide 112 is positioned higher than the top surface of the guide portion 111a of each first sheet guide 111.

The holder body 105 is attached to the base plate 104 such that the top surfaces of the first sheet guides 111, 111, . . . and the top surfaces of the second sheet guides 112 and 112 are in contact with the bottom surface of the base plate 104.

The support ring 106 is made of, for example, a conductive metal material. The support ring 106 includes a ring portion 106a, a flange portion 106b which protrudes inward from the bottom edge of the ring portion 106a, and attachment projections 106c and 106c which are provided on the outer peripheral surface of the ring portion 106a. The ring portion 106a, the flange portion 106b, and the attachment projections 106c and 106c are formed integrally with each other. The attachment projections 106c and 106c project outward from the ring portion 106a at opposite positions thereof.

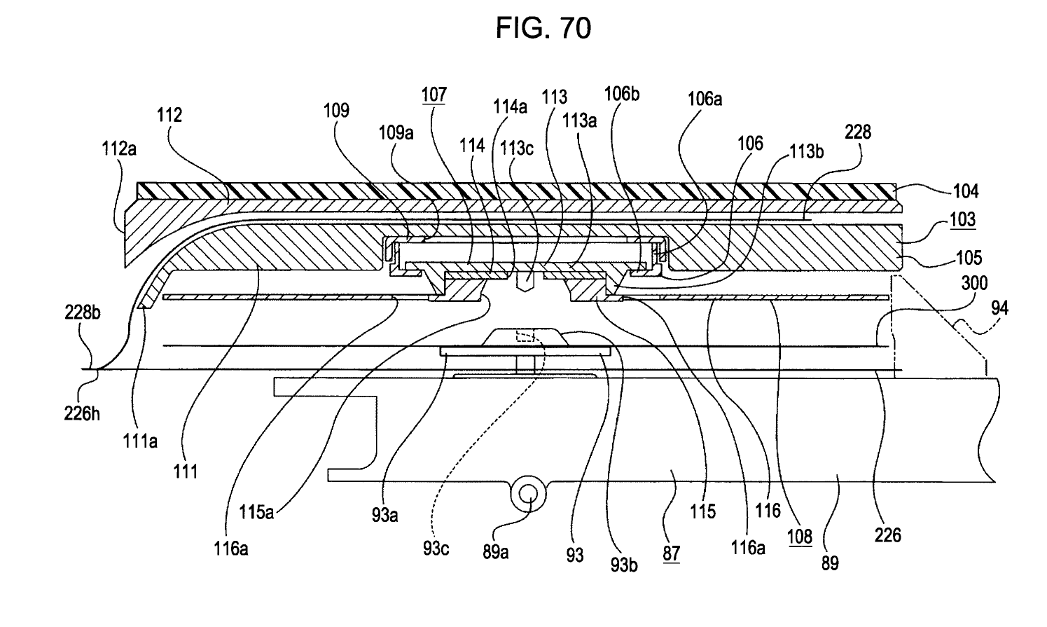

As shown in FIG. 70, the support body 107 includes a plate 113 made of, for example, a conductive metal material and an annular magnet 114 attached to the bottom surface of the plate 113. The plate 113 includes a circular plate portion 113a, an annular holder projection 113b which projects downward from the circular plate portion 113a at a position near the outer periphery thereof, and a positioning pin 113c which projects downward from the circular plate portion 113a at a central position thereof.

The magnet 114 is attached to the bottom surface of the circular plate portion 113a in a space surrounded by the holder projection 113b. A projection through hole 114a which allows the positioning pin 113c to project downward therethrough is formed in the magnet 114 at a central position thereof.

The stabilizer 108 is formed of, for example, a conductive metal material. As shown in FIGS. 68 and 70, the stabilizer 108 includes a core portion 115 disposed at a central position and a thin, disc-shaped adhesion portion 116 which extends outward from the bottom end of the core portion 115. The core portion 115 and the adhesion portion 116 are formed integrally with each other.

The core portion 115 is provided with a projection insertion hole 115a which extends through the core portion 115 in the vertical direction at a central position thereof. The bottom surface of the core portion 115 is positioned slightly below the bottom surface of the adhesion portion 116.

A plurality of holes 116a, 116a, . . . are formed in an inner peripheral section of the adhesion portion 116 such that the holes 116a, 116a, . . . are spaced from each other in the circumferential direction.

The stabilizer 108 is fixed to the support body 107 by means of screws or the like with the support ring 106 disposed between the stabilizer 108 and the support body 107. In the state in which the stabilizer 108 is fixed to the support body 107, the core portion 115 is inserted into the space surrounded by the holder projection 113b and the top surface of the core portion 115 is in contact with the bottom surface of the magnet 114 (see FIG. 70). In the state in which the stabilizer 108 is fixed to the support body 107, the positioning pin 113c, which projects downward through the projection through hole 114a in the magnet 114, of the support body 107 is disposed in the projection insertion hole 115a formed in the core portion 115 of the stabilizer 108.

A predetermined gap is provided between the inner peripheral section of the adhesion portion 116 of the stabilizer 108 and an outer peripheral section of the circular plate portion 113a of the support body 107, and the flange portion 106b of the support ring 106 is positioned in that gap.

Therefore, the support body 107 and the stabilizer 108 are movable in the vertical direction within a range corresponding to the gap provided between the inner peripheral section of the adhesion portion 116 and the outer peripheral section of the circular plate portion 113a.

In the disc-holding unit 103, while the disc table 93 is not yet attached to the stabilizer 108, the outer peripheral section of the circular plate portion 113a of the plate 113 is in contact with the flange portion 106b of the support ring 106 in the vertical direction (see FIG. 70).

### Backward Conveyance Operation

The operation of each component performed when the disc-loading block 5000 conveys the selected disc tray 226 and the disc-shaped recording medium 300 backward together with the cover sheet 228 will now be described.

When the disc cartridge 200 is inserted into the disc changer 1 through the opening 3a formed in the front panel 3, the opening-closing lid 203 is unlocked by a lid-unlocking mechanism (not shown) provided in the cartridge-holding block 3000. Accordingly, the opening-closing lid 203 is pivoted to open the opening 202a in the main body 202. At this time, the disc cartridge 200 is locked to the cartridge holder 44 by a cartridge-locking mechanism (not shown).

When the tab 227 on the disc tray 226 is pushed by the operation pin 23 and the disc tray 226, the disc-shaped recording medium 300, and the cover sheet 228 are pushed backward through the opening 202a, the disc tray 226 and the other components are conveyed backward by the feed rollers 65, 65, . . . and 69, 69, . . . as described above.

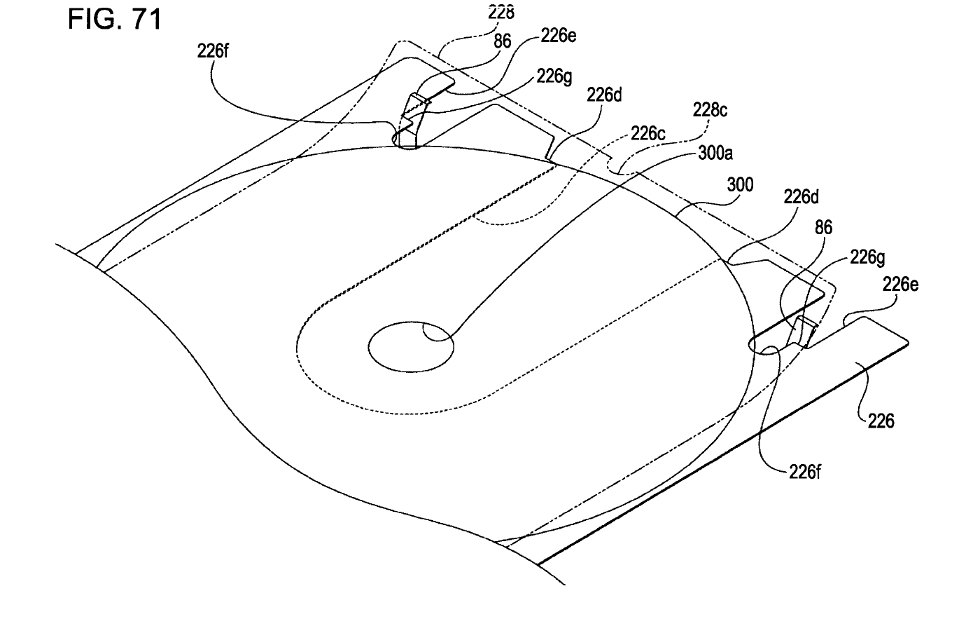

When the disc tray 226, the disc-shaped recording medium 300, and the cover sheet 228 are conveyed backward, the removing levers 86 and 86 positioned behind the storage case 201 are respectively inserted into the insertion notches 226e and 226e formed in the disc tray 226 (see FIG. 71).

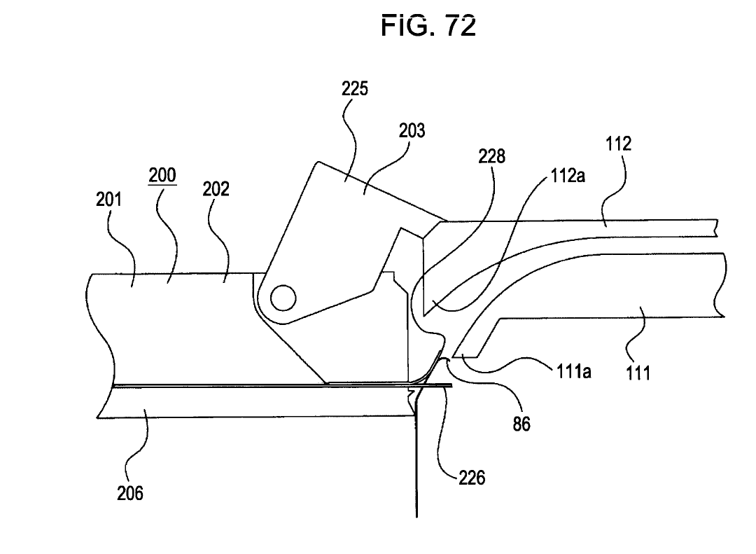

When the removing levers 86 and 86 are respectively inserted into the insertion notches 226e and 226e formed in the disc tray 226, the back edge portion of the cover sheet 228 is bent upward by the removing levers 86 and 86 and are separated from the disc tray 226 (see FIGS. 71 and 72). At this time, the back edge portion of the cover sheet 228 is inserted into a space between the first sheet guides 111, 111, . . . and the second sheet guides 112 and 112 of the disc holding unit 103 by being guided by the removing levers 86 and 86.

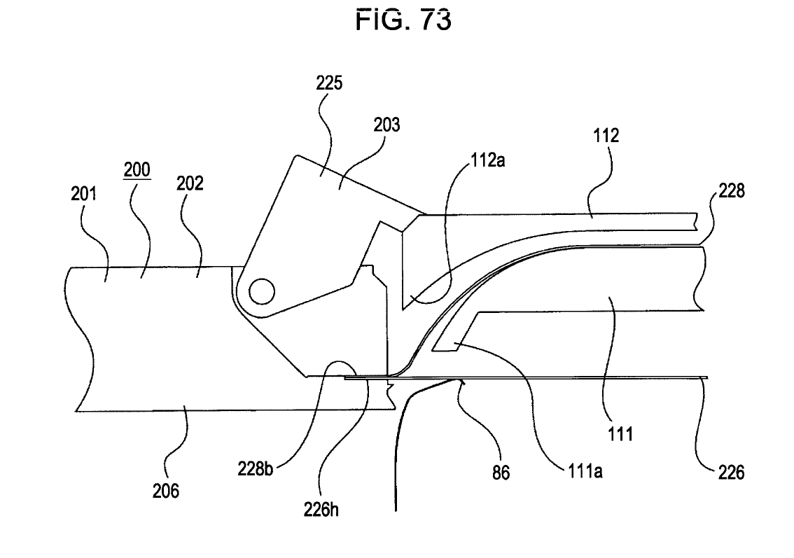

When the disc tray 226 and the other components are further conveyed backward, the removing levers 86 and 86 are respectively pushed by the operation edges 226g and 226g of the disc tray 226 and are elastically deformed such that the removing levers 86 and 86 slide along the bottom surface of the disc tray 226 (see FIG. 73). At this time, the cover sheet 228 is further inserted into the space between the first sheet guides 111, 111, . . . and the second sheet guides 112 and 112.

As described above, in the disc changer 1, the removing levers 86 and 86 are provided for removing the cover sheet 228 from the disc tray 226, and are caused to slide along the bottom surface of the disc tray 226.

Therefore, the cover sheet 228 can be removed from the disc tray 226 without damaging the disc-shaped recording medium 300 with the removing levers 86 and 86.

In addition, since the removing levers 86 and 86 are provided, the cover sheet 228 can be reliably removed from the disc tray 226.

Then, when the disc tray 226 and the other components are further conveyed backward, the removing levers 86 and 86 are elastically deformed such that the removing levers 86 and 86 slide along the bottom surface of the disc tray 226.

Therefore, it is not necessary to provide a dedicated driving force for removing the cover sheet 228 from the disc tray 226 or a dedicated driving force for causing the removing levers 86 to slide along the bottom surface of the disc tray 226. As a result, the structure can be simplified and the manufacturing cost can be reduced.

In addition, since the removing levers 86 and 86 are made of a conductive material, static electricity with which the cover sheet 228 and the disc tray 226 are charged can be discharged through the removing levers 86 and 86 when the removing levers 86 and 86 slide along the cover sheet 228 and the disc tray 226.

Thus, the cover sheet 228 and the disc tray 226 can be prevented from being charged.

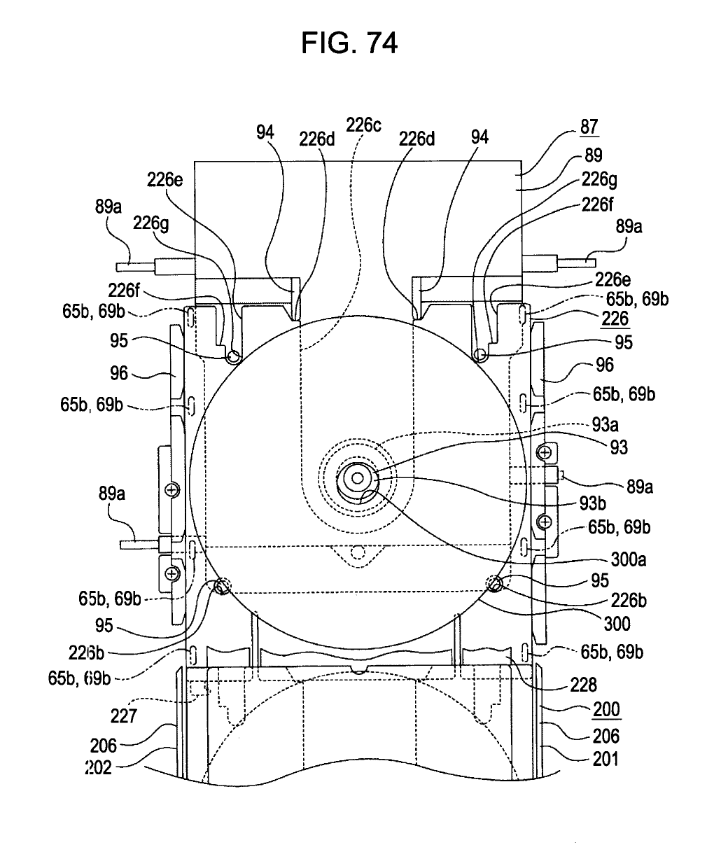

Then, when the disc tray 226 and the other components are further conveyed backward, the left and right edge portions of the cover sheet 228 are inserted into the gaps 110c and 110c between the attachment plate 109 and the attachment members 110 and 110 in the disc-holding unit 103. At this time, the disc tray 226, which is being conveyed backward, is positioned in the left-right direction by the positioning members 96 and 96 (see FIG. 74).

When the disc tray 226 and the other components are conveyed backward as described above and the positioning edges 226d and 226d of the disc tray 226 come into contact with the positioning ribs 94 and 94 of the disc drive mechanism 87, the rotation of the loading motor 58 is stopped. Thus, the operation of conveying the disc-shaped recording medium 300 to the recording-reproducing position is ended (FIG. 74). In the state in which the operation of conveying the disc tray 226 and the other components is ended, the cover sheet 228 is placed on the first sheet guides 111, 111, . . . at a position where the cover sheet 228 is separated upward from the disc-shaped recording medium 300 (see FIG. 73).

In the state in which the disc-shaped recording medium 300 is conveyed to the recording-reproducing position, the bonding portion 226h of the disc tray 226 and the bonding portion 228b of the cover sheet 228 are positioned in the storage case 201 and do not project backward from the opening 202a of the storage case 201. Therefore, the left side surface of the disc tray 226 is in contact with the operation projection 81c of the transmission lever 81, and the transmission lever 81 is retained at the non-operating position.

### Operation of Disc Drive Mechanism

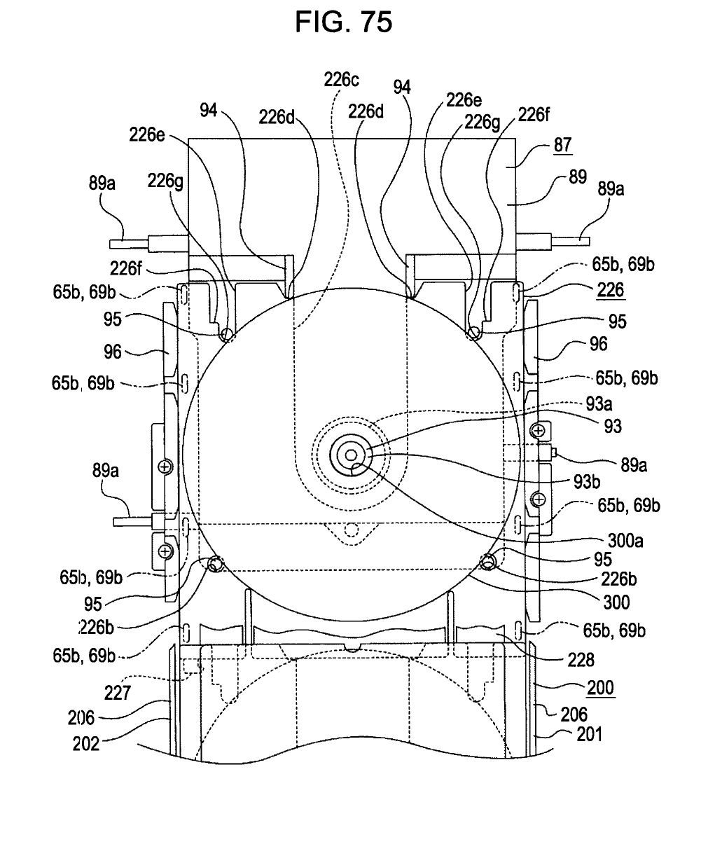

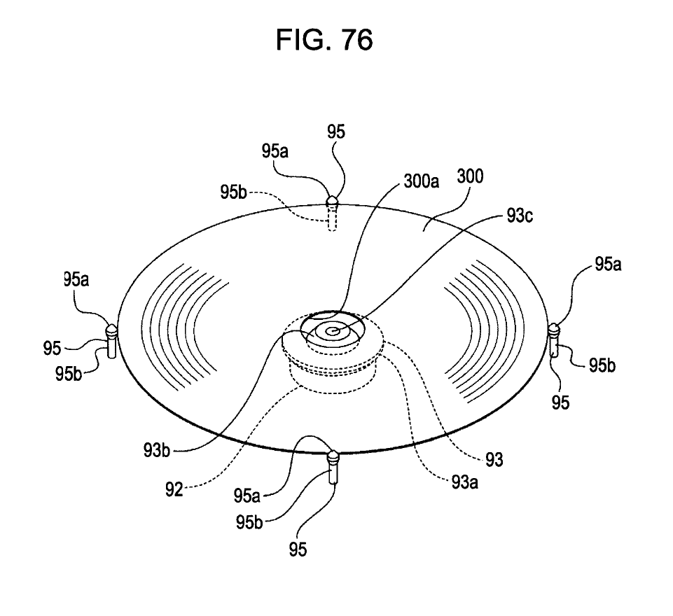

When the operation of conveying the disc tray 226 and the other components is ended, the chucking motor 97 is rotated and the disc drive mechanism 87 is moved upward. When the disc drive mechanism 87 is moved upward, the large-diameter portions 95a, 95a, . . . of the positioning shafts 95, 95, . . . slide along the outer peripheral edge of the disc-shaped recording medium 300 to position the disc-shaped recording medium 300 (see FIGS. 75 and 76).

As described above, the disc changer 1 is provided with the positioning shafts 95, 95, . . . which position the disc-shaped recording medium 300 in response to the upward movement of the disc drive mechanism 87. The disc-shaped recording medium 300 is positioned when the disc drive mechanism 87 is moved upward, so that the centering projection 93b of the disc table 93 can be reliably inserted into a center hole 300a formed in the disc-shaped recording medium 300.

When the disc drive mechanism 87 is moved further upward, the small-diameter portions 95b, 95b, . . . of the positioning shafts 95, 95, . . . are moved to positions where the small-diameter portions 95b, 95b, . . . face the outer peripheral surface of the disc-shaped recording medium 300 with gaps therebetween, and the centering projection 93b of the disc table 93 is inserted into the center hole 300a in the disc-shaped recording medium 300 from below.

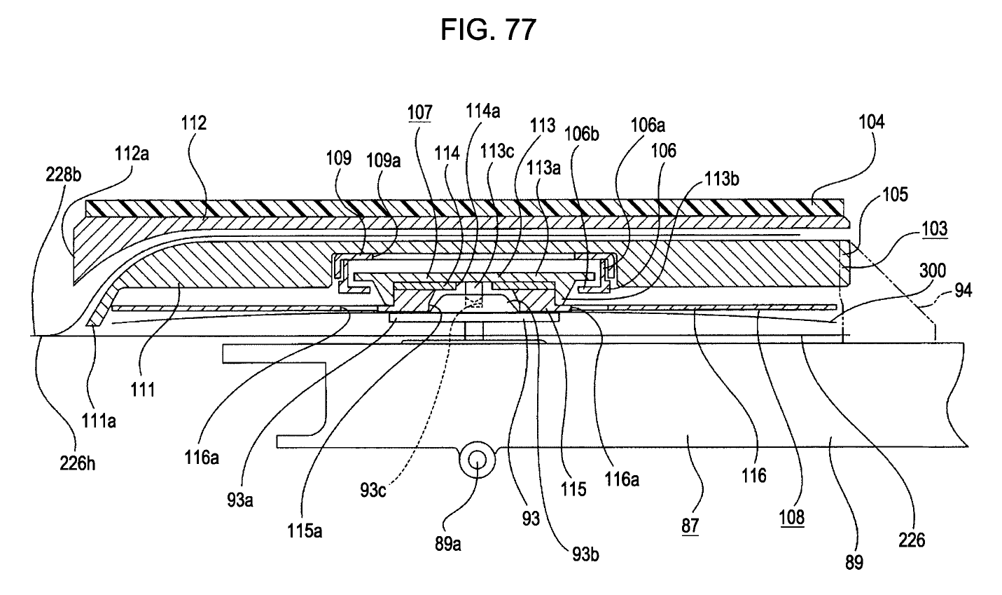

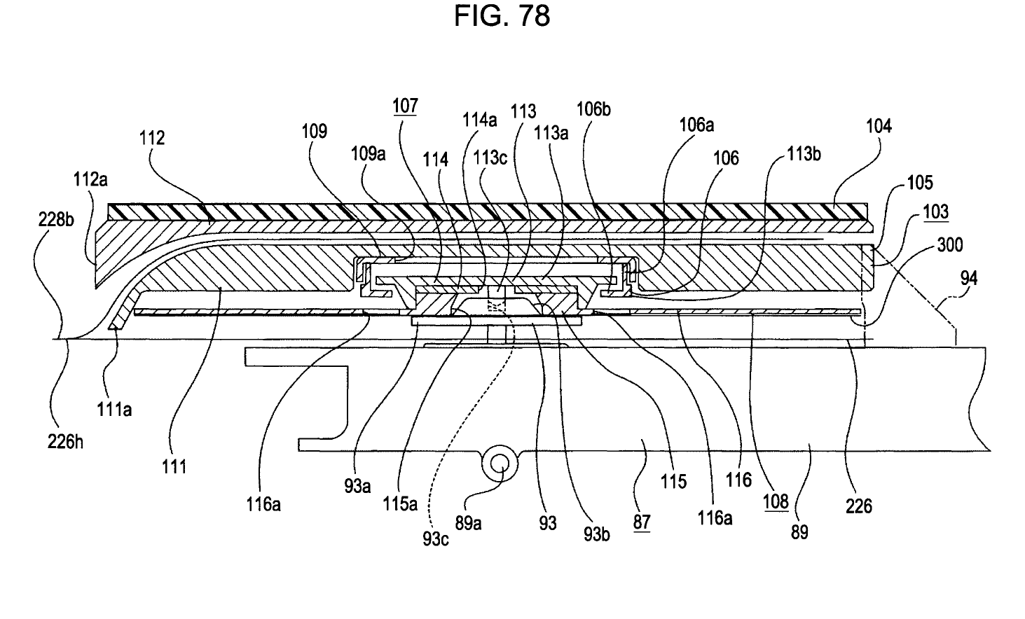

When the disc drive mechanism 87 is moved further upward, the disc-shaped recording medium 300 is lifted by the table portion 93a of the disc table 93 and the centering projection 93b is inserted into the projection insertion hole 115a formed in the core portion 115 of the stabilizer 108 from below (FIG. 77). At this time, the disc-shaped recording medium 300 is separated from the positioning ribs 94 and 94.

When the centering projection 93b is inserted into the projection insertion hole 115a, the magnet embedded in the centering projection 93b becomes attracted to the magnet 114 included in the support body 107. As a result, the disc table 93 is fixed to the support body 107. An inner peripheral portion of the disc-shaped recording medium 300 is chucked between the table portion 93a of the disc table 93 and the core portion 115 of the stabilizer 108, so that the disc-shaped recording medium 300 can be rotated by the rotation of the disc table 93. Then, the rotation of the chucking motor 97 is stopped, so that the upward movement of the disc drive mechanism 87 is stopped.

In the state in which the inner peripheral portion of the disc-shaped recording medium 300 is chucked between the table portion 93a and the core portion 115, an outer peripheral surface of the disc-shaped recording medium 300 is not in contact with any of the positioning shafts 95, 95, . . . , and the positioning ribs 94 and 94. In this state, the disc table 93 and the core portion 115 of the stabilizer 108 are not in contact with the support body 107, and are smoothly rotatable. In addition, since the disc-shaped recording medium 300 is made of a sheet-shaped material having a low rigidity, a portion of the disc-shaped recording medium 300 other than the inner peripheral section thereof is in a bent state.

When the disc table 93 is rotated together with the stabilizer 108 by the spindle motor 92, the disc-shaped recording medium 300 is also rotated by the rotation of the disc table 93 and the stabilizer 108. When the stabilizer 108 is rotated, convection toward the lower side of the adhesion portion 116 through the holes 116a, 116a, . . . formed in the adhesion portion 116 is generated, so that the disc-shaped recording medium 300, which has been bent, is rotated while adhering to the adhesion portion 116 (see FIG. 78). At this time, a small gap is provide between the bottom surface of the adhesion portion 116 and the top surface of the disc-shaped recording medium 300, and the disc-shaped recording medium 300 is rotated while the small gap is being provided.

While the disc-shaped recording medium 300 is being rotated, the optical pickup 91 is driven such that information signals are recorded on the disc-shaped recording medium 300 or reproduced from the disc-shaped recording medium 300.

As described above, in the disc changer 1, after the disc-shaped recording medium 300 is positioned by the large-diameter portion 95a, 95a, . . . of the positioning shafts 95, 95, . . . , the positioning shafts 95, 95, . . . are separated from the outer peripheral surface of the disc-shaped recording medium 300. Therefore, the disc-shaped recording medium 300 can be smoothly rotated.

In addition, the operation of positioning the disc-shaped recording medium 300 with the positioning shafts 95, 95, . . . and removing the positioning shafts 95, 95, . . . from the outer peripheral surface of the disc-shaped recording medium 300 are performed in response to the upward movement of the disc drive mechanism 87. Therefore, the mechanism and the operation can be simplified.

As described above, the disc changer 1 is provided with the first sheet guides 111, 111, . . . and the second sheet guides 112 and 112 for guiding the cover sheet 228 to a position where the cover sheet 228 is separated from the disc-shaped recording medium 300.

Therefore, the disc-shaped recording medium 300 can be smoothly rotated.

In addition, since the first sheet guides 111, 111, . . . are mace of a conductive material, static electricity with which the cover sheet 228 is charged can be discharged through the first sheet guides 111, 111, . . . . Thus, the cover sheet 228 can be prevented from being charged.

When the operation of recording the information signals on the disc-shaped recording medium 300 or reading the information signals from the disc-shaped recording medium 300 is ended, the disc-shaped recording medium 300 is placed on the disc tray 226 again by performing an operation reversed from the above-described operation.

More specifically, the rotation of the disc table 93 and the stabilizer 108 is stopped, and the chucking motor 97 is rotated in a direction opposite to that in the above-described operation, so that the disc drive mechanism 87 is moved downward. Accordingly, the disc table 93 is moved downward away from the support body 107, and is moved further downward away from the center hole 300a of the disc-shaped recording medium 300. As a result, the disc-shaped recording medium 300 is placed on the disc tray 226.

When the disc drive mechanism 87 is moved further downward, the outer peripheral section of the circular plate portion 113a of the plate 113 comes into contact with the flange portion 106b of the support ring 106 again (see FIG. 70).

Therefore, since the stabilizer 108 and the holder body 105 are made of a conductive material as described above, static electricity with which the disc-shaped recording medium 300 is charged can be discharged through the stabilizer 108 and the holder body 105. Thus, the disc-shaped recording medium 300 can be prevented from being charged.

### Forward Conveyance Operation

After the disc-shaped recording medium 300 is placed on the disc tray 226, the loading motor 58 is rotated in a direction opposite to that in the above-described operation, so that the disc tray 226, the disc-shaped recording medium 300, and the cover sheet 228 are conveyed forward by the feed rollers 65, 65, . . . and 69, 69, . . . . When the feed rollers 65, 65 . . . and 69, 69, . . . stop conveying the disc tray 226 and the other components forward, the disc tray 226 is pushed forward by the return lever unit 78 as described above, so that the disc tray 226, the disc-shaped recording medium 300, and the cover sheet 228 are stored in the storage case 201 again. At this time, since the bonding portion 226h and the bonding portion 228b of the disc tray 226 and the cover sheet 228, respectively, are bonded together, the disc tray 226 and the cover sheet 228 can be prevented from being displaced from each other, and the disc tray 226 and the other components can be stored in the storage case 201 in such a state that the disc-shaped recording medium 300 is covered by the cover sheet 228.

Thus, since the bonding portion 226h of the disc tray 226 and the bonding portion 228b of the cover sheet 228 are bonded together, the disc tray 226 and the cover sheet 228 can be prevented from being displaced from each other even after the cover sheet 228 is removed from the disc tray 226. Therefore, the adequate positional relationship between the disc tray 226 and the cover sheet 228 can be maintained and the disc-shaped recording medium 300 can be covered by the cover sheet 228 at an adequate position.

In addition, since the he bonding portion 226h and the bonding portion 228b of the disc tray 226 and the cover sheet 228, respectively, are bonded together, the disc-shaped recording medium 300 can be reliably conveyed forward together with the disc tray 226 and the cover sheet 228 in the forward conveyance operation.

As described above, in the disc changer 1, the tab 227 of the disc tray 226 is pushed so that the disc tray 226 projects from the storage case 201, and the disc tray 226 and the other components are conveyed by the feed rollers 65, 65, . . . and 69, 69, . . . .

The disc tray 226 and the other components are conveyed by a simple operation of causing the disc tray 226 and the other components to project from the storage case 201 and by a simple mechanism including the feed rollers 65, 65, . . . and 69, 69, . . . . Thus, the disc tray 226 and the other components can be reliably conveyed by a simple mechanism and a simple operation.

In particular, in the case where the disc tray 226 and the other components which are to be conveyed are sheet-shaped, the disc tray 226 has no projection. Therefore, an optimum conveyance operation can be performed by using the feed rollers 65, 65, . . . and 69, 69, . . . as conveying means.

The disc trays 226, 226, . . . are made of a sheet-shaped elastic material, and are stored in the storage case 201 such that the disc trays 226, 226, . . . are inserted into retaining grooves 206a, 206a, . . . formed in the side surface sections 206 and 206.

Since the disc trays 226, 226, . . . are inserted in the retaining grooves 206a, 206a, . . . the edge portions of the disc trays 226, 226, . . . disposed next to each other can be prevented from coming into contact with each other and are separated from each other by a constant interval. Thus, the disc trays 226, 226, . . . can be stored in the storage case 201 in a state such that the disc trays 226, 226, . . . can be elastically deformed, and the number of disc-shaped recording media 300, 300, . . . which can be stored in the storage case 201 can be increased.

In addition, since the disc trays 226, 226, . . . are elastically deformable, the risk that the disc-shaped recording media 300, 300, . . . will be damaged or scratched can be reduced.

In addition, since at least a central portion of each disc-shaped recording medium 300 is covered by the cover sheet 228, the risk that the disc-shaped recording medium 300 will be damaged or scratched can be reduced.

In addition, since each disc-shaped recording medium 300 is covered by the cover sheet 228 and each disc tray 226 is made of an elastic material, the disc-shaped recording medium 300 can be prevented from being damaged or scratched even when the cover sheet 228 and the disc tray 226 come into contact with the disc-shaped recording medium 300.

Since the contact between the cover sheet 228 and the disc tray 226 is allowable, the gap between the cover sheet 228 and the disc tray 226, which face each other in the thickness direction, can be reduced. Therefore, the number of disc-shaped recording media 300, 300, . . . which can be stored in the disc cartridge 200 can be increased without increasing the size of the disc cartridge 200.

### Address Selection

In the disc changer 1, an address number for selecting the disc tray 226 at the top in the storage case 201 is defined as address number 1, and an address number for selecting the disc tray 226 at the bottom in the storage case 201 is defined as address number 20. Therefore, in an operation of selecting one disc tray 226, the cartridge holder 44 moves in the vertical direction between the position corresponding to address number 1 and the position corresponding to address number 20. In addition, an address number of the position at which the disc cartridge 200 is inserted or extracted through the opening 3a in the front panel 3 is defined as address number 0. The position corresponding to address number 0 is higher than the position corresponding to address number 1. Therefore, when the disc cartridge 200 is inserted or extracted through the opening 3a, the cartridge holder 44 is also moved in the vertical direction between the position corresponding to address number 0 and the position corresponding to address number 1.

### Mechanism Regarding Disc Cartridge

When the disc cartridge 200 is inserted through the opening 3a, the opening-closing lid 203 is unlocked by the lid-unlocking mechanism and the opening-closing lid 203 is pivoted to open the opening 202a in the main body 202. At this time, the disc cartridge 200 is locked to the cartridge holder 44 by the cartridge-locking mechanism.

When the cartridge holder 44 is moved upward to the position corresponding to address number 0 while the disc cartridge 200 is stored in the cartridge holder 44, the state in which the disc cartridge 200 is locked to the cartridge holder 44 by the cartridge-locking mechanism is canceled. In addition, the opening-closing lid 203 is pivoted and is locked to the main body 202 such that the opening 202a is closed by the opening-closing lid 203. When the state in which the disc cartridge 200 is locked to the cartridge holder 44 by the cartridge-locking mechanism is canceled, a part of the disc cartridge 200 automatically projects from the opening 3a of the front panel 3.

### Operations of Disc Changer

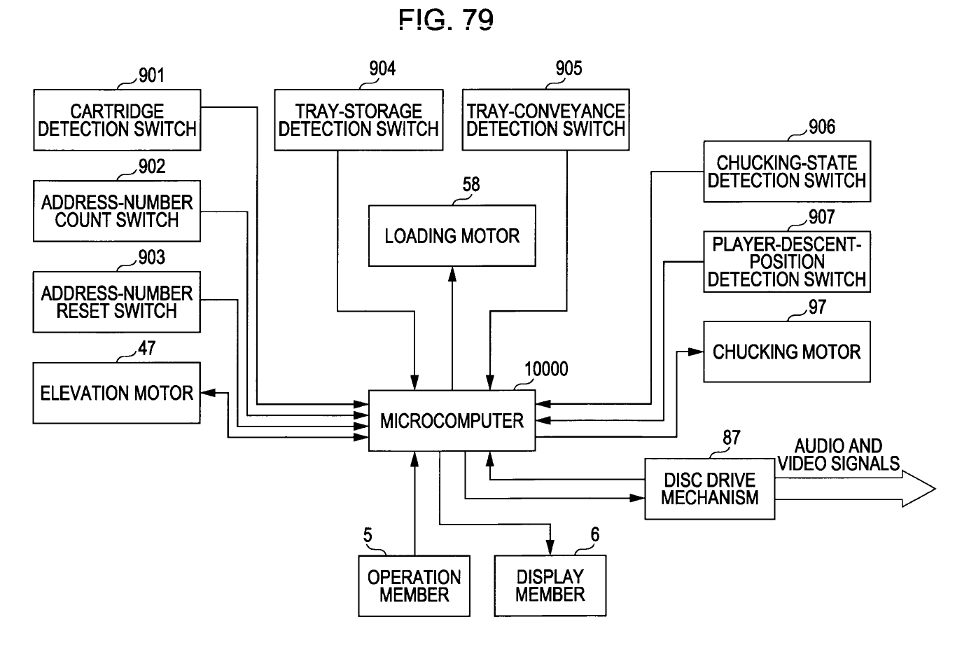

Operations performed by the disc changer 1 will now be described with reference to the flowcharts shown in FIGS. 79 to 84.

In the following description, “ON” shows the state in which an operation is detected, and “OFF” shows a standby state.

As shown in FIG. 79, the disc changer 1 includes a cartridge detection switch 901, an address-number count switch 902, an address-number reset switch 903, a tray-storage detection switch 904, a tray-conveyance detection switch 905, a chucking-state detection switch 906, and a player-descent-position detection switch 907.

The cartridge detection switch 901 detects an insertion state in which the disc cartridge 200 is inserted into the cartridge holder 44.

The address-number count switch 902 counts the address number for selecting one of the disc trays 226, 226, . . . and the address-number reset switch 903 resets the address number for selecting one of the disc trays 226, 226, . . . . The address-number count switch 902 corresponds to the above-described elevation position detection switch 500.

The tray-storage detection switch 904 detects the state in which each disc tray 226 is stored in the storage case 201, and the tray-conveyance detection switch 905 detects the state in which each disc tray 226 has been conveyed to the recording-reproducing position. The tray-storage detection switch 904 corresponds to the above-described tray-storage detection switch 600.

The chucking-state detection switch 906 detects the state in which each disc-shaped recording medium 300 is being chucked. The player-descent-position detection switch 907 detects a position of the disc drive mechanism 87 when the disc drive mechanism 87 is moved downward.

The disc changer 1 also includes a microcomputer 10000 which controls the above-described switches 901 to 907, the elevation motor 47, the loading motor 58, the chucking motor 97, the disc drive mechanism 87, and each display member 6. The microcomputer 10000 controls each component in response to signals input through the operation members 5, 5, . . . .

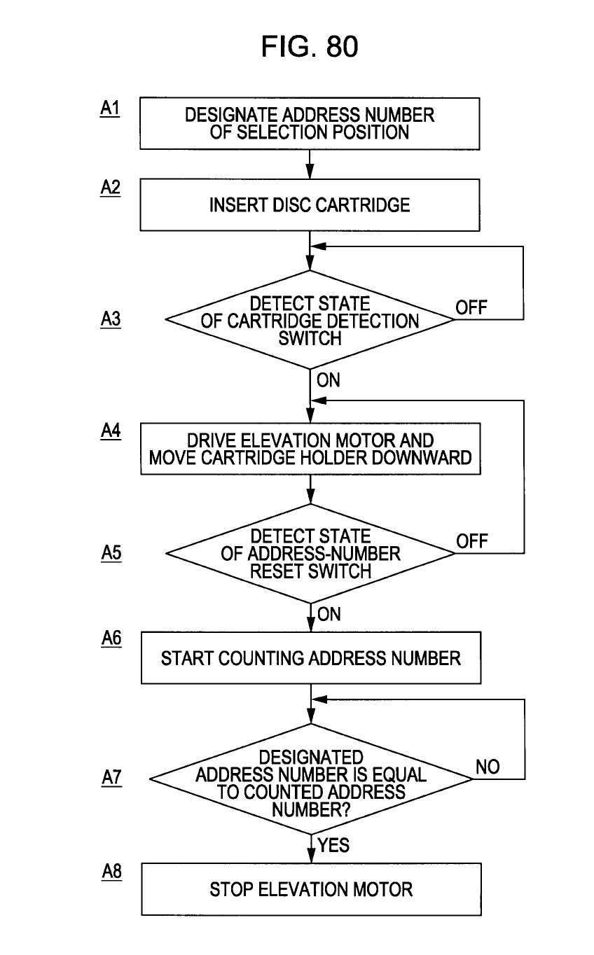

First, an operation from when the disc cartridge 200 is inserted into the cartridge holder 44 to when one of the disc-shaped recording media 300, 300, . . . is selected will be described with reference to FIG. 80.

When the disc cartridge 200 is not yet inserted through the opening 3a formed in the front panel 3, the cartridge holder 44 is held at an uppermost position.

When a user operates the operation members 5, 5, . . . to turn on the power, the microcomputer 10000 starts a detection operation based on the cartridge detection switch 901 and the operation members 5, 5, . . . .

(A1) The user operates the operation members 5, 5, . . . to designate an address number corresponding to a selection position of the selected disc tray 226.

(A2) The user inserts the disc cartridge 200 into the opening 3a.

(A3) The state of the cartridge detection switch 901 is detected. The cartridge detection switch 901 is in the ON state if the insertion of the disc cartridge 200 into the cartridge holder 44 is detected, and is in the OFF state if the insertion of the disc cartridge 200 into the cartridge holder 44 is not detected. If the cartridge detection switch 901 is in the ON state, the process proceeds to (A4). If the cartridge detection switch 901 is in the OFF state, the detection process performed in (A3) is repeated.

(A4) The elevation motor 47 is driven such that the cartridge holder 44 is moved downward.

(A5) The state of the address-number reset switch 903 is detected. The address-number reset switch 903 is in the ON state if the counted address number is 0, and is in the OFF state if the counted address number is not 0. If the address-number reset switch 903 is in the ON state, the process proceeds to (A6). If the address-number reset switch 903 is in the OFF state, the process returns to (A4).

(A5) A counting process using the address-number count switch 902 is started. When the address-number count switch 902 is turned ON the next time, the address number is set to 1. Then, the number of times the address-number count switch 902 is turned ON is counted from 1, and the thus-counted address number is stored in an address number counter.

(A7) It is detected whether or not the address number designated through the operation members 5, 5, . . . in (A1) is equal to the address number counted by the address number counter. If the result of the determination is YES, the process proceeds to (A8). If the result of the determination is NO, the process returns to (A7).

(A8) The elevation motor 47 is stopped.

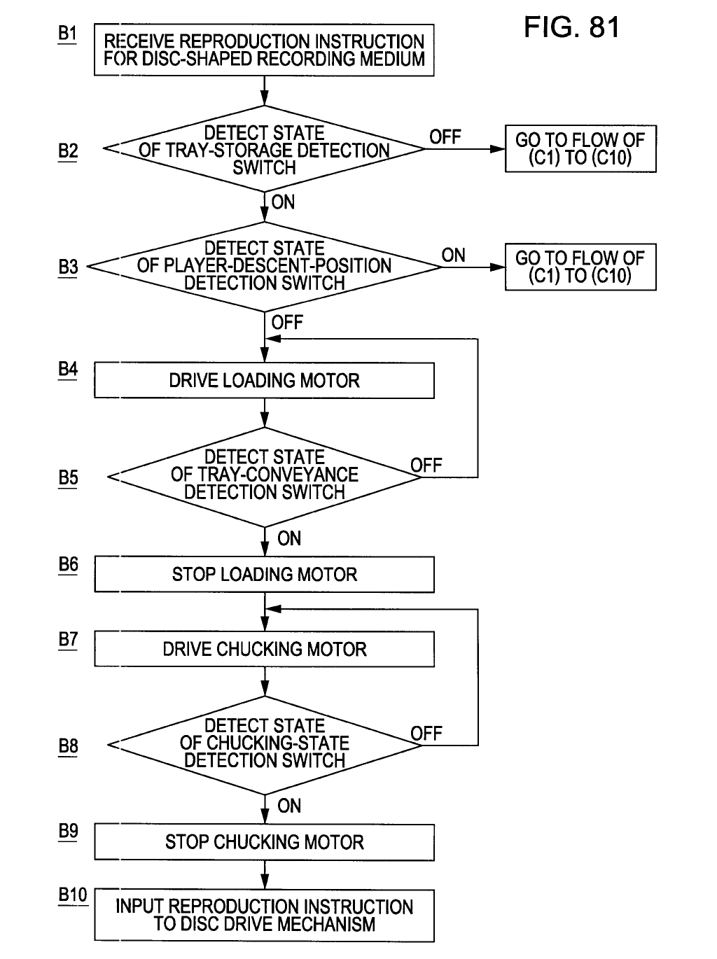

Next, a reproducing operation for the disc-shaped recording medium 300 stored in the disc cartridge 200 at a position corresponding to the address number designated by the user will be described with reference to FIG. 81.

(B1) An instruction to perform a reproducing operation for the disc-shaped recording medium 300 at the position corresponding to the address number designated through the operation members 5, 5, . . . by the user is input.

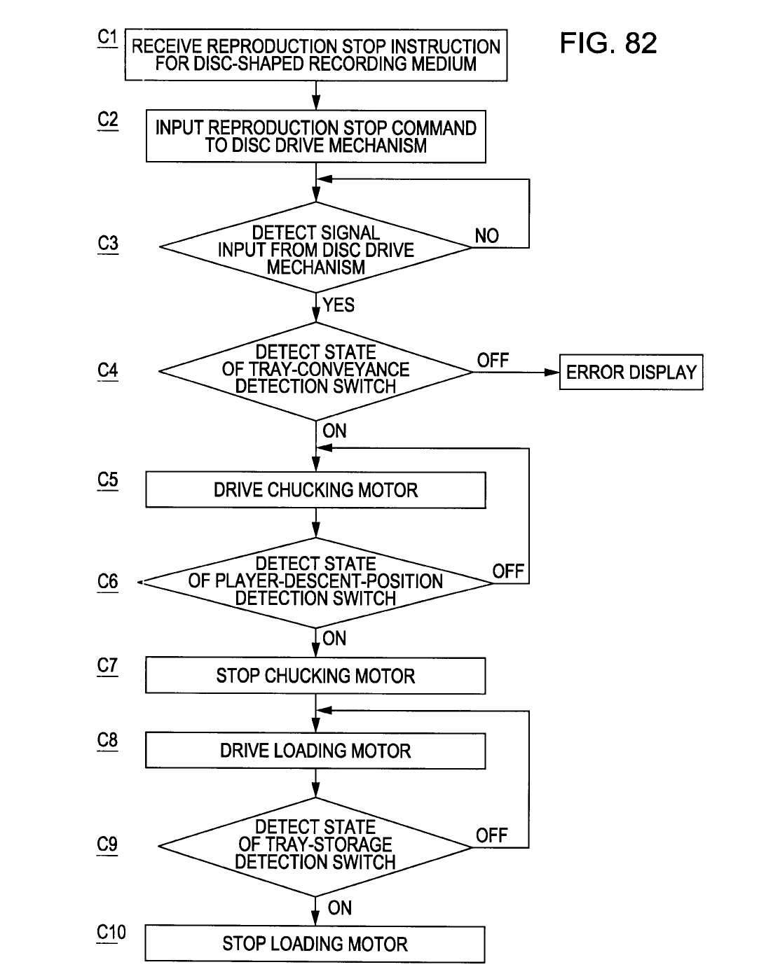

(B2) The state of the tray-storage detection switch 904 is detected. The tray-storage detection switch 904 is in the ON state if it is detected that the disc tray 226 is stored in the storage case 201. The tray-storage detection switch 904 is in the OFF state if it is not detected that the disc tray 226 is stored in the storage case 201. If the tray-storage detection switch 904 is in the ON state, the process proceeds to (B3). If the tray-storage detection switch 904 is in the OFF state, a flow of “operation of returning the disc-shaped recording medium 300 in the state of the reproducing operation to a position corresponding to the original address number (see FIG. 82)”, which will be described below, is performed.

(B3) The state of the player-descent-position detection switch 907 is detected. The player-descent-position detection switch 907 is in the ON state if it is detected that the disc-shaped recording medium 300 is chucked by the disc table 93 and other components, and is in the OFF state if it is not detected that the disc-shaped recording medium 300 is chucked by the disc table 93 and other components. If the player-descent-position detection switch 907 is in the OFF state, the process proceeds to (B4). If the player-descent-position detection switch 907 is in the ON state, the flow of “operation of returning the disc-shaped recording medium 300 in the state of the reproducing operation to a position corresponding to the original address number (see FIG. 82)”, which will be described below, is performed.

(B4) The loading motor 58 is driven such that the disc tray 226 is conveyed from the storage case 201 to the recording-reproducing position.

(B5) The state of the tray-conveyance detection switch 905 is detected. The tray-conveyance detection switch 905 is in the ON state if it is detected that the disc tray 226 has been conveyed to the recording-reproducing position, and is in the OFF state if it is not detected that the disc tray 226 has been conveyed to the recording-reproducing position. If the tray-conveyance detection switch 905 is in the ON state, the process proceeds to (B6). If the tray-conveyance detection switch 905 is in the OFF state, the process returns to (B4).

(B6) The loading motor 58 is stopped.

(B7) The chucking motor 97 is driven to move the disc drive mechanism 87 upward.

(B8) The state of the chucking-state detection switch 906 is detected. If the chucking-state detection switch 906 is in the ON state, the process proceeds to (B9). If the chucking-state detection switch 906 is in the OFF state, the process returns to (B7).

(B9) The chucking motor 97 is stopped.

(B10) A reproduction instruction is input to the disc drive mechanism 87, and the spindle motor 92 and the optical pickup 91 are driven together to perform a reproducing operation for the disc-shaped recording medium 300.

Next, an operation of returning the disc-shaped recording medium 300 in the state of the reproducing operation to a position corresponding to the original address number will be described with reference to FIG. 82.

(C1) The user operates the operation members 5, 5, . . . to input an instruction to stop the reproducing operation for the disc-shaped recording medium 300.

(C2) A reproduction stop instruction is input to the disc drive mechanism 87, and the operations of the spindle motor 92 and the optical pickup 91 are stopped to stop the reproducing operation for the disc-shaped recording medium 300.

(C3) It is determined whether or not an input of a signal representing that the disc drive mechanism 87 has stopped is detected. If the input of the signal is detected, the process proceeds to step (C4). If the input of the signal is not detected, the process performed in (C3) is repeated.

(C4) The state of the tray-conveyance detection switch 905 is detected. If the tray-conveyance detection switch 905 is in the ON state, the process proceeds to (C5). If the tray-conveyance detection switch 905 is in the OFF state, an error display is presented and the operation is stopped.

(C5) The chucking motor 97 is driven to move the disc drive mechanism 87 downward.

(C6) The state of the player-descent-position detection switch 907 is detected. If the player-descent-position detection switch 907 is in the ON state, the process proceeds to (C7). If the player-descent-position detection switch 907 is in the OFF state, the process returns to (C5).

(C7) The chucking motor 97 is stopped.

(C8) The loading motor 58 is driven such that the disc tray 226 is conveyed from the recording-reproducing position to the storage case 201.

(C9) The state of the tray-storage detection switch 904 is detected. The tray-storage detection switch 904 is in the ON state if it is detected that the disc tray 226 is stored in the storage case 201. The tray-storage detection switch 904 is in the OFF state if it is not detected that the disc tray 226 is stored in the storage case 201. If the tray-storage detection switch 904 is in the ON state, the process proceeds to (C10). If the tray-storage detection switch 904 is in the OFF state, the process returns to (C8).

(C10) The loading motor 58 is stopped.

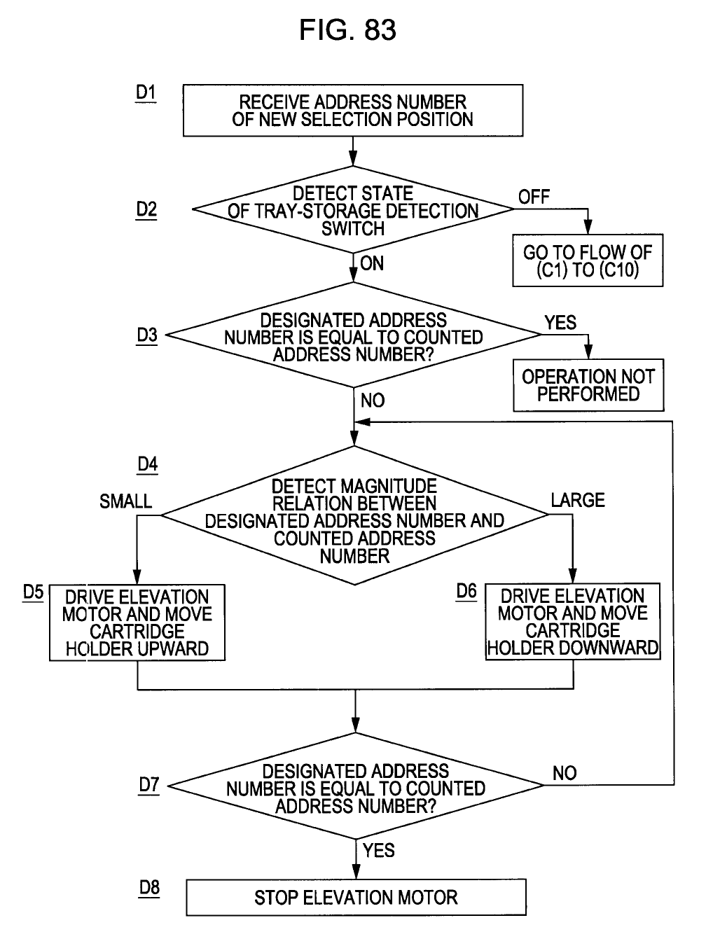

Next, the operation of changing the address number of the selection position designated by the user will be described with reference to FIG. 83.

(D1) The user operates the operation members 5, 5, . . . to input an address number of a new selection position.

(D2) The state of the tray-storage detection switch 904 is detected. If the tray-storage detection switch 904 is in the ON state, the process proceeds to (D3). If the tray-storage detection switch 904 is in the OFF state, a flow of “operation of returning the disc-shaped recording medium 300 in the state of the reproducing operation to a position corresponding to the original address number (see FIG. 82)” is performed.

(D3) It is detected whether or not the address number designated through the operation members 5, 5, . . . in (D1) is equal to the address number counted by the address number counter. If the result of the determination is NO, the process proceeds to (D4). If the result of the determination is YES, no operation is performed.

(D4) The magnitude relation between the address number designated through the operation members 5, 5, . . . in (D1) and the address number counted by the address number counter is determined. If the designated address number is smaller than the counted address number, the process proceeds to step (D5). If the designated address number is larger than the counted address number, the process proceeds to step (D6).

(D5) The elevation motor 47 is driven such that the cartridge holder 44 is moved upward. During this process, each time the address-number count switch 902 is turned ON, the counted address number is decremented by 1. Thus, the cartridge holder 44 is moved upward by a distance corresponding to one address number at a time.

(D6) The elevation motor 47 is driven such that the cartridge holder 44 is moved downward. During this process, each time the address-number count switch 902 is turned ON, the counted address number is incremented by 1. Thus, the cartridge holder 44 is moved downward by a distance corresponding to one address number at a time.

(D7) It is detected whether or not the address number designated through the operation members 5, 5, . . . in (D1) is equal to the address number counted by the address number counter. If the result of the determination is YES, the process proceeds to (D8). If the result of the determination is NO, the process returns to (D4).

(D8) The elevation motor 47 is stopped.

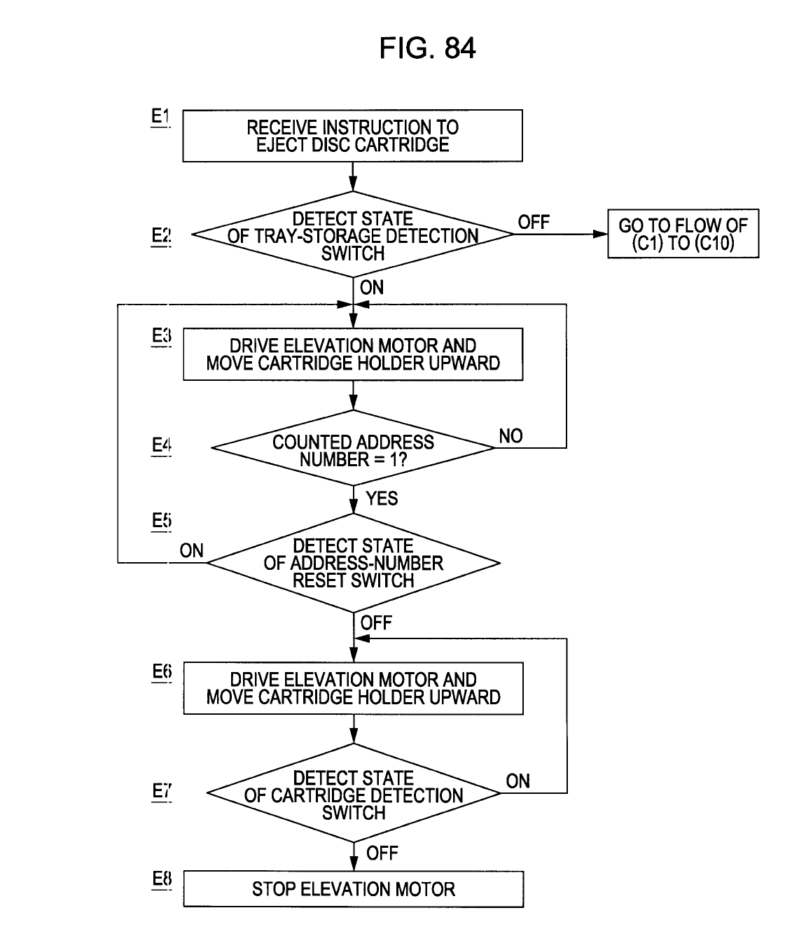

Next, an operation of ejecting the disc cartridge 200 from the cartridge holder 44 will be described with reference to FIG. 84.

(E1) The user operates the operation members 5, 5, . . . to input an instruction to eject the disc cartridge 200.

(E2) The state of the tray-storage detection switch 904 is detected. If the tray-storage detection switch 904 is in the ON state, the process proceeds to (E3). If the tray-storage detection switch 904 is in the OFF state, the “operation of returning the disc-shaped recording medium 300 in the state of the reproducing operation to a position corresponding to the original address number (see FIG. 82)” is performed.

(E3) The elevation motor 47 is driven such that the cartridge holder 44 is moved upward.

(E4) It is determined whether or not the counted address number is 1. If the counted address number is 1, the process proceeds to (E5). If the counted address number is not 1, the process proceeds to (E3).

(E5) The state of the address-number reset switch 903 is detected. If the address-number reset switch 903 is in the ON state, the process proceeds to (E3). If the address-number reset switch 903 is in the OFF state, the process returns to (E6).

(E6) The elevation motor 47 is driven such that the cartridge holder 44 is moved upward.

(E7) The state of the cartridge detection switch 901 is detected. If the cartridge detection switch 901 is in the OFF state, the process proceeds to (E8). If the cartridge detection switch 901 is in the ON state, the process proceeds to (E6).

(E8) The elevation motor 47 is stopped and the operation of ejecting the cartridge holder 200 from the cartridge holder 44 is completed.

Although an example in which the disc trays 226, 226, . . . , the disc-shaped recording media 300, 300, . . . , and the cover sheets 228, 228, . . . are arranged substantially perpendicular to the up-down direction (vertical direction) in the storage case 201 is described above, the present invention may also be applied to the case in which the disc trays 226, 226, . . . , the disc-shaped recording media 300, 300, . . . , and the cover sheets 228, 228, . . . are arranged substantially perpendicular to the horizontal direction.

The present application contains subject matter related to that disclosed in Japanese Priority Patent Application JP 2009-001987 filed in the Japan Patent Office on Jan. 7, 2009, Japanese Priority Patent Application JP 2009-001989 filed in the Japan Patent Office on Jan. 7, 2009, Japanese Priority Patent Application JP 2009-001988 filed in the Japan Patent Office on Jan. 7, 2009, and Japanese Priority Patent Application JP 2009-001990 filed in the Japan Patent Office on Jan. 7, 2009, the entire contents of which are hereby incorporated by reference.

The detailed shapes and structures of the components explained in the above-described embodiment are only an example of many possible embodiments of the present invention, and the technical field of the present invention is not limited by the above-described embodiments.

It should be understood by those skilled in the art that various modifications, combinations, sub-combinations and alterations may occur depending on design requirements and other factors insofar as they are within the scope of the appended claims or the equivalents thereof.

What is claimed is:

1. A disc cartridge comprising:
a storage case in which a plurality of disc-shaped recording media having a sheet shape are arranged in a thickness direction;
a plurality of disc trays having a sheet shape, the disc trays holding the respective disc-shaped recording media and being moved toward one side with respect to the storage case to be inserted into the storage case together with the disc-shaped recording media and toward another side to be extracted from the storage case together with the disc-shaped recording media; and
a plurality of tray levers disposed in the storage case, the tray levers being movable in a predetermined direction and causing the respective disc trays to move toward the another side,
wherein a first direction, a second direction, and a third direction are respectively defined as the thickness direction of the disc-shaped recording media, a direction in which the disc trays are moved with respect to the storage case, and a direction perpendicular to the first direction and the second direction,
wherein each disc tray includes a tab which projects in the second direction,
wherein each tray lever includes a pushing portion which pushes the tab of the corresponding disc tray toward the another side when the disc tray is to be extracted from the storage case,
wherein the tabs of the disc trays disposed next to each other in the first direction are at different positions in the third direction, and
wherein the tray levers are positioned near the respective tabs.

2. The disc cartridge according to claim 1,
wherein the tabs of the disc trays and the tray levers are successively arranged in the first direction and the third direction.

3. The disc cartridge according to claim 1,
wherein two tabs that are disposed at one and the other ends of the disc trays in the third direction and the tabs of the disc trays that are positioned between two disc trays including the two tabs in the first direction are arranged with constant intervals therebetween in the third direction.

4. The disc cartridge according to claim 1,
wherein the tab of each disc tray includes a lock-receiving projection, and
wherein each tray lever includes a lock projection which engages with the lock-receiving projection to lock the corresponding disc tray to the storage case when the disc-shaped recording medium held by the disc tray is stored in the storage case.

5. The disc cartridge according to claim 4,
wherein each tray lever is rotatable about an axis which extends in the first direction,
wherein, when the tray lever rotates in a first rotational direction, the pushing portion pushes the tab of the corresponding disc tray toward the another side, and
wherein, when the tray lever rotates in a second rotational direction, the lock projection engages with the lock-receiving projection on the tab of the corresponding disc tray.

6. The disc cartridge according to claim 5,
wherein each tray lever is rotatable between a lock position at which the corresponding disc tray is locked and a pushing completion position at which pushing of the tab of the corresponding disc tray is completed, and
wherein, when the tray lever is rotated toward the lock position, the tray lever receives an urging force in the second rotational direction from a corresponding urging spring.

7. The disc cartridge according to claim 6,
wherein a standby position is provided between the lock position and the pushing completion position, each tray lever being placed at the standby position such that the tab of the corresponding disc tray is capable of coming into contact with the pushing portion when the disc tray is moved toward the one side to be inserted into the storage case, and
wherein the tray lever is capable of being retained at the standby position by the corresponding urging spring.

8. The disc cartridge according to claim 5,
wherein a plurality of pin insertion holes which correspond to the tray levers are provided in the storage case, and
wherein each tray lever is rotated by inserting an operation pin into the storage case through the corresponding pin insertion hole and pushing the tray lever.

9. The disc cartridge according to claim 1,
wherein a thickness of the pushing portion of each tray lever is larger than a thickness of the tab of each disc tray.

10. The disc cartridge according to claim 6,
wherein the urging springs are formed integrally with a base surface portion by processing a metal plate such that the urging springs project from the base surface portion in a predetermined direction.

11. A disc changer comprising:
a cartridge-holding block configured to hold a disc cartridge; and
a disc-selecting block capable of moving in a predetermined direction with respect to the disc cartridge held by the cartridge-holding block,
wherein the disc cartridge includes
a storage case in which a plurality of disc-shaped recording media having a sheet shape are arranged in a thickness direction,
a plurality of disc trays having a sheet shape, the disc trays holding the respective disc-shaped recording media and being moved toward one side with respect to the storage case to be inserted into the storage case together with the disc-shaped recording media and toward another side to be extracted from the storage case together with the disc-shaped recording media, and
a plurality of tray levers disposed in the storage case, the tray levers being movable in a predetermined direction and causing the respective disc trays to move toward the another side,
wherein a first direction, a second direction, and a third direction are respectively defined as the thickness direction of the disc-shaped recording media, a direction in which the disc trays are moved with respect to the storage case, and a direction perpendicular to the first direction and the second direction,
wherein each disc tray includes a tab which projects in the second direction,
wherein each tray lever includes a pushing portion which pushes the tab of the corresponding disc tray toward the another side when the disc tray is to be extracted from the storage case,
wherein the tabs of the disc trays disposed next to each other in the first direction are at different positions in the third direction,
wherein the tray levers are positioned near the respective tabs,
wherein the disc-selecting block includes a selection slider configured to select a disc-shaped recording medium and a disc tray to be extracted from the storage case and move the tray lever corresponding to the disc tray such that the disc tray is moved toward the another side, and
wherein the selection slider is movable in the third direction.

12. The disc changer according to claim 11,
wherein a plurality of pin insertion holes which correspond to the tray levers are provided in the storage case, and
wherein the selection slider in the disc-selecting block includes an operation pin that is capable of being inserted into the storage case through each pin insertion hole to push and move the corresponding tray lever.

13. A disc cartridge comprising:
a storage case in which a plurality of disc-shaped recording media having a sheet shape are arranged in a thickness direction;
a plurality of disc trays composed of sheet-shaped elastic members, the disc trays holding the respective disc-shaped recording media and being moved toward one side with respect to the storage case to be inserted into the storage case together with the disc-shaped recording media and toward another side to be extracted from the storage case together with the disc-shaped recording media; and
a plurality of tray levers disposed in the storage case, the tray levers being movable in a predetermined direction and causing the respective disc trays to move toward the another side,
wherein a first direction, a second direction, and a third direction are respectively defined as the thickness direction of the disc-shaped recording media, a direction in which the disc trays are moved with respect to the storage case, and a direction perpendicular to the first direction and the second direction,
wherein each disc tray includes a tab which projects in the second direction,
wherein each tray lever includes a pushing portion which pushes the tab of the corresponding disc tray toward the another side when the disc tray is to be extracted from the storage case,
wherein the tabs of the disc trays disposed next to each other in the first direction are at different positions in the third direction,
wherein the tray levers are positioned near the respective tabs,
wherein the storage case includes a pair of side surface sections which are spaced from each other in the third direction, and
wherein each of the side surface sections is provided with a plurality of retaining grooves which extend in the second direction, outer peripheral portions of the disc trays being inserted in the retaining grooves so that the disc trays are retained by the retaining grooves.

14. The disc cartridge according to claim 13,
wherein each disc-shaped recording medium is provided with a cover sheet which covers at least a central portion of the disc-shaped recording medium at a side opposite the disc tray.

15. The disc cartridge according to claim 14,
wherein an edge portion of each disc tray at the one side thereof and an edge portion of the corresponding cover sheet at the one side thereof and are bonded together.

16. The disc cartridge according to claim 13,
wherein each disc tray is made of a conductive material.

17. The disc cartridge according to claim 13,
wherein a width of each disc tray in the third direction is larger than a diameter of each disc-shaped recording medium,
wherein a distance between the side surface sections of the storage case is larger than the diameter of each disc-shaped recording medium and smaller than the width of each disc tray in the third direction, and
wherein a width of each of the retaining grooves provided in the side surface sections in the first direction is larger than the thickness of each disc tray and smaller than the sum of the thickness of each disc tray and the thickness of each disc-shaped recording medium.

18. The disc cartridge according to claim 13,
wherein each disc tray is provided with a rib arrangement notch or a rib arrangement hole, and
wherein the storage case includes a positioning rib which, when the disc trays are stored in the storage case, extends through all of the rib arrangement notches or the rib arrangement holes in the disc trays and positions the disc-shaped recording media held by the disc trays.

19. The disc cartridge according to claim 13,
wherein the storage case is provided with an opening through which each disc-shaped recording medium is inserted into and extracted from the storage case,
wherein the storage case includes a rotatable opening-closing lid which closes or opens the opening when the disc-shaped recording media and the disc trays are stored in the storage case,
wherein the opening-closing lid includes a positioning portion which is capable of coming into contact with outer peripheral surfaces of the disc-shaped recording media when the opening is closed by the opening-closing lid, and
wherein a length of the positioning portion is substantially equal to a width of the opening in the thickness direction.

20. The disc cartridge according to claim 13,
wherein the side surface sections of the storage case are made of a conductive material.

21. The disc cartridge according to claim 13,
wherein the storage case includes a top surface section which continues to the side surface sections at opposite edges thereof and a bottom surface section which continues to the side surface sections at opposite edges thereof, the top surface section and the bottom surface section being spaced from each other in the first direction, and
wherein the following condition is satisfied:
Lt>Δa
Δa=Δb·cos θ
where θ is a maximum bending angle obtained when the disc trays are elastically deformed together with the disc-shaped recording media and one of the disc trays is in contact with the top surface section or the bottom surface section, Lt is an amount of insertion by which the disc trays are inserted into the respective retaining grooves in a radial direction of the disc-shaped recording media, and Δb is a displacement of end faces of the disc trays in the third direction when the disc trays are bent at the maximum bending angle θ.

22. A disc changer comprising:
a cartridge-holding block configured to hold a disc cartridge; and
a disc-selecting block capable of moving in a predetermined direction with respect to the disc cartridge held by the cartridge-holding block,
wherein the disc cartridge includes
a storage case in which a plurality of disc-shaped recording media having a sheet shape are arranged in a thickness direction,
a plurality of disc trays composed of sheet-shaped elastic members, the disc trays holding the respective disc-shaped recording media and being moved toward one side with respect to the storage case to be inserted into the storage case together with the disc-shaped recording media and toward another side to be extracted from the storage case together with the disc-shaped recording media, and
a plurality of tray levers disposed in the storage case, the tray levers being movable in a predetermined direction and causing the respective disc trays to move toward the another side,
wherein a first direction, a second direction, and a third direction are respectively defined as the thickness direction of the disc-shaped recording media, a direction in which the disc trays are moved with respect to the storage case, and a direction perpendicular to the first direction and the second direction,
wherein each disc tray includes a tab which projects in the second direction,
wherein each tray lever includes a pushing portion which pushes the tab of the corresponding disc tray toward the another side when the disc tray is to be extracted from the storage case,
wherein the tabs of the disc trays disposed next to each other in the first direction are at different positions in the third direction,
wherein the tray levers are positioned near the respective tabs,
wherein the storage case includes a pair of side surface sections which are spaced from each other in the third direction,
wherein each of the side surface sections is provided with a plurality of retaining grooves which extend in the second direction, outer peripheral portions of the disc trays being inserted in the retaining grooves so that the disc trays are retained by the retaining grooves,
wherein the disc-selecting block includes a selection slider configured to select a disc-shaped recording medium and a disc tray to be extracted from the storage case and move the tray lever corresponding to the disc tray such that the disc tray is moved toward the another side, and
wherein the selection slider is movable in the third direction.

23. A disc changer comprising:
a cartridge-holding block configured to hold a disc cartridge; and
a disc-conveying block,
wherein the disc cartridge includes
a storage case in which a plurality of disc-shaped recording media are arranged in a thickness direction while being held by respective disc trays which each include a tab, the tabs of the disc trays being disposed at different positions in a direction perpendicular to the thickness direction, and
a plurality of tray levers capable of pushing the tabs of the respective disc trays so that the disc trays partially project from the storage case together with the disc-shaped recording media, and
wherein the disc-conveying block includes at least one pair of feed rollers capable of conveying each disc tray and the disc-shaped recording medium held by the disc tray in an extraction direction for extracting the disc tray and the disc-shaped recording medium from the storage case by rotating while clamping a part of the disc tray between the feed rollers in the thickness direction when the disc tray partially projects from the storage case, and conveying each disc tray and the disc-shaped recording medium held by the disc tray in an insertion direction for inserting the disc tray and the disc-shaped recording medium into the storage case by rotating in a direction opposite to a rotational direction for the conveyance in the extraction direction while clamping the part of the disc tray between the feed rollers in the thickness direction.

24. The disc changer according to claim 23, further comprising:
an operation pin configured to push each tray lever;
a selection slider configured to hold the operation pin;
an operation lever configured to push the selection slider so that the operation pin pushes each tray lever; and
a loading motor configured to rotate the feed rollers in a forward direction or a reverse direction in accordance with a rotational direction of the loading motor, thereby conveying the disc tray and the disc-shaped recording medium in the extraction direction or the insertion direction, respectively,
wherein the operation lever is driven by a driving force of the loading motor when the feed rollers are rotated in the forward direction by the loading motor.

25. The disc changer according to claim 23, further comprising:
a return lever which, when the conveyance of the disc tray and the disc-shaped recording medium in the insertion direction performed by the feed rollers is completed, pushes the disc tray in the insertion direction to insert the disc tray and the disc-shaped recording medium into the storage case; and
a loading motor configured to rotate the feed rollers in a forward direction or a reverse direction in accordance with a rotational direction of the loading motor, thereby conveying the disc tray and the disc-shaped recording medium in the extraction direction or the insertion direction, respectively,
wherein the return lever is driven by a driving force of the loading motor when the feed rollers are rotated in the reverse direction by the loading motor.

26. The disc changer according to claim 24, further comprising:
a return lever which, when the conveyance of the disc tray and the disc-shaped recording medium in the insertion direction performed by the feed rollers is completed, pushes the disc tray in the insertion direction to insert the disc tray and the disc-shaped recording medium into the storage case,
wherein the operation of the return lever is stopped when feed rollers are rotated in the forward direction by the loading motor, and
wherein the return lever is driven by the driving force of the loading motor and the operation of the operation lever is stopped when the feed rollers are rotated in the reverse direction by the loading motor.

27. The disc changer according to claim 25,
wherein the return lever includes
a swing lever supported such that the swing lever is rotatable about a first rotational axis which extends in the thickness direction, the swing lever swinging about the first rotational axis when the disc tray and the disc-shaped recording medium are conveyed in the insertion direction by the feed rollers, and
a transmission lever supported such that the transmission lever is rotatable about a second rotational axis which extends in the thickness direction, the transmission lever being capable of sliding along an outer peripheral surface of the disc tray and being rotated about the second rotational axis when the disc tray is moved in the extraction direction or the insertion direction, and
wherein, when the conveyance of the disc tray and the disc-shaped recording medium in the insertion direction performed by the feed rollers is completed, the swing lever pushes the transmission lever and a pushing force of the swing lever is applied to the disc tray through the transmission lever so that the disc tray and the disc-shaped recording medium are inserted into the storage case.

28. The disc changer according to claim 27, further comprising:
a return spring which applies an urging force to the transmission lever in a direction away from the disc trays when the disc trays and the disc-shaped recording media are stored in the storage case.

29. The disc changer according to claim 27, further comprising:
a tray-storage detection switch configured to detect a position of each disc tray in the extraction direction and the insertion direction on the basis of a position of the transmission lever in a rotational direction thereof.

30. The disc changer according to claim 23,
wherein each disc-shaped recording medium is stored in the storage case such that the disc-shaped recording medium is covered by a cover sheet at a side opposite the disc tray, and
wherein the cover sheet is removed from the disc-shaped recording medium by a removing lever when the disc tray partially projects from the storage case, the removing lever being moved away from the disc-shaped recording medium when the disc tray, the disc-shaped recording medium, and the cover sheet are conveyed in the extraction direction by the feed rollers.

31. The disc changer according to claim 30,
wherein the cover sheet, the disc tray, and the removing lever are composed of elastic bodies,
wherein an elasticity of the removing lever is higher than an elasticity of the cover sheet and lower than an elasticity of the disc tray,
wherein the cover sheet is caused to slide along the removing lever so that the cover sheet is elastically deformed and is removed from the disc-shaped recording medium, and
wherein the disc tray is caused to slide along the removing lever so that the removing lever is elastically deformed and is moved away from the disc-shaped recording medium.

32. The disc changer according to claim 31,
wherein the removing lever is made of a conductive material.

33. The disc changer according to claim 30, further comprising:
a sheet guide which guides the cover sheet removed from the disc-shaped recording medium to a position separated from the disc-shaped recording medium.

34. The disc changer according to claim 33,
wherein the sheet guide is made of a conductive material.

35. The disc changer according to claim 23, further comprising:
a disc drive mechanism which includes a disc table rotated by a spindle motor and which is moved in the thickness direction after the disc tray and the disc-shaped recording medium conveyed by the feed rollers reach a recording-reproducing position at which information signals are recorded on or reproduced from the disc-shaped recording medium, the disc table including a centering projection which is inserted into a center hole formed in the disc-shaped recording medium,
wherein the disc tray is provided with a plurality of shaft insertion holes which extend through the disc tray in the thickness direction, and
wherein the disc drive mechanism includes positioning shafts and, when the disc drive mechanism is moved in the thickness direction such that the centering projection is inserted into the center hole in the disc-shaped recording medium, the positioning shafts are inserted through the shaft insertion holes in the disc tray and are positioned around the outer periphery of the disc-shaped recording medium to position the disc-shaped recording medium with respect to the centering projection.

36. The disc changer according to claim 35,
wherein each positioning shaft includes a large-diameter portion and a small-diameter portion which have different diameters,
wherein the disc-shaped recording medium is positioned by the large-diameter portions of the positioning shafts, and
wherein the small-diameter portions of the positioning shafts are positioned outside the outer peripheral surface of the disc-shaped recording medium when the centering projection of the disc table is inserted in the center hole in the disc-shaped recording medium.

37. The disc changer according to claim 35,
wherein the disc-shaped recording medium has a sheet shape,
wherein the disc changer further comprises:
a disc-shaped stabilizer provided to retain the disc-shaped recording medium between the stabilizer and the disc table, the stabilizer being rotated by the rotation of the disc table and being made of a conductive metal material; and
a holder body made of a conductive material, the holder body holding the stabilizer when the stabilizer is not rotated and being spaced from the stabilizer when the stabilizer is being rotated, and
wherein the stabilizer and the holder body are electrically connected to each other when the stabilizer is not rotated.

38. A disc changer comprising:
a cartridge-holding block configured to hold a disc cartridge in which a plurality of disc-shaped recording media are arranged at a first pitch in a thickness direction of the disc-shaped recording media;
a disc-conveying block which conveys a disc-shaped recording medium to be inserted into or extracted from the disc cartridge in a process of inserting the disc-shaped recording medium into the disc cartridge or extracting the disc-shaped recording medium from the disc cartridge; and
a disc-selecting block which selects the disc-shaped recording medium to be extracted from the disc-shaped recording medium in the process of extracting the disc-shaped recording medium from the disc cartridge,
wherein a first direction, a second direction, and a third direction are respectively defined as the thickness direction of the disc-shaped recording media, a direction which is perpendicular to the first direction and in which each disc-shaped recording medium is inserted into and extracted from the disc cartridge, and a direction which is perpendicular to the first direction and the second direction,
wherein selection positions at which the disc-selecting block selects the respective disc-shaped recording media are separated from each other by a second pitch in the third direction and by a first pitch in the first direction in the order of storage positions at which the disc-shaped recording media are arranged in the first direction in the disc cartridge,
wherein the cartridge-holding block includes a cartridge holder to which the disc cartridge is attached, the cartridge holder being movable in the first direction,
wherein the disc-selecting block includes a selection slider which selects the disc-shaped recording medium to be extracted at the corresponding selection position, the selection slider being movable in the third direction, and
wherein the ratio between an amount of movement per unit time of the cartridge holder in the first direction and an amount of movement per unit time of the selection slider in the third direction is equal to the ratio between the first pitch and the second pitch.

39. The disc changer according to claim 38,
wherein the cartridge holder is moved in the first direction and the selection slider is moved in the third direction by a single motor.

40. The disc changer according to claim 38,
wherein the disc-shaped recording media are divided into a plurality of groups, each group including a predetermined number of disc-shaped recording media,
wherein the selection positions of the disc-shaped recording media in the respective groups are provided with a predetermined interval therebetween in the first direction,
wherein the same number of selection sliders as the number of groups are provided,
wherein the selection of one of the disc-shaped recording media in each group is performed by the selection slider corresponding to the group, and
wherein, when one of the selection sliders is being moved, all of the remaining selection sliders are stopped.

41. The disc changer according to claim 40, further comprising:
a common guide shaft which guides the selection sliders in the third direction.

42. The disc changer according to claim 38,
wherein the selection slider includes a rack portion which extends in the third direction,
wherein the disc changer further comprises:
a gear train including a plurality of gears which mesh with each other, the gears being arranged in the third direction, and
wherein the selection slider is moved in the third direction by causing the rack portion to successively mesh with the gears arranged next to each other.
